(19) United States
(12) Patent Application Publication
(10) Pub. No.: US 2025/0176054 A1
(43) Pub. Date: May 29, 2025

(54) METHOD AND APPARATUS FOR ACTIVATING AND DIRECTING PLURALITY OF TRANSMIT/RECEIVE BEAMS IN WIRELESS COMMUNICATION SYSTEM

(71) Applicant: SAMSUNG ELECTRONICS CO., LTD., Suwon-si, Gyeonggi-do (KR)

(72) Inventors: Youngrok JANG, Suwon-si (KR); Kyoungmin PARK, Suwon-si (KR); Ameha Tsegaye ABEBE, Suwon-si (KR); Seongmok LIM, Suwon-si (KR); Hyoungju JI, Suwon-si (KR)

(21) Appl. No.: 18/727,053

(22) PCT Filed: Jan. 5, 2023
(86) PCT No.: PCT/KR2023/000214

§ 371 Date: Jul. 5, 2024

(30) Foreign Application Priority Data
Jan. 5, 2022 (KR) 10-2022-0001532
Aug. 3, 2022 (KR) 10-2022-0096959

(51) Int. Cl. H04W 76/20; H04L 5/00; H04W 72/02; H04W 72/231

(52) U.S. Cl. CPC H04W 76/20; H04L 5/0051; H04W 72/02; H04W 72/231

(57) ABSTRACT

The present disclosure relates to a communication technique that merges IoT technology with a 5G communication system for supporting higher data transmission rates than 4G systems, and a system therefor. The present disclosure may be applied to intelligent services (for example, smart homes, smart buildings, smart cities, smart cars or connected cars, healthcare, digital education, retail business, security and safety-related services, etc.) on the basis of 5G communication technology and IoT-related technology. The present disclosure discloses a method for enhancing coverage for a PDCCH in a wireless communication system.

### TECHNICAL FIELD

The disclosure relates to operations of a terminal and a base station in a wireless communication system. More particularly, the disclosure relates to a method for activating and indicating a plurality of transmit and receive beams in a wireless communication system, and an apparatus capable of performing the method.

### BACKGROUND ART

To meet the ever increasing demand for wireless data traffic since the commercialization of 4^{th} generation (4G) communication systems, efforts have been made to develop improved 5^{th} generation (5G) or pre-5G communication systems. As such, 5G or pre-5G communication systems are also called “beyond 4G network system” or “post Long Term Evolution (LTE) system”. To achieve high data rates, 5G communication systems are being considered for implementation in the extremely high frequency (mmWave) band (e.g., 60/80 GHz band). To decrease path loss of radio waves and increase the transmission distance thereof in the mmWave band, various technologies including beamforming, massive multiple-input multiple-output (massive MIMO), full dimensional MIMO (FD-MIMO), array antennas, analog beamforming, and large scale antennas are considered for 5G communication systems. To improve system networks in 5G communication systems, technology development is under way regarding evolved small cells, advanced small cells, cloud radio access networks (cloud RANs), ultra-dense networks, device-to-device (D2D) communication, wireless backhaul, moving networks, cooperative communication, coordinated multi-points (COMP), interference cancellation, and the like. Additionally, advanced coding and modulation (ACM) schemes such as hybrid frequency shift keying and quadrature amplitude modulation (FQAM) and sliding window superposition coding (SWSC), and advanced access technologies such as filter bank multi carrier (FBMC), non-orthogonal multiple access (NOMA), and sparse code multiple access (SCMA) are also under development for 5G systems.

Meanwhile, the Internet is evolving from a human centered network where humans create and consume information into the Internet of Things (IoT) where distributed elements such as things exchange and process information. There has also emerged the Internet of Everything (IoE) technology that combines IoT technology with big data processing technology through connection with cloud servers. To realize IoT, technology elements related to sensing, wired/wireless communication and network infrastructure, service interfacing, and security are needed, and technologies interconnecting things such as sensor networks, machine-to-machine (M2M) or machine type communication (MTC) are under research in recent years. In IoT environments, it is possible to provide intelligent Internet technology services, which collect and analyze data created by interconnected things to add new values to human life. Through convergence and combination between existing information technologies and various industries, IoT technology may be applied to various areas such as smart homes, smart buildings, smart cities, smart or connected cars, smart grids, health-care, smart consumer electronics, and advanced medical services.

Accordingly, various attempts are being made to apply 5G communication systems (5G communication systems or New Radio (NR)) to IoT networks. For example, technologies such as sensor networks and machine-to-machine (M2M) or machine type communication (MTC) are being realized by use of 5G communication technologies including beamforming, MIMO, and array antennas. Application of cloud RANs as a big data processing technique described above may be an instance of convergence of 3eG technology and IoT technology.

With the advancement of wireless communication systems as described above, various services can be provided, so there is a need for a method to provide these services smoothly.

### DISCLOSURE OF INVENTION

### Technical Problem

The disclosed embodiments aim to provide an apparatus and method that can effectively provide services in a mobile communication system.

### Solution to Problem

A method of a terminal in a wireless communication system according to an embodiment of the disclosure may include: receiving, based on a unified transmission configuration indication (TCI), TCI state identification information from a base station; receiving, from the base station, unified TCI state type information indicating that a type related to the unified TCI is either a joint TCI type or a separate TCI type; and receiving, from the base station, a medium access control (MAC) control element (CE) that activates a TCI state associated with a codepoint of a TCI state field included in downlink control information (DCI), wherein the MAC CE may include an information field that indicates a number of TCI states associated with the codepoint of the TCI state field included in the DCI. A method of a base station in a wireless communication system according to an embodiment of the disclosure may include: transmitting, based on a unified transmission configuration indication (TCI), TCI state identification information to a terminal; transmitting, to the terminal, unified TCI state type information indicating that a type related to the unified TCI is either a joint TCI type or a separate TCI type; and transmitting, to the terminal, a medium access control (MAC) control element (CE) that activates a TCI state associated with a codepoint of a TCI state field included in downlink control information (DCI), wherein the MAC CE may include an information field that indicates a number of TCI states associated with the codepoint of the TCI state field included in the DCI.

A terminal in a wireless communication system according to an embodiment of the disclosure may include: a transceiver; and a controller that is configured to receive, based on a unified transmission configuration indication (TCI), TCI state identification information from a base station, receive unified TCI state type information indicating that a type related to the unified TCI is either a joint TCI type or a separate TCI type from the base station, and receive a medium access control (MAC) control element (CE) that activates a TCI state associated with a codepoint of a TCI state field included in downlink control information (DCI) from the base station, wherein the MAC CE may include an information field that indicates a number of TCI states associated with the codepoint of the TCI state field included in the DCI.

A base station in a wireless communication system according to an embodiment of the disclosure may include: a transceiver; and a controller that is configured to transmit, based on a unified transmission configuration indication (TCI), TCI state identification information to a terminal, transmit unified TCI state type information indicating that a type related to the unified TCI is either a joint TCI type or a separate TCI type to the terminal, and transmit a medium access control (MAC) control element (CE) that activates a TCI state associated with a codepoint of a TCI state field included in downlink control information (DCI) to the terminal, wherein the MAC CE may include an information field that indicates a number of TCI states associated with the codepoint of the TCI state field included in the DCI.

### Advantageous Effects of Invention

The disclosed embodiments provide an apparatus and method that can effectively provide services in a mobile communication system.

### BRIEF DESCRIPTION OF DRAWINGS

FIG. 1 is a diagram illustrating the basic structure of the time-frequency domain in a wireless communication system according to an embodiment of the disclosure.

FIG. 2 is a diagram illustrating the structure of a frame, subframe, and slot in a wireless communication system according to an embodiment of the disclosure.

FIG. 3 is a diagram illustrating an example of configuring bandwidth parts in a wireless communication system according to an embodiment of the disclosure.

FIG. 4 is a diagram illustrating an example of configuring a control resource set of a downlink control channel in a wireless communication system according to an embodiment of the disclosure.

FIG. 5A is a diagram illustrating the structure of a downlink control channel in a wireless communication system according to an embodiment of the disclosure.

FIG. 5B is a diagram illustrating a case where a UE may have multiple PDCCH monitoring occasions within a slot by use of a span in a wireless communication system according to an embodiment of the present disclosure.

FIG. 6 is a diagram illustrating an example of DRX operation in a wireless communication system according to an embodiment of the present disclosure.

FIG. 7 is a diagram illustrating an example of allocating base station beams based on the TCI state configuration in a wireless communication system according to an embodiment of the disclosure.

FIG. 8 is a diagram illustrating an example of a TCI state assignment scheme for the PDCCH in a wireless communication system according to an embodiment of the disclosure.

FIG. 9 is a diagram illustrating a structure for TCI indication MAC CE signaling as to PDCCH DMRS in a wireless communication system according to an embodiment of the disclosure.

FIG. 10 is a diagram illustrating an example of beam configuration for control resource sets and search spaces in a wireless communication system according to an embodiment of the disclosure.

FIG. 11 is a diagram describing a method for a base station and a UE to transmit and receive data in consideration of downlink data channel and rate matching resources in a wireless communication system according to an embodiment of the disclosure.

FIG. 12 is a diagram illustrating a method for a UE to select a control resource set that can be received by considering priority when receiving a downlink control channel in a wireless communication system according to an embodiment of the disclosure.

FIG. 13 is a diagram illustrating an example of frequency domain resource assignment of the PDSCH in a wireless communication system according to an embodiment of the disclosure.

FIG. 14 is a diagram illustrating an example of time domain resource assignment of the PDSCH in a wireless communication system according to an embodiment of the disclosure.

FIG. 15 is a diagram illustrating an example of time-axis resource allocation based on the subcarrier spacing of a data channel and a control channel in a wireless communication system according to an embodiment of the disclosure.

FIG. 16 illustrates a process for beam configuration and activation for the PDSCH.

FIG. 17 is a diagram illustrating an example of PUSCH transmission with repetition type B in a wireless communication system according to an embodiment of the disclosure.

FIG. 18 is a diagram illustrating the structure of wireless protocols in a base station and a UE under situations of a single cell, carrier aggregation, and dual connectivity in a wireless communication system according to an embodiment of the disclosure.

FIG. 19 is a diagram illustrating an example of antenna port configuration and resource allocation for cooperative communication in a wireless communication system according to an embodiment of the disclosure.

FIG. 20 is a diagram illustrating an example of downlink control information (DCI) configuration for cooperative communication in a wireless communication system according to an embodiment of the disclosure.

FIG. 21 is a diagram illustrating a structure for enhanced PDSCH TCI state activation/deactivation MAC CE.

FIG. 22 is a diagram illustrating an RLM RS selection process according to an embodiment of the disclosure.

FIG. 23 is a diagram illustrating a MAC CE structure for activating and indicating joint TCI states in a wireless communication system according to an embodiment of the disclosure.

FIG. 24 is a diagram illustrating another MAC CE structure for activating and indicating joint TCI states in a wireless communication system according to an embodiment of the disclosure.

FIG. 25 is a diagram illustrating another MAC CE structure for activating and indicating joint TCI states in a wireless communication system according to an embodiment of the disclosure.

FIG. 26 is a diagram illustrating a MAC CE structure for activating and indicating separate TCI states in a wireless communication system according to an embodiment of the disclosure.

FIG. 27 is a diagram illustrating another MAC CE structure for activating and indicating separate TCI states in a wireless communication system according to an embodiment of the disclosure.

FIG. 28 is a diagram illustrating another MAC CE structure for activating and indicating separate TCI states in a wireless communication system according to an embodiment of the disclosure.

FIG. 29 is a diagram illustrating another MAC CE structure for activating and indicating separate TCI states in a wireless communication system according to an embodiment of the disclosure.

FIG. 30 is a diagram illustrating a MAC CE structure for activating and indicating joint and separate TCI states in a wireless communication system according to an embodiment of the disclosure.

FIG. 31 is a diagram illustrating another MAC CE structure for activating and indicating joint and separate TCI states in a wireless communication system according to an embodiment of the disclosure.

FIG. 32 is a diagram illustrating the beam application time that may be considered when using a unified TCI framework in a wireless communication system according to an embodiment of the disclosure.

FIG. 33 is a diagram illustrating a MAC CE structure for activating and indicating plural joint TCI states in a wireless communication system according to an embodiment of the disclosure.

FIG. 34 is a diagram illustrating a MAC CE structure for activating and indicating plural separate TCI states in a wireless communication system according to an embodiment of the disclosure.

FIG. 35 is a diagram illustrating another MAC CE structure for activating and indicating plural separate TCI states in a wireless communication system according to an embodiment of the disclosure.

FIG. 36 is a diagram illustrating another MAC CE structure for activating and indicating joint TCI state, separate DL TCI state, or separate UL TCI state in a wireless communication system according to an embodiment of the disclosure.

FIG. 37 is a diagram illustrating another MAC CE structure for activating and indicating multiple joint TCI states, separate DL TCI states, or separate UL TCI states in a wireless communication system according to an embodiment of the disclosure.

FIG. 38 is a diagram illustrating another MAC CE structure for activating and indicating multiple joint TCI states, separate DL TCI states, or separate UL TCI states in a wireless communication system according to an embodiment of the disclosure.

FIG. 39 is a diagram illustrating the structure of a UE in a wireless communication system according to an embodiment of the disclosure.

FIG. 40 is a diagram illustrating the structure of a base station in a wireless communication system according to an embodiment of the disclosure.

### MODE FOR THE INVENTION

Hereinafter, embodiments of the disclosure will be described in detail with reference to the accompanying drawings.

In describing the embodiments, descriptions of technical content that is well known in the art to which this disclosure belongs and is not directly related to this disclosure will be omitted. This is to convey the subject matter of the disclosure more clearly without obscuring it by omitting unnecessary explanation. Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts. In addition, when describing the disclosure, if it is determined that a detailed description of a related function or configuration may unnecessarily obscure the gist of the disclosure, the detailed description will be omitted. In addition, the terms described below are defined in consideration of their functions in the disclosure, and these may vary depending on the intention of the user, the operator, or the custom. Hence, their meanings should be determined based on the overall contents of this specification.

In the following description, the base station (BS) is a main agent that performs resource allocation for terminals and may be at least one of gNode B, eNode B, Node B, wireless access unit, base station controller, or node on a network. The terminal may include a user equipment (UE), mobile station (MS), cellular phone, smartphone, computer, or multimedia system capable of performing communication functions. In the disclosure, downlink (DL) refers to a radio transmission path of a signal transmitted from a base station to a terminal, and uplink (UL) refers to a radio transmission path of a signal transmitted from a terminal to a base station. In addition, although the LTE or LTE-A system may be described below as an example, embodiments of the disclosure may also be applied to other communication systems with similar technical background or channel configurations. For example, this may include the 5^{th} generation mobile communication technology (5G, new radio, NR) developed after LTE-A, and the term 5G below may be a concept including the existing LTE, LTE-A, and other similar services. In addition, this disclosure may be applied to other communication systems through some modifications without significantly departing from the scope of the disclosure at the discretion of a person skilled in technical knowledge.

Meanwhile, it is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

In addition, a block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the description, the word “unit”, “module”, or the like may refer to a software component or hardware component such as an FPGA or ASIC capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose large components and units. Components and units may be configured to drive a device or one or more processors in a secure multimedia card. Also, in a certain embodiment, a module or unit may include one or more processors.

Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends a data or control signal to a base station (BS or gNode B), and the downlink refers to a radio link through which a base station sends a data or control signal to a terminal. In such a multiple access scheme, time-frequency resources used to carry user data or control information are allocated so as not to overlap each other (i.e., maintain orthogonality) to thereby identify the data or control information of a specific user.

As a future communication system after LTE, that is, the 5G communication system must be able to freely reflect various requirements of users and service providers and need to support services satisfying various requirements. Services being considered for the 5G communication system include enhanced mobile broadband (eMBB), massive machine type communication (mMTC), and ultra-reliable and low-latency communication (URLLC).

eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. At the same time, the 5G communication system has to provide an increased user perceived data rate for the terminal. To meet such requirements in the 5G communication system, it is required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a transmission bandwidth of up to 20 MHz in a band of 2 GHz used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km²) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time such as 10 to 15 years may be required.

Finally, URLLC is a cellular-based wireless communication service used for a specific purpose (mission-critical). For example, it may consider services usable for remote control of robots or machinery, industrial automation, unmanned aerial vehicles, remote health care, and emergency alert. Hence, the communication provided by URLLC must provide very low latency and very high reliability. For example, a URLLC service has to support both an air interface latency of less than 0.5 ms and a packet error rate of 10-5 or less as a requirement. Hence, for a service supporting URLLC, the 5G system must provide a transmission time interval (TTI) shorter than that of other services, and at the same time, a design requirement for allocating a wide resource in a frequency band may be required.

The above three 5G services (i.e., eMBB, URLLC, and mMTC) can be multiplexed and transmitted in one system. Here, to satisfy different requirements of the services, different transmission and reception techniques and parameters can be used between services. However, 5G is not limited to the three services mentioned above.

### [NR Time-Frequency Resources]

Next, the frame structure of a 5G system will be described in more detail with reference to the drawing.

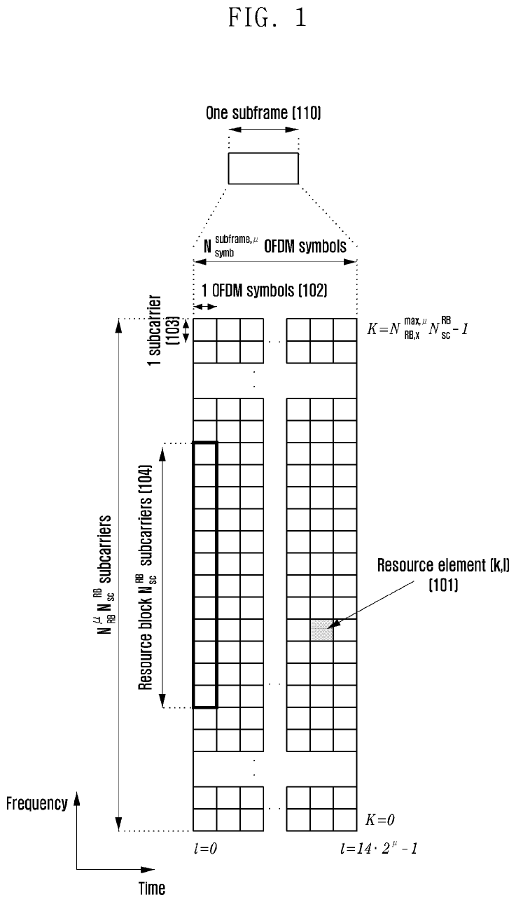

FIG. 1 is a diagram illustrating the basic structure of the time-frequency domain, which is a radio resource region where data or control channels are transmitted in the 5G system.

In FIG. 1, the horizontal axis represents the time domain and the vertical axis represents the frequency domain. The basic unit of resources in the time-frequency domain is a resource element (RE) 101, which may be defined as 1 OFDM (orthogonal frequency division multiplexing) symbol 102 in the time domain and 1 subcarrier 103 in the frequency domain. In the frequency domain, Z Sc (e.g., 12) consecutive REs may constitute one resource block (RB) 104.

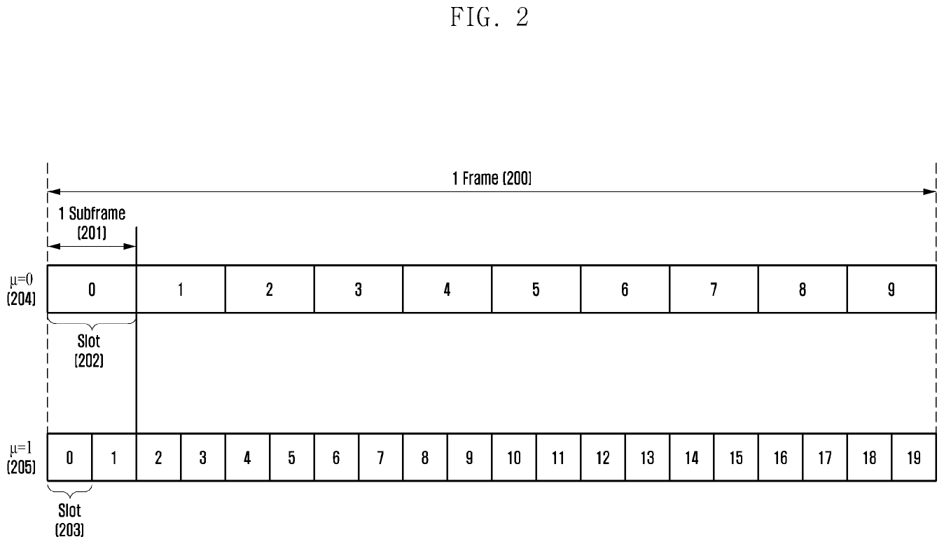

FIG. 2 is a diagram illustrating the structure of a frame, subframe, and slot in a wireless communication system according to an embodiment of the disclosure. In FIG. 2, an example structure of a frame 200, a subframe 201, and a slot 202 is shown. One frame 200 may be defined to be 10 ms. One subframe 201 may be defined to be 1 ms, and thus one frame 200 may be composed of a total of 10 subframes 201. One slot 202 or 203 may be defined to be 14 OFDM symbols (i.e., the number of symbols per slot (N_{symb}^{slot})=14). One subframe 201 may be composed of one or multiple slots 202 or 203, and the number of slots 202 or 203 per subframe 201 may vary according to a configuration value μ (204 or 205) for the subcarrier spacing. In an example of FIG. 2, a case where μ=0 (204) and a case where μ=1 (205) are shown as a subcarrier spacing configuration value. When μ=0 (204), 1 subframe 201 may be composed of 1 slot 202, and when μ=1 (205), 1 subframe 201 may be composed of 2 slots 203. That is, according to the configuration value μ for the subcarrier spacing, the number of slots per subframe (Nₛₗₒₜ^{subframe,μ}) may vary, and the number of slots per frame (Nₛₗₒₜ^{frame,μ}) may vary accordingly. According to each configuration value μ for the subcarrier spacing, Nₛₗₒₜ^{subframe,μ} and Nₛₗₒₜ^{frame,μ} may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, the bandwidth part (BWP) configuration in a 5G communication system will be described in detail with reference to the drawing.

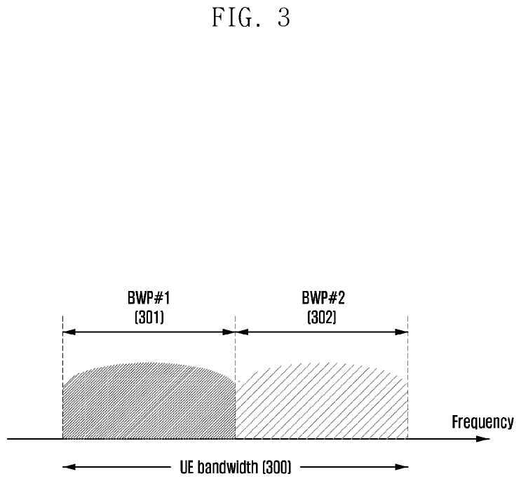

FIG. 3 is a diagram illustrating an example of configuring bandwidth parts in a wireless communication system according to an embodiment of the disclosure.

In FIG. 3, an example is shown in which the UE bandwidth 300 is configured as two bandwidth parts, that is, bandwidth part #1 (BWP #1) 301 and bandwidth part #2 (BWP #2) 302. The base station may configure one or more bandwidth parts to the UE, and the following information may be set for each bandwidth part.

TABLE 2

| BWP ::= | SEQUENCE { |
|---|---|
| bwp-Id | |
| BWP-Id | |
| locationAndBandwidth | INTEGER (0..65536), |
| subcarrierSpacing | |
| ENUMERATED {n0, n1, n2, n3, n4, n5}, | |
| cyclicPrefix | ENUMERATED |

{ extended }
}

Without being limited to the above example, various parameters related to the bandwidth part can be configured to the UE in addition to the above configuration information. These information may be transmitted from the base station to the UE through higher layer signaling, for example, radio resource control (RRC) signaling. Among one or more configured bandwidth parts, at least one bandwidth part may be activated. Whether a configured bandwidth part is activated may be transmitted from the base station to the UE semi-statically through RRC signaling or dynamically through downlink control information (DCI).

According to some embodiments, before being radio resource control (RRC) connected, a UE may be configured by the base station with an initial bandwidth part (initial BWP) for initial connection through a master information block (MIB). To be more specific, in the initial connection stage, the UE may receive, through the MIB, configuration information about a control resource set (CORESET) and search space through which a physical downlink control channel (PDCCH) for receiving system information required for initial connection (remaining system information (RMSI) or system information block 1 (SIB1) can be transmitted. The control resource set and search space configured through the MIB can each be regarded as having an identity (ID) of 0. The base station may notify the UE of configuration information such as frequency assignment information, time assignment information, and numerology for control resource set #0 through the MIB. Additionally, the base station may notify the UE of configuration information about the monitoring periodicity and occasion for control resource set #0, that is, configuration information about search space #0, through the MIB. The UE may regard the frequency domain set as control resource set #0 obtained from the MIB as the initial bandwidth part for initial connection. At this time, the identity (ID) of the initial bandwidth part may be regarded as 0.

The configuration for the bandwidth part supported by 5G may be used for various purposes.

According to some embodiments, the configuration for the bandwidth part may be used when the bandwidth supported by the UE is smaller than the system bandwidth. For example, the base station may configure the frequency location of a bandwidth part (configuration information 2) to the UE, allowing the UE to transmit and receive data at a specific frequency location within the system bandwidth.

Additionally, according to some embodiments, the base station may configure a plurality of bandwidth parts to the UE for the purpose of supporting different numerologies. For example, to support data transmission and reception using both a subcarrier spacing of 15 kHz and a subcarrier spacing of 30 kHz for a UE, the base station may configure two bandwidth parts with subcarrier spacings of 15 kHz and 30 kHz, respectively. Different bandwidth parts may be frequency division multiplexed, and when the base station intends to transmit and receive data at a specific subcarrier spacing, the bandwidth part configured with the corresponding subcarrier spacing may be activated.

Additionally, according to some embodiments, for the purpose of reducing power consumption of a UE, the base station may configure bandwidth parts with different bandwidth sizes to the UE. For example, if a UE supports a very large bandwidth, for example, a bandwidth of 100 MHz, and always transmits and receives data through that bandwidth, very large power consumption may occur. In particular, monitoring unnecessarily a downlink control channel with a large bandwidth of 100 MHz in a situation where there is no traffic can be very inefficient in terms of power consumption. For the purpose of reducing the power consumption of the UE, the base station may configure a relatively small bandwidth part, for example, a bandwidth part of 20 MHz, to the UE. The UE may perform monitoring operations on the 20 MHz bandwidth part in a situation where there is no traffic, and may, when data is generated, transmit and receive data in the 100 MHz bandwidth part according to the instruction of the base station.

In a method of configuring the bandwidth part, a terminal before being RRC connected may receive configuration information for an initial bandwidth part through a master information block (MIB) in the initial connection stage. To be more specific, through the MIB of the physical broadcast channel (PBCH), the UE may be configured with a control resource set (CORESET) for the downlink control channel through which downlink control information (DCI) scheduling the system information block (SIB) can be transmitted. The bandwidth of the control resource set configured through the MIB may be considered as the initial bandwidth part, and through the configured initial bandwidth part, the UE may receive the physical downlink shared channel (PDSCH) on which the SIB is transmitted. In addition to receiving the SIB, the initial bandwidth part may also be used for other system information (OSI), paging, and random access.

### [Bandwidth Part (BWP) Switching]

When one or more bandwidth parts are configured to the UE, the base station may instruct the UE to change (or switch) the bandwidth part by using a bandwidth part indicator field in the DCI. As an example, in FIG. 3, if the currently activated bandwidth part of the UE is bandwidth part #1 (301), the base station may indicate bandwidth part #2 (302) to the UE by using a bandwidth part indicator in the DCI, and the UE may switch the bandwidth part to bandwidth part #2 (302) indicated by the bandwidth part indicator in the received DCI.

As described above, since DCI-based bandwidth part switching can be indicated by the DCI scheduling the PDSCH or PUSCH, when a UE receives a bandwidth part switch request, it must be able to receive or transmit the PDSCH or PUSCH scheduled by the corresponding DCI without difficulty in the switched bandwidth part. To this end, the standard stipulates requirements for the delay time (T_{BWP}) required when switching the bandwidth part, and may be defined as follows, for example.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
^{Note 2}If the BWP switch involves changing of SCS, the BWP switch delay is determined by the larger one between the SCS before BWP switch and the SCS after BWP switch.

Requirements for the bandwidth part switch delay time may support type 1 or type 2 depending on the UE's capability. The UE may report the supported bandwidth part delay time type to the base station.

According to the requirements for the bandwidth part switch delay time described above, when the UE receives a DCI including a bandwidth part switch indicator in slot n, the UE may complete switching to the new bandwidth part indicated by the bandwidth part switch indicator no later than slot n+T_{BWP}, and may perform transmission and reception on the data channel scheduled by the corresponding DCI in the newly switched bandwidth part. When the base station intends to schedule a data channel with a new bandwidth part, it may determine time domain resource allocation for the data channel by taking into consideration the bandwidth part switch delay time (T_{BWP}) of the UE. That is, when scheduling a data channel with a new bandwidth part, the base station can schedule the data channel after the bandwidth part switch delay time in determining time domain resource allocation for the data channel. Accordingly, the UE may not expect that the DCI indicating bandwidth part switching indicates a slot offset (K0 or K2) value that is smaller than the bandwidth part switch delay time (T_{BWP}).

If the UE receives a DCI (e.g., DCI format 1_1 or 0_1) indicating bandwidth part switching, the UE may not perform any transmission or reception during a time interval ranging from the third symbol of the slot in which the PDCCH containing the corresponding DCI is received to the start point of the slot indicated by a slot offset (K0 or K2) value indicated by the time domain resource allocation indicator field in the corresponding DCI. For example, if the UE receives a DCI indicating bandwidth part switching in slot n, and the slot offset value indicated by the DCI is K, the UE may not perform any transmission or reception during a time interval ranging from the third symbol of slot n to the symbol before slot n+K (i.e., last symbol of slot n+K−1).

### [SS/PBCH Block]

Next, a description will be given of the synchronization signal (SS)/PBCH block in 5G.

The SS/PBCH block may indicate a physical layer channel block including a primary SS (PSS), a secondary SS (SSS), and a PBCH. The details are as follows.
PSS: PSS is a signal that serves as a reference for downlink time/frequency synchronization and provides some information of cell ID.
SSS: SSS serves as a reference for downlink time/frequency synchronization and provides remaining cell ID information not provided by PSS. Additionally, it may serve as a reference signal (RS) for demodulation of the PBCH.
PBCH: PBCH provides essential system information required for transmission and reception of a data channel and control channel of the UE. The essential system information may include search space-related control information indicating radio resource mapping information of a control channel, scheduling control information of a separate data channel for transmitting system information, and the like.
SS/PBCH block: the SS/PBCH block is composed of a combination of PSS, SSS, and PBCH. One or multiple SS/PBCH blocks may be transmitted within 5 ms, and individual SS/PBCH blocks being transmitted may be distinguished by an index. The UE may detect the PSS and SSS in the initial connection stage, and may decode the PBCH. The UE may obtain the MIB from the PBCH, and may be configured with control resource set (CORESET) #0 (which may correspond to a control resource set having a control resource set index of 0) therefrom. The UE may assume that a selected SS/PBCH block and a demodulation reference signal (DMRS) transmitted in control resource set #0 are in a quasi-colocated (QCL) relationship, and may perform monitoring of control resource set #0. The UE may obtain system information through downlink control information transmitted in control resource set #0. The UE may obtain random access channel (RACH)-related configuration information required for initial connection from the received system information. The UE may transmit a physical RACH (PRACH) to the base station in consideration of the selected SS/PBCH block index, and the base station having received the PRACH may obtain information about the SS/PBCH block index selected by the UE. The base station may know that the UE has selected a specific block among individual SS/PBCH blocks and monitors control resource set #0 related thereto.

### [DRX]

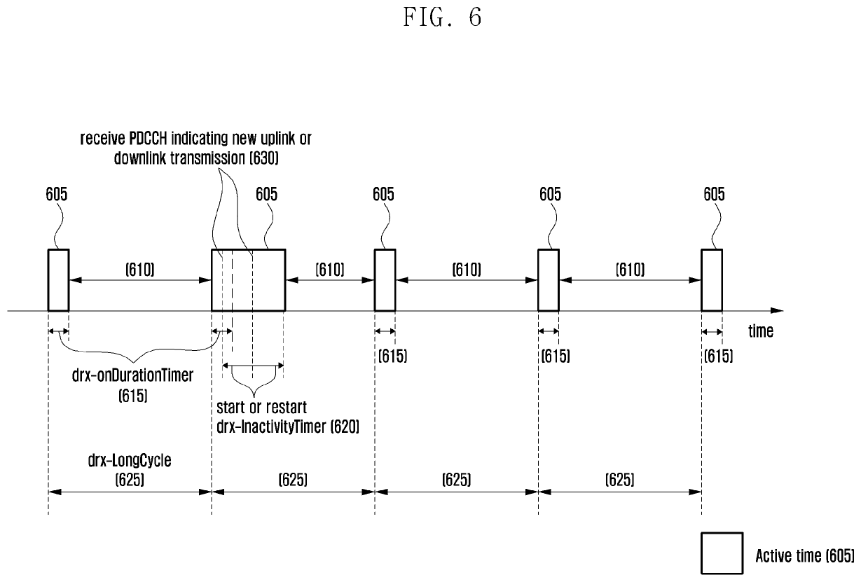

FIG. 6 is a diagram for describing discontinuous reception (DRX).

Discontinuous reception (DRX) is an operation in which a UE using a service receives data discontinuously in an RRC connected state where a radio link is established between the base station and the UE. When DRX is applied, the UE may turn on the receiver at a specific time point to monitor the control channel, and if no data is received for a specific period of time, it may turn off the receiver to reduce power consumption of the UE. 0. DRX operation may be controlled by a MAC entity based on various parameters and timers.

With reference to FIG. 6, the active time 605 is the time when the UE wakes up every DRX cycle to monitor the PDCCH. The active time 605 may be defined as follows.
drx-onDurationTimer or drx-InactivityTimer or drx-RetransmissionTimerDL or drx-RetransmissionTimerUL or ra-ContentionResolutionTimer is running; or
a scheduling request is sent on PUCCH and is pending; or
a PDCCH indicating a new transmission addressed to the C-RNTI of the MAC entity has not been received after successful reception of a random access response for the random access preamble not selected by the MAC entity among the contention-based random access preamble

drx-onDurationTimer, drx-InactivityTimer, drx-RetransmissionTimerDL, drx-RetransmissionTimerUL, ra-ContentionResolutionTimer, or the like is a timer whose value is set by the base station, and serves to configure the UE to monitor the PDCCH when a specific condition is satisfied.

drx-onDurationTimer 615 is a parameter to set the minimum time that the UE is awake in the DRX cycle. drx-Inactivity Timer 620 is a parameter for setting the additional awake time of the UE when receiving a PDCCH indicating new uplink or downlink transmission (630). drx-RetransmissionTimerDL is a parameter for setting the maximum time that the UE is awake to receive downlink retransmission in the downlink HARQ procedure. drx-RetransmissionTimerUL is a parameter for setting the maximum time that the UE is awake to receive an uplink retransmission grant in the uplink HARQ procedure. drx-onDurationTimer, drx-InactivityTimer, drx-RetransmissionTimerDL, and drx-RetransmissionTimerUL may be set to, for example, a time, a number of subframes, a number of slots, or the like. ra-ContentionResolutionTimer is a parameter for PDCCH monitoring in the random access procedure.

The inactive time 610 is the time set so as not to monitor the PDCCH or not to receive the PDCCH during DRX operation, and the remaining time excluding the active time 605 from the total time for DRX operation may become the inactive time 610. If the UE does not monitor the PDCCH during the active time 605, it may transition to the sleep or inactive state to reduce power consumption.

The DRX cycle refers to the periodicity in which the UE wakes up to monitor the PDCCH. In other words, the DRX cycle refers to the time interval from monitoring a PDCCH to monitoring the next PDCCH, or the on-duration periodicity. There are two types of DRX cycle: short DRX cycle and long DRX cycle. The short DRX cycle may be selectively applied (option).

The long DRX cycle 625 is the longer one of the two types of DRX cycle set in the UE. While operating in long DRX, the UE starts drx-onDurationTimer 615 again when the long DRX cycle 625 has elapsed from the start point (e.g., start symbol) of drx-onDurationTimer 615. When operating in the long DRX cycle 625, the UE may start drx-onDurationTimer 615 in the slot after drx-SlotOffset in a subframe that satisfies Equation 1 below. Here, drx-SlotOffset means the delay before starting drx-onDurationTimer 615. drx-SlotOffset may be set to, for example, a time, a number of slots, or the like.

[(SFN×10)+subframe number]modulo(drx-LongCycle)=drx-StartOffset [Equation 1]

At this time, drx-LongCycleStartOffset may be used to define the subframe to start the long DRX cycle 625, and drx-StartOffset may be used to define the subframe to start the long DRX cycle 625. drx-LongCycleStartOffset may be set to, for example, a time, a number of subframes, a number of slots, or the like.

### [PDCCH: DCI-Related]

Next, the downlink control information (DCI) in the 5G system will be described in detail.

In the 5G system, scheduling information regarding uplink data (or, physical uplink shared channel (PUSCH)) or downlink data (or, physical downlink shared channel (PDSCH)) is delivered from the base station to the UE through DCI. The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), which is a physical downlink control channel, through a channel coding and modulation process. A cyclic redundancy check (CRC) is attached to the payload of a DCI message, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted, but is transmitted by being included in the CRC calculation process. Upon receiving a DCI message transmitted over the PDCCH, the UE may perform a CRC check by using the assigned RNTI, and if the CRC check result is correct, the UE may know that the corresponding message has been transmitted to it.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with C-RNTI (cell RNTI).

DCI format 0_0 may be used as fallback DCI for scheduling a PUSCH, where the CRC may be scrambled with a C-RNTI. DCI format 0_0 having a CRC scrambled with a C-RNTI may include, for example, the following information.

TABLE 4

| - | Identifier for DCI formats - [1] bit |
|---|---|
| - | Frequency domain resource assignment - |
| [┌log₂( N_{RB}^{UL, BWP} (N_{RB}^{UL, BWP} + 1)/2)┐] bits | |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL indicator - 0 or 1 bit |

DCI format 0_1 may be used as non-fallback DCI for scheduling a PUSCH, where the CRC may be scrambled with a C-RNTI. DCI format 0_1 having a CRC scrambled with a C-RNTI may include, for example, the following information.

TABLE 5

| | |
|---|---|
| - | Carrier indicator - 0 or 3 bits |
| - | UL/SUL indicator - 0 or 1 bit |
| - | Identifier for DCI formats - bits |
| - | Bandwidth part indicator - 0, 1 or 2 bits |
| - | Frequency domain resource assignment |

For resource
allocation type 0,
┌N_{RB}^{UL, BWP} /P]bits
For resource allocation type 1,
┌log₂( N_{RB}^{UL, BWP} (N_{RB}^{UL, BWP} + 1)/2)┐ bits

| | |
|---|---|
| - | Time domain resource assignment -1, 2, 3, or 4 bits |
| - | VRB-to-PRB mapping - 0 or |
| | 1 bit, only for resource allocation |

type 1.
0 bit if only resource allocation type 0 is configured;
1 bit otherwise.

| | |
|---|---|
| - | Frequency hopping flag - 0 or |
| | 1 bit, only for resource allocation |

type 1.
0 bit if only resource allocation type 0 is configured;
1 bit otherwise.

| | |
|---|---|
| - | Modulation and coding scheme - 5 bits |
| - | New data indicator - 1 bit |
| - | Redundancy version - 2 bits |
| - | HARQ process number - 4 bits |
| - | 1st downlink assignment index - 1 or 2 bits |

1 bit for semi-static HARQ-ACK codebook;
2 bits for dynamic HARQ-ACK codebook with single HARQ-ACK
codebook.

| | |
|---|---|
| - | 2nd downlink assignment index - 0 or 2 bits |

2 bits for dynamic HARQ-ACK codebook with two HARQ-ACK sub-
codebooks;
0 bit otherwise.

| | |
|---|---|
| - | TPC command for scheduled PUSCH - 2 bits |
| - | SRS resource indicator - ┌log₂ (Σ_{k = 1}^{L}^{ₘₐₓ}(ₖ^{N}^{_{SRS}}))┐ or |

┌log₂(N_{SRS})] bits
┌log₂ (Σ_{k = 1}^{L}^{ₘₐₓ}(ₖ^{N}^{_{SRS}}))┐ bits for non-codebook based PUSCH
transmission;
┌log₂(N_{SRS})] bits for codebook based PUSCH transmission.

| | |
|---|---|
| - | Precoding information and |
| | number of layers - up to 6 bits |
| - | Antenna ports - up to 5 bits |
| - | SRS request - 2 bits |
| - | CSI request - 1, 2, 3, 4, 5, or 6 bits |
| - | CBG transmission information - 0, 2, 4, 6, or 8 bits |
| - | PTRS-DMRS association - 0 or 2 bits. |
| - | beta_offset indicator - 0 or 2 bits |
| - | DMRS sequence initialization - 0 or 1 bit |

DCI format 1_0 may be used as fallback DCI for scheduling a PDSCH, where the CRC may be scrambled with a C-RNTI. DCI format 1_0 having a CRC scrambled with a C-RNTI may include, for example, the following information.

TABLE 6

| - | Identifier for DCI formats - [1] bit |
|---|---|
| - | Frequency domain resource assignment - |
| [┌log₂( N_{RB}^{DL, BWP} (N_{RB}^{DL, BWP} + 1)/2)┐] bits | |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator - [3] bits |

DCI format 1_1 may be used as non-fallback DCI for scheduling a PDSCH, where the CRC may be scrambled with a C-RNTI. DCI format 1_1 having a CRC scrambled with a C-RNTI may include, for example, the following information.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

For resource
allocation type 0,
┌N_{RB}^{DL, BWP} /P┐bits
For resource allocation type 1,
┌log₂( N_{RB}^{DL, BWP} (N_{RB}^{DL, BWP} + 1)/2)┐ bits

| | |
|---|---|
| - | Time domain resource assignment -1, 2, 3, or 4 bits |
| - | VRB-to-PRB mapping - 0 or 1 bit, only for resource allocation |

type 1.
0 bit if only resource allocation type 0 is configured;
1 bit otherwise.

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, Search Space]

Next, a detailed description will be given of a downlink control channel in a 5G communication system with reference to the drawings.

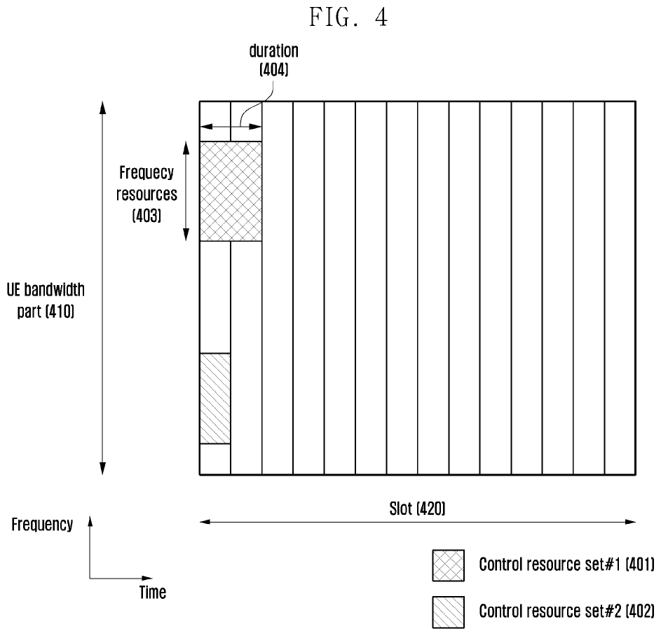

FIG. 4 is a diagram illustrating an example of a control resource set (CORESET) through which a downlink control channel is transmitted in a 5G wireless communication system. FIG. 4 illustrates an example in which a UE bandwidth part 410 is configured on the frequency domain and two control resource sets (control resource set #1 (401) and control resource set #2 (402)) are configured in one slot 420 on the time domain. Control resource sets 401 and 402 may be configured on a specific frequency resource 403 within the entire UE bandwidth part 410 in the frequency domain. The control resource sets 401 and 402 may be configured as one or multiple OFDM symbols in the time domain, and this may be defined as a control resource set duration 404. In the example shown in FIG. 4, control resource set #1 (401) is configured with a control resource set duration of two symbols, and control resource set #2 (402) is configured with a control resource set duration of one symbol.

The control resource set in 5G described above may be configured to the UE by the base station through higher layer signaling (e.g., system information, master information block (MIB), and radio resource control (RRC) signaling). Configuring a control resource set to the UE may mean providing information such as a control resource set identity, a frequency location of the control resource set, a symbol duration of the control resource set, and the like. For example, the following information may be included.

TABLE 8

| ControlResourceSet ::= | |
|---|---|
| SEQUENCE { | |
| -- Corresponds to L1 parameter ‘CORESET-ID’ | |
| controlResourceSetId | |
| ControlResourceSetId, | |
| frequencyDomainResources | BIT |
| STRING (SIZE (45)), | |
| duration | |
| INTEGER (1..maxCoReSetDuration), | |
| cce-REG-MappingType | |
| CHOICE { | |
| interleaved | |
| SEQUENCE { | |
| reg-BundleSize | |
| ENUMERATED {n2, n3, n6}, | |
| precoderGranularity | |
| ENUMERATED | {sameAsREG-bundle, |
| allContiguousRBs}, | |
| interleaverSize | |
| ENUMERATED {n2, n3, n6} | |
| shiftIndex | |
| INTEGER(0..maxNrofPhysicalResourceBlocks- | |
| 1) | |
| OPTIONAL | |
| }, | |
| nonInterleaved | |
| NULL | |
| }, | |
| tci-StatesPDCCH | |
| SEQUENCE(SIZE (1..maxNrofTCI-StatesPDCCH)) OF TCI- | |
| StateId | OPTIONAL, |

```
  tci-PresentInDCI
  ENUMERATED {enabled}
  OPTIONAL, -- Need S
}
```

In Table 8, tci-StatesPDCCH (simply referred to as transmission configuration indication (TCI) state) configuration information may include information about one or more synchronization signal (SS)/physical broadcast channel (PBCH) block indexes or channel state information reference signal (CSI-RS) indexes in a quasi-co-located (QCLed) relationship with a demodulation reference signal (DMRS) transmitted in the corresponding control resource set.

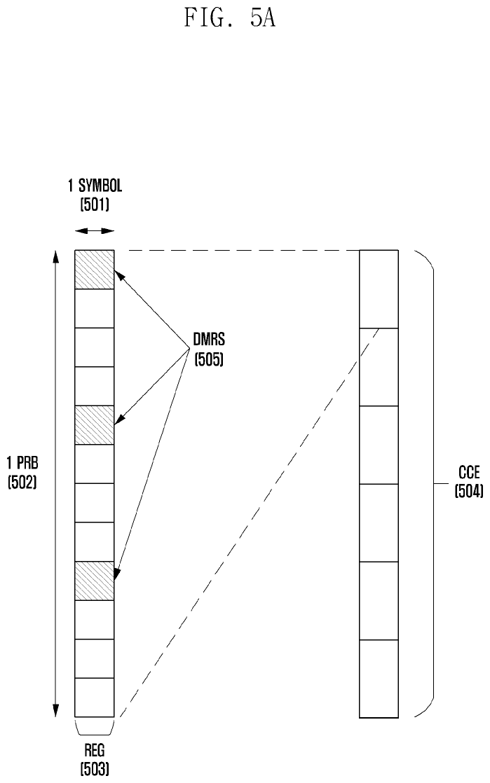

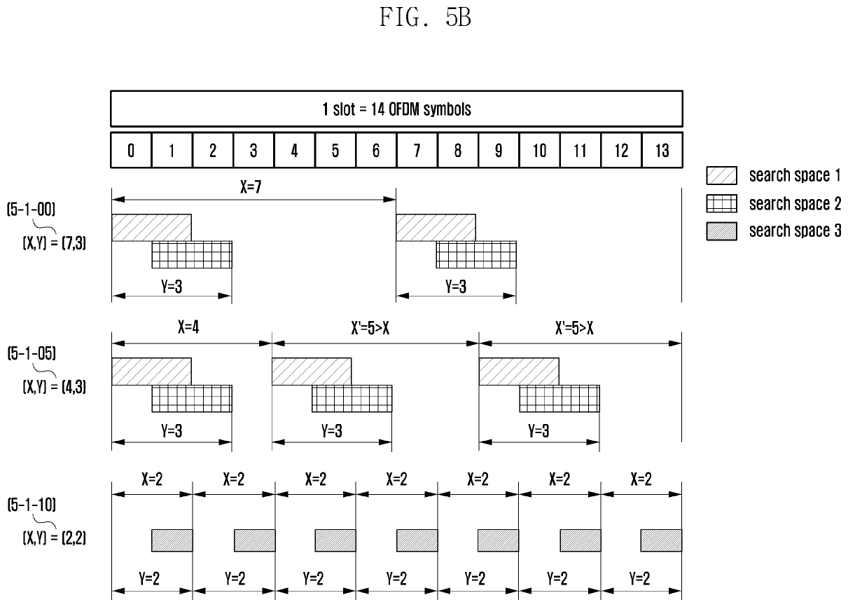

FIG. 5A is a diagram showing an example of the basic unit of time-frequency resources constituting a downlink control channel that may be used in 5G. With reference to FIG. 5A, the basic unit of time-frequency resources constituting a control channel may be referred to as a resource element group (REG) 503, and the REG 503 may be defined as one OFDM symbol 501 in the time domain and one physical resource block (PRB) 502, that is, 12 subcarriers, in the frequency domain. The base station may concatenate REGs 503 to compose a downlink control channel allocation unit.

As illustrated in FIG. 5A, when the basic unit to which the downlink control channel is assigned in 5G is a control channel element (CCE) 504, one CCE 504 may be composed of plural REGs 503. Taking the REG 503 shown in FIG. 5A as an example, when the REG 503 includes 12 REs and one CCE 504 includes 6 REGs 503, one CCE 504 may include 72 REs. When a downlink control resource set is configured, the corresponding region may be composed of multiple CCEs 504, and a specific downlink control channel may be transmitted after being mapped to one or multiple CCEs 504 according to an aggregation level (AL) in the control resource set. The CCEs 504 in a control resource set may be identified by numbers, in which case the numbers may be assigned to the CCEs 504 according to a logical mapping scheme.

The basic unit of the downlink control channel illustrated in FIG. 5A, that is, the REG 503, may include both REs to which the DCI is mapped and a region to which a DMRS 505 being a reference signal for decoding the DCI is mapped. As illustrated in FIG. 5A, three DMRSs 505 may be transmitted in one REG 503. The number of CCEs required to transmit the PDCCH may be 1, 2, 4, 8, or 16 according to the aggregation level (AL), and different number of CCEs may be used to implement link adaptation of the downlink control channel. For example, when AL=L, one downlink control channel may be transmitted through L CCEs. The UE has to detect a signal without having information about the downlink control channel, and a search space representing a set of CCEs is defined for blind decoding. The search space may refer to a set of downlink control channel candidates composed of CCEs to which the UE has to attempt decoding on a given aggregation level. Because there are various aggregation levels that groups 1, 2, 4, 8, or 16 CCEs into one bundle, the UE may have plural search spaces. The search space set may be defined as a set of search spaces at all configured aggregation levels.

A search space may be classified as a common search space and a UE-specific search space. A group of UEs or all UEs may search for a common search space of the PDCCH to receive cell-common control information such as dynamic scheduling of system information or a paging message. For example, PDSCH scheduling allocation information for transmitting an SIB including cell operator information or the like may be received by searching for the common search space of the PDCCH. Since a group of UEs or all UEs need to receive the PDCCH, a common search space may be defined as a set of CCEs agreed upon in advance. Scheduling allocation information for a UE-specific PDSCH or PUSCH may be received by searching for a UE-specific search space of the PDCCH. A UE-specific search space may be defined in a UE-specific way as a function of UE identity and various system parameters.

In 5G, parameters for a search space for the PDCCH may be configured by the base station to the UE via higher layer signaling (e.g., SIB, MIB, or RRC signaling). For example, the base station may configure, to the UE, the number of PDCCH candidates at each aggregation level L, a periodicity of monitoring the search space, a search space monitoring occasion in units of symbols within a slot, a search space type (common search space or UE-specific search space), a DCI format-RNTI combination to be monitored in a corresponding search space, a control resource set index at which a search space is to be monitored, and the like. For example, the following information may be included.

```
TABLE 9
SearchSpace ::=
    SEQUENCE {
    -- Identity of the search space. SearchSpaceId = 0 identifies the
SearchSpace configured via PBCH (MIB) or
ServingCellConfigCommon.
    searchSpaceId
    SearchSpaceId,
    controlResourceSetId
    ControlResourceSetId,
```

| | |
|---|---|
| monitoringSlotPeriodicityAndOffset | CHOICE { |

```
      sl1
        NULL,
      sl2
        INTEGER (0..1),
      sl4
        INTEGER (0..3),
      sl5
      INTEGER (0..4),
      sl8
        INTEGER (0..7),
      sl10
      INTEGER (0..9),
      sl16
      INTEGER (0..15),
      sl20
      INTEGER (0..19)
    }
        OPTIONAL,
```

| | |
|---|---|
| duration | INTEGER (2..2559) |

```
    monitoringSymbolsWithinSlot
    BIT STRING (SIZE (14))
    OPTIONAL,
    nrofCandidates
    SEQUENCE {
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
    searchSpaceType
    CHOICE {
      -- Configures this search space as common search space
(CSS) and DCI formats to monitor.
      common
        SEQUENCE {
    }
      ue-Specific
      SEQUENCE {
        -- Indicates whether the UE monitors in this USS
for DCI formats 0-0 and 1-0 or for formats 0-1 and 1-1.
        formats
```

| | |
|---|---|
| ENUMERATED | {formats0-0-And-1-0, |

```
formats0-1-And-1-1},
        ...
      }
```

Based on the configuration information, the base station may configure one or multiple search space sets to the UE. According to some embodiments, the base station may configure the UE with search space set 1 and search space set 2 so as to monitor DCI format A scrambled with X-RNTI in a common search space of search space set 1, and monitor DCI format B scrambled with Y-RNTI in a UE-specific search space of search space set 2.

According to the configuration information, one or multiple search space sets may be present in a common search space or a UE-specific search space. For example, search space set #1 and search space set #2 may be configured as a common search space, and search space set #3 and search space set #4 may be configured as a UE-specific search space.

In a common search space, the following combination of a DCI format and an RNTI may be monitored. However, it is not limited to the examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the following combination of a DCI format and an RNTI may be monitored. However, it is not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above-described RNTIs may follow the definition and usage described below.
C-RNTI (cell RNTI): used for scheduling UE-specific PDSCH
TC-RNTI (temporary cell RNTI): used for scheduling UE-specific PDSCH
CS-RNTI (configured scheduling RNTI): used for scheduling semi-statically configured UE-specific PDSCH
RA-RNTI (random access RNTI): used for scheduling PDSCH at random access stage
P-RNTI (paging RNTI): used for scheduling PDSCH in which paging is transmitted
SI-RNTI (system information RNTI): used for scheduling PDSCH in which system information is transmitted
INT-RNTI (interruption RNTI): used for indicating whether to perform puncturing on PDSCH
TPC-PUSCH-RNTI (transmit power control for PUSCH RNTI): used for issuing a power control command for PUSCH
TPC-PUCCH-RNTI (transmit power control for PUCCH RNTI): used for issuing a power control command for PUCCH
TPC-SRS-RNTI (transmit power control for SRS RNTI): used for issuing a power control command for SRS

The DCI formats specified above may follow the definitions below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

With control resource set p and search space set s in 5G, the search space at aggregation level L may be represented as in Equation 2 below.

$$L \cdot \{ ( {y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad [ Equation 2 ]$$

L: aggregation level
n_{CI}: carrier index
N_{CCE,p}: total number of CCEs present in control resource set p
n_{s,f}^{μ}: slot index
M_{s,max}^{(L)}: number of PDCCH candidates at aggregation level L
m_{s,n}_{_{CI}}=0, . . . , M_{s,max}⁽²⁾−1: PDCCH candidate index at aggregation level L
i=0, . . . , L−1
Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The value of Y_{p,n}_{_{s,f}}_{^{μ}} may correspond to 0 for the common search space.

For the UE-specific search space, the value of Y_{p,n}_{_{s,f}}_{^{μ}} may correspond to a value that changes according to the UE identity (C-RNTI or ID configured by the base station to the UE) and the time index.

In 5G, since a plurality of search space sets may be configured with different parameters (e.g., parameters in Table 9), the group of search space sets monitored by the UE may vary at each time point. For example, if search space set #1 is configured with a X-slot periodicity, and search space set #2 is configured with a Y-slot periodicity, where X and Y are different, the UE may monitor both search space set #1 and search space set #2 in a specific slot, and may monitor either search space set #1 or search space set #2 in another specific slot.

### [PDCCH: Span]

The UE may perform UE capability reporting at each subcarrier spacing for cases where it has multiple PDCCH monitoring occasions within a slot, in which case the concept of span may be used. A span refers to consecutive symbols in a slot at which the UE may monitor the PDCCH, and individual PDCCH monitoring occasions are within one span. A span may be denoted by (X, Y), where X indicates the minimum number of symbols that should be separated between the first symbols of two consecutive spans, and Y indicates the number of consecutive symbols at which the UE may monitor the PDCCH within one span. Here, the UE may monitor the PDCCH in a range from the first symbol of the span to Y symbols within the span.

FIG. 5B is a diagram illustrating a case where a UE may have multiple PDCCH monitoring occasions within a slot by use of a span in a wireless communication system. A span may be denoted by (X,Y), and (7, 3), (4, 3) and (2, 2) are possible, where these three cases are indicated respectively by (5-1-00), (5-1-05), (5-1-10) in FIG. 5B. For example, (5-1-00) indicates a case represented by (7, 4) where two spans may be present in a slot. The gap between the first symbols of two spans is expressed as X=7, a PDCCH monitoring occasion may present within a total of Y=3 symbols starting from the first symbol of each span, and search space 1 and search space 2 are present within the Y=3 symbols. As another example, (5-1-05) indicates a case represented by (4, 3) where a total of three spans are present in a slot and the gap between the second and third spans is X′=5 symbols greater than X=4.

### [PDCCH: UE Capability Reporting]

The slot position in which the above-described common search space and UE-specific search space are located is indicated by parameter “monitoringSymbolsWithinSlot” in Table 11-1, and the symbol position in the slot is indicated by a bitmap through parameter “monitoringSymbolsWithinSlot” in Table 9. The symbol position within a slot in which the UE may monitor the search space may be reported to the base station through the following UE capabilities.
UE capability 1 (hereinafter referred to as “FG 3-1”). This UE capability indicates, in the case where one monitoring occasion (MO) for type 1 and type 3 common search spaces or UE-specific search spaces is present in the slot as shown in Table 11-1 below, the capability of monitoring the corresponding MO when the corresponding MO is positioned at the first three symbols in the slot. This UE capability is a mandatory capability that all UEs supporting NR must support, and whether to support this capability is not explicitly reported to the base station.

TABLE 11-1

| | | | Field |
|---|---|---|---|
| | | | name |
| | Feature | | in TS 38.331 |
| Index | group | Components | [2] |
| 3-1 | Basic | 1) One configured | n/a |
| | DL | CORESET per BWP per | |
| | control | cell in addition to CORESET0 | |
| | channel | CORESET resource allocation of 6RB | |
| | | bit-map and duration of 1-3 OFDM | |
| | | symbols for FR1 | |
| | | For type 1 CSS without dedicated RRC | |
| | | configuration and for type 0, 0A, and 2 | |
| | | CSSs, CORESET resource allocation of | |
| | | 6RB bit-map and duration 1-3 OFDM | |
| | | symbols for FR2 | |
| | | For type 1 CSS with dedicated RRC | |
| | | configuration and for type 3 CSS, UE | |
| | | specific SS, CORESET resource allocation | |
| | | of 6RB bit-map and duration 1-2 OFDM | |
| | | symbols for FR2 | |
| | | REG-bundle sizes of 2/3 RBs or 6 RBs | |
| | | Interleaved and non-interleaved CCE-to- | |
| | | REG mapping | |
| | | Precoder-granularity of REG-bundle size | |
| | | PDCCH DMRS scrambling determination | |
| | | TCI state(s) for a CORESET | |
| | | configuration | |
| | | 2) CSS and UE-SS configurations for | |
| | | unicast PDCCH transmission per BWP per | |
| | | cell | |
| | | PDCCH aggregation levels 1, 2, 4, 8, 16 | |
| | | UP to 3 search space sets in a slot for a | |
| | | scheduled SCell per BWP | |
| | | This search space limit is before applying | |
| | | all dropping rules. | |
| | | For type 1 CSS with dedicated RRC | |
| | | configuration, type 3 CSS, and UE-SS, the | |
| | | monitoring occasion is within the first 3 | |
| | | OFDM symbols of a slot | |
| | | For type 1 CSS without dedicated RRC | |
| | | configuration and for type 0, 0A, and 2 | |
| | | CSS, the monitoring occasion can be any | |
| | | OFDM symbol(s) of a slot, with the | |
| | | monitoring occasions for any of Type 1- | |
| | | CSS without dedicated | |
| | | RRC configuration, | |
| | | or Types 0, 0A, or 2 CSS configurations | |
| | | within a single span of three consecutive | |
| | | OFDM symbols within a slot | |
| | | 3) Monitoring DCI formats | |
| | | 0_0, 1_0, 0_1, 1_1 | |
| | | 4) Number of PDCCH blind decodes per | |
| | | slot with a given SCS follows Case 1-1 | |
| | | table | |
| | | 5) Processing one unicast DCI scheduling | |
| | | DL and one unicast | |
| | | DCI scheduling UL per | |
| | | slot per scheduled CC for FDD | |
| | | 6) Processing one unicast DCI scheduling | |
| | | DL and 2 unicast DCI scheduling UL per | |
| | | slot per scheduled CC for TDD | |

UE capability 2 (hereinafter referred to as “FG 3-2”). This UE capability indicates, in the case where one monitoring occasion (MO) for a common search space or a UE-specific search space is present in the slot as shown in Table 11-2 below, the capability of monitoring the MO regardless of the location of the start symbol of the corresponding MO. This UE capability may be selectively supported by the UE (optional), and whether to support this capability is explicitly reported to the base station.

TABLE 11-2

| | Feature | | Field name |
|---|---|---|---|
| Index | Group | Components | in TS 38.331 [2] |
| 3-2 | PDCCH | For a given UE, all | pdcchMoni- |
| | monitoring | search space | toringSingleOccasion |
| | on any span | configurations are | |
| | of up to 3 | within the | |
| | consecutive | same span | |
| | OFDM | of 3 consecutive | |
| | symbols of | OFDM symbols | |
| | a slot | in the slot | |

UE capability 3 (hereinafter referred to as “FG 3-5, 3-5a, or 3-5b”). This UE capability indicates, in the case where a plurality of monitoring occasions (MOs) for a common search space or a UE-specific search space are present in the slot as shown in Table 11-3 below, a pattern of the MO capable of being monitored by the UE. The above-described pattern is composed of gap X between start symbols of different MOs and maximum symbol length Y for one MO. The combination (X, Y) supported by the UE may be one or more of {(2, 2), (4, 3), (7, 3)}. This UE capability may be selectively supported by the UE (optional), and whether to support this capability and the above-mentioned combination (X, Y) is explicitly reported to the base station.

TABLE 11-3

| | | | Field name |
|---|---|---|---|
| | | | in TS 38.331 |
| Index | Feature group | Components | [2] |
| 3-5 | For type 1 | For type 1 CSS with | pdcch- |
| | CSS with | dedicated RRC | MonitoringAnyOccasions |
| | dedicated | configuration, type 3 CSS, | {3-5. withoutDCI-Gap |
| | RRC | and UE-SS, monitoring | 3-5a. withDCI-Gap} |
| | configuration, | occasion can be any OFDM | |
| | type 3 CSS, | symbol(s) of a slot for Case | |
| | and UE-SS, | 2 | |
| | monitoring | | |
| | occasion can | | |
| | be any | | |
| | OFDM | | |
| | symbol(s) of | | |
| | a slot for Case | | |
| | 2 | | |
| 3-5a | For type 1 | For type 1 CSS with | |
| | CSS with | dedicated RRC | |
| | dedicated | configuration, type 3 CSS | |
| | RRC | and UE-SS, monitoring | |
| | configuration, | occasion can be any OFDM | |
| | type 3 CSS, | symbol(s) of a slot for Case | |
| | and UE-SS, | 2, with minimum time | |
| | monitoring | separation (including the | |
| | occasion can | cross-slot boundary case) | |
| | be any | between two DL unicast | |
| | OFDM | DCIs, between two UL | |
| | symbol(s) of | unicast DCIs, or between a | |
| | a slot for Case | DL and an UL unicast DCI | |
| | 2 with a DCI | in different monitoring | |
| | gap | occasions where | |
| | | at least one | |
| | | of them is not the | |
| | | monitoring occasions of | |
| | | FG-3-1, for a same UE as | |
| | | 2OFDM symbols | |
| | | for 15 kHz | |
| | | 4OFDM symbols | |
| | | for 30 kHz | |
| | | 7OFDM symbols | |
| | | for 60 kHz with NCP | |
| | | 11OFDM symbols | |
| | | for 120 kHz | |
| | | Up to one unicast DL DCI | |
| | | and up to one unicast UL | |
| | | DCI in a monitoring | |
| | | occasion except for the | |
| | | monitoring occasions of FG | |
| | | 3-1. | |
| | | In addition for TDD the | |
| | | minimum separation | |
| | | between the first two UL | |
| | | unicast DCIs within the first | |
| | | 3 OFDM symbols of a slot | |
| | | can be zero OFDM | |
| | | symbols. | |
| 3-5b | All PDCCH | PDCCH monitoring | |
| | monitoring | occasions of FG-3-1, plus | |
| | occasion can | additional PDCCH | |
| | be any | monitoring occasion(s) can | |
| | OFDM | be any OFDM symbol(s) of | |
| | symbol(s) of | a slot for Case 2, and for | |
| | a slot for Case | any two PDCCH | |
| | 2 with a span | monitoring occasions | |
| | gap | belonging to different | |
| | | spans, where at least one of | |
| | | them is not the monitoring | |
| | | occasions of FG-3-1, in | |
| | | same or different search | |
| | | spaces, there is a minimum | |
| | | time separation of X OFDM | |
| | | symbols | |
| | | (including the | |
| | | cross-slot boundary case) | |
| | | between the start of two | |
| | | spans, where each span is of | |
| | | length up to Y consecutive | |
| | | OFDM symbols of a slot. | |
| | | Spans do not overlap. Every | |
| | | span is contained in a single | |
| | | slot. The same span pattern | |
| | | repeats in every slot. The | |
| | | separation between | |
| | | consecutive spans within | |
| | | and across slots may be | |
| | | unequal but the same (X, Y) | |
| | | limit must be satisfied by all | |
| | | spans. Every monitoring | |
| | | occasion is fully contained | |
| | | in one span. In order to | |
| | | determine a suitable span | |
| | | pattern, first a bitmap b(l), | |
| | | 0 <= 1 <= 13 is generated, | |
| | | where b(l) = 1 if symbol l of | |
| | | any slot is part of a | |
| | | monitoring occasion, b(l) = 0 | |
| | | otherwise. The first span in | |
| | | the span pattern begins at | |
| | | the smallest l for which | |
| | | b(l) = 1. The next span in the | |
| | | span pattern begins at the | |
| | | smallest l not included in | |
| | | the previous span(s) for | |
| | | which b(l) = 1. The span | |
| | | duration is max{maximum | |
| | | value of all CORESET | |
| | | durations, minimum value | |
| | | of Y in the UE reported | |
| | | candidate value} except | |
| | | possibly the last span in a | |
| | | slot which can be of shorter | |
| | | duration. A particular | |
| | | PDCCH monitoring | |
| | | configuration meets the UE | |
| | | capability limitation if the | |
| | | span arrangement satisfies | |
| | | the gap separation for at | |
| | | least one (X, Y) in the UE | |
| | | reported candidate value set | |
| | | in every slot, including | |
| | | cross slot boundary. | |
| | | For the set of monitoring | |
| | | occasions which are within | |
| | | the same span: | |
| | | Processing one | |
| | | unicast DCI scheduling DL | |
| | | and one unicast DCI | |
| | | scheduling UL | |
| | | per | |
| | | scheduled CC across this | |
| | | set of monitoring occasions | |
| | | for FDD | |
| | | Processing one | |
| | | unicast DCI scheduling DL | |
| | | and two unicast DCI | |
| | | scheduling UL per | |
| | | scheduled CC across this | |
| | | set of monitoring occasions | |
| | | for TDD | |
| | | Processing two | |
| | | unicast DCI scheduling DL | |
| | | and one unicast DCI | |
| | | scheduling UL per | |
| | | scheduled CC across this | |
| | | set of monitoring occasions | |
| | | for TDD | |
| | | The number of different | |
| | | start symbol indices of | |
| | | spans for all PDCCH | |
| | | monitoring occasions per | |
| | | slot, including PDCCH | |
| | | monitoring occasions of | |
| | | FG-3-1, is no more than | |
| | | floor(14/X) (X is minimum | |
| | | among values reported by | |
| | | UE). | |
| | | The number of different | |
| | | start symbol indices of | |
| | | PDCCH monitoring | |
| | | occasions per slot including | |
| | | PDCCH monitoring | |
| | | occasions of FG-3-1, is no | |
| | | more than 7. | |
| | | The number of different | |
| | | start symbol indices of | |
| | | PDCCH monitoring | |
| | | occasions per half-slot | |
| | | including PDCCH | |
| | | monitoring occasions of | |
| | | FG-3-1 is no more than 4 in | |
| | | SCell. | |

The UE may report whether to support the above-described UE capability 2 and/or UE capability 3 and related parameters to the base station. The base station may perform time domain resource allocation for a common search space and a UE-specific search space based on the reported UE capabilities. The base station may perform resource allocation described above so that the MO is not located at a position that the UE cannot monitor.

### [PDCCH: BD/CCE Limit]

In the case where a plurality of search space sets is configured to the UE, the following conditions may be considered in a method for determining a search space set to be monitored by the UE.

If the value of “monitoringCapabilityConfig-r16” being higher layer signaling is configured as “r15monitoringcapability”, the UE defines the maximum value for the number of PDCCH candidates capable of being monitored and the number of CCEs constituting the entire search space (here, the entire search space indicates an entire CCE set corresponding to the union of plural search space sets) for each slot; and if the value of “monitoringCapabilityConfig-r16” is configured as “r16monitoringcapability”, the UE defines the maximum value for the number of PDCCH candidates capable of being monitored and the number of CCEs constituting the entire search space (here, the entire search space indicates an entire CCE set corresponding to the union of plural search space sets) for each span.

### [Condition 1: Limitation on Maximum Number of PDCCH Candidates]

According to the configuration value of higher layer signaling described above, M^{μ}, the maximum number of PDCCH candidates capable of being monitored by the UE, may be set according to Table 12-1 below if being defined based on a slot in a cell having a subcarrier spacing of 15·2^{μ} kHz, and may be set according to Table 12-2 below if being defined based on a span.

TABLE 12-1

| | Maximum number of PDCCH candidates per slot |
|---|---|
| μ | and per serving cell (M^{μ}) |
| 0 | 44 |
| 1 | 36 |
| 2 | 22 |
| 3 | 20 |

TABLE 12-2

| | Maximum number M^{μ} of monitored PDCCH | | |
|---|---|---|---|
| | candidates per span for combination (X, Y) and per | | |
| | serving cell | | |
| μ | (2, 2) | (4, 3) | (7, 3) |
| 0 | 14 | 28 | 44 |
| 1 | 12 | 24 | 36 |

### [Condition 2: Limitation on Maximum Number of CCEs]

According to the configuration value of higher layer signaling described above, CH, the maximum number of CCEs constituting the entire search space (here, the entire search space indicates the entire CCE set corresponding to the union of plural search space sets), may be set according to Table 12-3 below if being defined based on a slot in a cell having a subcarrier spacing of 15.24 kHz, and may be set according to Table 12-4 below if being defined based on a span.

TABLE 12-3

| | Maximum number of non-overlapped CCEs per slot and per |
|---|---|
| μ | serving cell (C^{μ}) |
| 0 | 56 |
| 1 | 56 |
| 2 | 48 |
| 3 | 32 |

TABLE 12-4

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For convenience of explanation, a situation that satisfies both condition 1 and condition 2 at a specific time is defined as “condition A”. Hence, a situation that does not satisfy condition A may indicate that the situation does not satisfy at least one of condition 1 or condition 2 above.

### [Pdcch: Overbooking]

Condition A may be not satisfied at a specific time depending on the configuration of search space sets by the base station. If condition A is not satisfied at a specific time, the UE may select and monitor only some of the search space sets configured so as to satisfy condition A at that time, and the base station may transmit a PDCCH through the selected search space sets.

Selection of some search spaces from among the total configured search space sets may be performed according to the following methods.

If condition A for the PDCCH is not satisfied at a specific time (slot), the UE (or the base station) may select a search space set whose search space type is a common search space from among the search space sets present at the corresponding time in preference to a search space set whose search space type is a UE-specific search space.

If all search space sets configured as a common search space are selected (i.e., condition A is still satisfied even after selecting all search spaces configured as a common search space), the UE (or the base station) may select search space sets configured as a UE-specific search space. Here, if there are a plurality of search space sets configured as a UE-specific search space, the search space set having a lower search space set index may have a higher priority. UE-specific search space sets may be selected within the range where condition A is satisfied in consideration of priority.

### [QCL, TCI State]

In a wireless communication system, one or more different antenna ports (these may be replaced with one or more channels, signals, or a combination thereof, but will be collectively referred to as “different antenna ports” in the following description of the disclosure for convenience) may be associated with each other according to quasi co-location (QCL) configuration as shown in Table 10 below. The TCI state is intended to notify a QCL relationship between a PDCCH (or PDCCH DMRS) and another RS or channel; when a specific reference antenna port A (reference RS #A) and another target antenna port B (target RS #B) are quasi co-located (QCLed), this indicates that the UE is allowed to apply some or all of large-scale channel parameters estimated from the antenna port A to channel measurement from the antenna port B. QCL may be required to associate different parameters depending on the situation, such as 1) time tracking affected by average delay and delay spread, 2) frequency tracking affected by Doppler shift and Doppler spread, 3) radio resource management (RRM) affected by average gain, 4) beam management (BM) affected by spatial parameters, and the like. Accordingly, NR supports four types of QCL relationships as shown in Table 13 below.

TABLE 13

| QCL type | Large-scale characteristics |
|---|---|
| A | Doppler shift, Doppler spread, average delay, delay spread |
| B | Doppler shift, Doppler spread |
| C | Doppler shift, average delay |
| D | Spatial Rx parameter |

Spatial RX parameters may refer to some or all of various parameters such as angle of arrival (AoA), power angular spectrum (PAS) of AoA, angle of departure (AoD), PAS of AoD, transmit/receive channel correlation, transmit/receive beamforming, spatial channel correlation, and the like.

The QCL relationship may be configured to the UE through RRC parameters TCI-State and QCL-Info as shown in Table 14 below. With reference to Table 14, the base station may configure one or more TCI states for the UE and notify the UE of up to two QCL relationships (qcl-Type1 and qcl-Type2) about the RS referring to the ID of a TCI state, that is, the target RS. Here, each piece of QCL information (QCL-Info) included in each TCI state includes a serving cell index and a BWP index associated with the reference RS indicated by the corresponding QCL information, the type and ID of the reference RS, and the QCL type as shown in Table 13 above.

TABLE 14

| TCI-State ::= | SEQUENCE { |
|---|---|
| tci-StateId | |
| TCI-StateId, | |
| qcl-Type1 | |
| QCL-Info, | |
| qcl-Type2 | |
| QCL-Info | OPTIONAL, -- |
| Need R | |
| ... | |
| } | |
| QCL-Info ::= | SEQUENCE { |
| cell | |
| ServCellIndex | OPTIONAL, -- Need R |

```
  bwp-Id
  BWP-Id
  OPTIONAL, -- Cond CSI-RS-Indicated
  referenceSignal
  CHOICE {
    csi-rs
  NZP-CSI-RS-ResourceId,
    ssb
    SSB-Index
  },
  qcl-Type
  ENUMERATED {typeA, typeB, typeC, typeD},
  ...
}
```

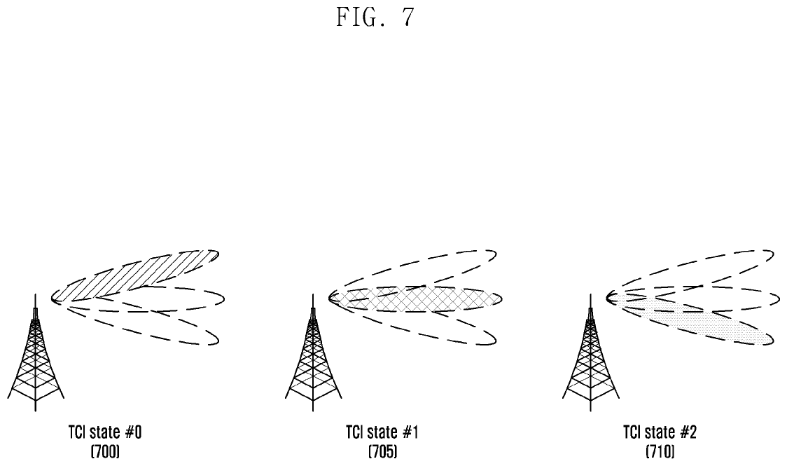

FIG. 7 is a diagram showing an example of base station beam allocation according to the TCI state configuration. With reference to FIG. 7, the base station may transmit information about N different beams to the UE through N different TCI states. For example, in the case of N=3 as shown in FIG. 7, the base station may configure parameter “qcl-Type2” included in three TCI states 700, 705 and 710 as being associated with CSI-RSs or SSBs corresponding to different beams and as being QCL type D, thereby notifying that the antenna ports referring to the different TCI states 700, 705 and 710 are associated with different spatial Rx parameters, that is, different beams.

Tables 15-1 to 15-5 below illustrate valid TCI state configurations according to target antenna port types.

Table 15-1 illustrates valid TCI state configurations when the target antenna port is a CSI-RS for tracking (TRS). The TRS indicates an NZP CSI-RS whose repetition parameter is not configured and trs-Info is set to “true” among the CSI-RSs. Configuration 3 in Table 15-1 may be used for aperiodic TRS.

TABLE 15-1
Valid TCI state configurations when target
antenna port is CSI-RS for tracking (TRS)

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS (periodic) | QCL-TypeA | TRS (same as DL RS | QCL-TypeD |
| | | | 1) | |

Table 15-2 illustrates valid TCI state configurations when the target antenna port is a CSI-RS for CSI. The CSI-RS for CSI indicates an NZP CSI-RS whose parameter indicating repetition (e.g., repetition parameter) is not configured and trs-Info is not set to “true” among the CSI-RSs.

TABLE 15-2
Valid TCI state configurations when target antenna port is CSI-RS for CSI

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 15-3 illustrates valid TCI state configurations when the target antenna port is a CSI-RS for beam management (BM, same meaning as a CSI-RS for L1 RSRP reporting). The CSI-RS for BM indicates an NZP CSI-RS whose repetition parameter is configured to have a value of On or Off and trs-Info is not set to “true” among the CSI-RSs.

TABLE 15-3
Valid TCI state configurations when target antenna
port is CSI-RS for BM (for L1 RSRP reporting)

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH Block | QCL-TypeC | SS/PBCH Block | QCL-TypeD |

Table 15-4 illustrates valid TCI state configurations when the target antenna port is a PDCCH DMRS.

TABLE 15-4
Valid TCI state configurations when target antenna port is PDCCH DMRS

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 illustrates valid TCI state configurations when the target antenna port is a PDSCH DMRS.

TABLE 15-5
Valid TCI state configurations when target antenna port is a PDSCH DMRS

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

A typical QCL configuration method according to Tables 15-1 to 15-5 is configuring the target antenna port and the reference antenna port for respective steps as “SSB”->“TRS”->“CSI-RS for CSI, CSI-RS for BM, PDCCH DMRS, or PDSCH DMRS” for operation. Through this, the statistical characteristics being measurable from the SSB and the TRS may be associated with the respective antenna ports, thereby assisting the reception operation of the UE.

### [PDCCH: TCI State Related]

Specifically, combinations of TCI states applicable to the PDCCH DMRS antenna port are shown in Table 16 below. The fourth row in Table 16 is a combination assumed by the UE before RRC configuration, and configuring it after RRC is not allowed.

TABLE 16

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH Block | QCL-TypeD |
| | Block | | | |

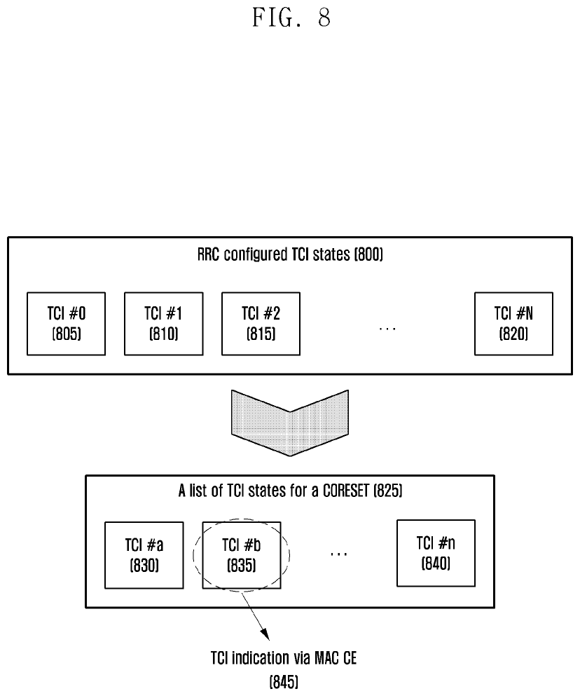

NR supports a hierarchical signaling method illustrated in FIG. 8 for dynamic allocation as to a PDCCH beam. Referring to FIG. 8, the base station may configure N TCI states 805, 810, 815, . . . , 820 for the UE through RRC signaling 800, and some of them may be configured as TCI states for CORESET (825). Thereafter, the base station may indicate one of the TCI states 830, 835 and 840 for CORESET to the UE through MAC CE signaling (845). Then, the UE receives a PDCCH based on beam information included in the TCI state indicated by the MAC CE signaling.

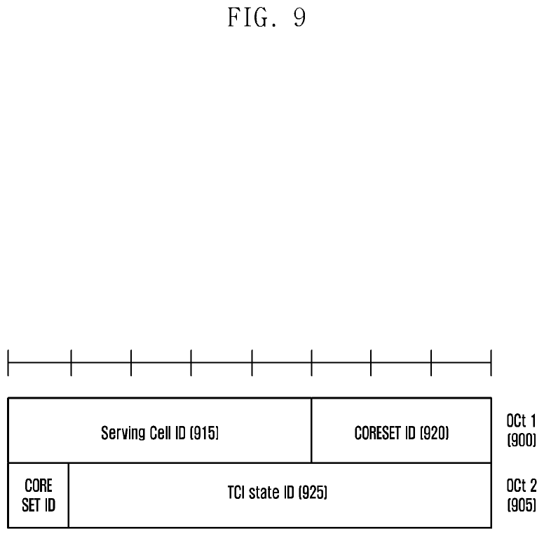

FIG. 9 is a diagram illustrating a structure for TCI indication MAC CE signaling as to PDCCH DMRS. Referring to FIG. 9, TCI indication MAC CE signaling for PDCCH DMRS is composed of 2 bytes (16 bits) and includes a serving cell ID (915) of 5 bits, a CORESET ID (920) of 4 bits, and a TCI state ID (925) of 7 bits.

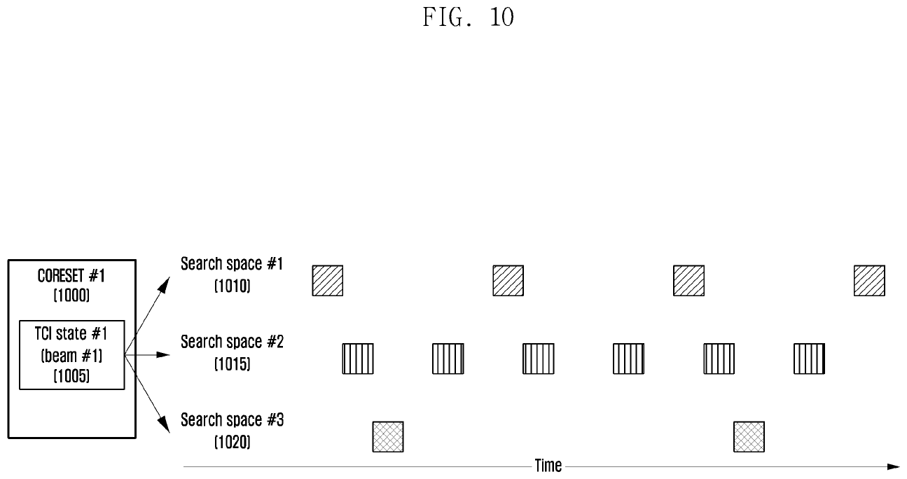

FIG. 10 is a diagram illustrating an example of a control resource set (CORESET) and beam configuration of search spaces according to the above description. Referring to FIG. 10, the base station may indicate one TCI state among the TCI state list included in the configuration of CORESET 1000 through MAC CE signaling (1005). Thereafter, the UE considers that the same QCL information (beam #1, 1005) is applied to one or more search spaces 1010, 1015 and 1020 linked to the CORESET until another TCI state is indicated to the corresponding CORESET through another MAC CE signaling. The above-described PDCCH beam allocation method has a difficulty in indicating a beam change faster than the MAC CE signaling delay and has a disadvantage of collectively applying the same beam per CORESET irrespective of search space characteristics, making flexible PDCCH beam operation difficult. Hereinafter, embodiments of the disclosure provide a more flexible PDCCH beam configuration and operation method. Although several distinct examples will be provided for convenience of describing the embodiments of the disclosure, these are not mutually exclusive and may be applied in appropriate combination depending on the situation.

The base station may configure one or more TCI states to the UE as to a specific control resource set, and may activate one of the configured TCI states through a MAC CE activation command. For example, when {TCI state #0, TCI state #1, TCI state #2} are configured as TCI states for control resource set #1, the base station may transmit an activation command to the UE to assume TCI state #0 as the TCI state for control resource set #1 through MAC CE. According to the activation command for the TCI state received through the MAC CE, the UE may correctly receive a DMRS of the corresponding control resource set based on QCL information in the activated TCI state.

For a control resource set with an index of zero (control resource set #0), if the UE fails to receive a MAC CE activation command for the TCI state of control resource set #0, the UE may assume that the DMRS transmitted in control resource set #0 is QCLed with the SS/PBCH block that is identified in the initial access procedure or in the non-contention-based random access procedure that is not triggered by a PDCCH command.

For a control resource set with an index of a non-zero value (control resource set #X), if the UE is not configured with a TCI state for control resource set #X, or if the UE is configured with one or more TCI states but fails to receive a MAC CE activation command for activating one of them, the UE may assume that the DMRS transmitted in control resource set #X is QCLed with the SS/PBCH block that is identified in the initial access process.

### [PDCCH: QCL Prioritization Rule Related]

Next, QCL prioritization operation for the PDCCH will be described in detail.

In the case where the UE operates on carrier aggregation in a single cell or band and where plural control resource sets present in activated bandwidth parts of a single or multiple cells have the same or different QCL-TypeD characteristics in a specific PDCCH monitoring occasion and overlap in time, the UE may select a specific control resource set according to QCL prioritization operation and monitor control resource sets having the same QCL-TypeD characteristic as the selected control resource set. That is, when multiple control resource sets overlap in time, only one QCL-TypeD characteristic may be received. In this case, the criteria for QCL prioritization may be as follows.
Criterion 1. The control resource set linked to a common search space having the lowest index in a cell corresponding to the lowest index among the cells including common search spaces
Criterion 2. The control resource set linked to a UE-specific search space having the lowest index in a cell corresponding to the lowest index among the cells including UE-specific search spaces

As described above, if each of the above criteria is not met, the next criterion may be applied. For example, when control resource sets overlap in time in a specific PDCCH monitoring period, if all the control resource sets are linked to a UE-specific search space but not to a common search space, that is, if criterion 1 is not met, the UE may omit application of criterion 1 and apply criterion 2.

When selecting control resource sets according to the above-described criteria, the UE may further consider the following two items in relation to QCL information configured in the control resource set. First, if control resource set 1 has CSI-RS 1 as a reference signal having a QCL-TypeD relationship, and a reference signal having a QCL-TypeD relationship with CSI-RS 1 is SSB 1, and if a reference signal with which control resource set 2 has a QCL-TypeD relationship is SSB 1, the UE may consider that two control resource sets 1 and 2 have different QCL-TypeD characteristics. Second, if control resource set 1 has CSI-RS 1 configured in cell 1 as a reference signal having a QCL-TypeD relationship, and a reference signal with which CSI-RS 1 has a QCL-TypeD relationship is SSB 1, and if control resource set 2 has CSI-RS 2 configured in cell 2 as a reference signal having a QCL-TypeD relationship, and a reference signal with which CSI-RS 2 has a QCL-TypeD relationship is SSB 1, the UE may consider that the two control resource sets have the same QCL-TypeD characteristic.

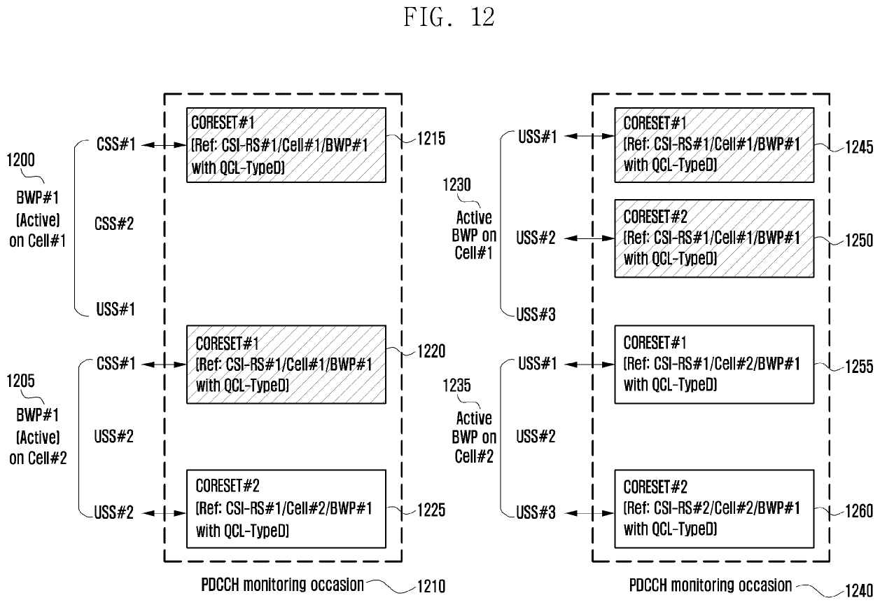

FIG. 12 is a diagram illustrating a method for a UE to select a control resource set that can be received by considering priority when receiving a downlink control channel in a wireless communication system according to an embodiment of the disclosure. For example, the UE may be configured with plural control resource sets overlapping in time in a specific PDCCH monitoring occasion 1210, and these plural control resource sets may be linked to common search spaces or UE-specific search spaces for a plurality of cells. In the corresponding PDCCH monitoring occasion, a first control resource set 1215 linked to a first common search space may be present in a first bandwidth part 1200 of a first cell, and a first control resource set 1220 linked to a first common search space and a second control resource set 1225 linked to a second UE-specific search space may be present in a first bandwidth part 1205 of a second cell. The control resource sets 1215 and 1220 may have a QCL-TypeD relationship with a first CSI-RS resource configured in the first bandwidth part of the first cell, and the control resource set 1225 may have a QCL-TypeD relationship with a first CSI-RS resource configured in the first bandwidth part of the second cell. Hence, if criterion 1 is applied to the corresponding PDCCH monitoring occasion 1210, all other control resource sets having a reference signal of the same QCL-TypeD as the first control resource set 1215 may be received. So, the UE may receive the control resource sets 1215 and 1220 in the corresponding PDCCH monitoring occasion 1210. As another example, the UE may be configured to receive plural control resource sets overlapping in time in a specific PDCCH monitoring occasion 1240, and these plural control resource sets may be linked to common search spaces or UE-specific search spaces for a plurality of cells. In the corresponding PDCCH monitoring occasion, a first control resource set 1245 linked to a first UE-specific search space and a second control resource set 1250 linked to a second UE-specific search space may be present in a first bandwidth part 1230 of a first cell, and a first control resource set 1255 linked to a first UE-specific search space and a second control resource set 1260 linked to a third UE-specific search space may exist in a first bandwidth part 1235 of a second cell. The control resource sets 1245 and 1250 may have a QCL-TypeD relationship with a first CSI-RS resource configured in the first bandwidth part of the first cell, the control resource set 1255 may have a QCL-TypeD relationship with a first CSI-RS resource configured in the first bandwidth part of the second cell, and the control resource set 1260 may have a QCL-TypeD relationship with a second CSI-RS resource configured in the first bandwidth part of the second cell. However, if criterion 1 is applied to the corresponding PDCCH monitoring occasion 1240, as there is no common search space, so criterion 2 being the next criterion may be applied. If criterion 2 is applied to the corresponding PDCCH monitoring occasion 1240, all other control resource sets having a reference signal of the same QCL-TypeD as the control resource set 1245 may be received. Consequently, the UE may receive the control resource sets 1245 and 1250 in the corresponding PDCCH monitoring occasion 1240.

### [Rate Matching/Puncturing Related]

Next, rate matching operation and puncturing operation will be described in detail. In the case where time-frequency resources A to transmit a symbol sequence A overlap other time-frequency resources B, a rate matching or puncturing operation may be considered as a transmission/reception operation of a channel A in consideration of a resource C of the region where the resources A and the resources B overlap. A detailed operation may be as follows.

### Rate Matching Operation

For a symbol sequence A to be transmitted to the UE, the base station may map the channel A only to the remaining resources excluding the resource C corresponding to the overlap with the resources B among all the resources A, and transmit the same. For example, in the case where the symbol sequence A is composed of {symbol #1, symbol #2, symbol #3, symbol #4}, the resources A are {resource #1, resource #2, resource #3, resource #4}, and the resources B are {resource #3, resource #5}, the base station may sequentially map the symbol sequence A to the remaining resources {resource #1, resource #2, resource #4}, excluding {resource #3} corresponding to the resource C among the resources A, and transmit the same. As a result, the base station may map the symbol sequence {symbol #1, symbol #2, symbol #3} respectively to {resource #1, resource #2, resource #4} and transmit the same.

The UE may determine the resources A and the resources B from scheduling information for the symbol sequence A from the base station and determine the resource C being a region where the resources A and the resources B overlap accordingly. The UE may receive the symbol sequence A by assuming that the symbol sequence A is mapped to the remaining regions excluding the resource C among the resources A for transmission. For example, in the case where the symbol sequence A is composed of {symbol #1, symbol #2, symbol #3, symbol #4}, the resources A are {resource #1, resource #2, resource #3, resource #4}, and the resources B are {resource #3, resource #5}, the UE may receive the symbol sequence A by assuming that the symbol sequence A is sequentially mapped to the remaining resources {resource #1, resource #2, resource #4} excluding {resource #3} corresponding to the resource C among the resources A. As a result, the UE may perform a series of subsequent reception operations by assuming that the symbol sequence {symbol #1, symbol #2, symbol #3} is mapped respectively to the resources {resource #1, resource #2, resource #4} for transmission.

### Puncturing Operation

If there is a resource C corresponding to a region overlapping with the resources B among the resources A for transmitting the symbol sequence A to the UE, the base station may map the symbol sequence A to all the resources A and transmit only the remaining resource region excluding the resource C from among the resources A without transmitting the resource region corresponding to the resource C. For example, in the case where the symbol sequence A is composed of {symbol #1, symbol #2, symbol #3, symbol 4}, the resources A are {resource #1, resource #2, resource #3, resource #4}, and the resources B are {resource #3, resource #5}, the base station may map the symbol sequence A {symbol #1, symbol #2, symbol #3, symbol #4} respectively to the resources A {resource #1, resource #2, resource #3, resource #4}, and transmit only the symbol sequence {symbol #1, symbol #2, symbol #4} corresponding to {resource #1, resource #2, resource #4}, which are the remaining resources excluding {resource #3} corresponding to the resource C from among the resources A, without transmitting {symbol #3} mapped to {resource #3} corresponding to the resource C. As a result, the base station may map the symbol sequence {symbol #1, symbol #2, symbol #4} respectively to {resource #1, resource #2, resource #4} for transmission.

The UE may determine the resources A and the resources B from scheduling information about the symbol sequence A from the base station and determine the resource C being a region where the resources A and the resources B overlap accordingly. The UE may receive the symbol sequence A by assuming that the symbol sequence A is mapped to all the resources A but transmitted only in the remaining region excluding the resource C from among the resource region A. For example, in the case where the symbol sequence A is composed of {symbol #1, symbol #2, symbol #3, symbol #4}, the resources A are {resource #1, resource #2, resource #3, resource #4}, and the resources B are {resource #3, resource #5}, the UE may assume that the symbol sequence A {symbol #1, symbol #2, symbol #3, symbol #4} is mapped respectively to the resources A {resource #1, resource #2, resource #3, resource #4}, but {symbol #3} mapped to {resource #3} corresponding to the resource C will be not transmitted, and perform reception by assuming that the symbol sequence {symbol #1, symbol #2, symbol #4} corresponding to the remaining resources {resource #1, resource #2, resource #4} excluding {resource #3} corresponding to the resource C from among the resources A is mapped and transmitted. As a result, the UE may perform a series of subsequent reception operations by assuming that the symbol sequence {symbol #1, symbol #2, symbol #4} is mapped respectively to the resources {resource #1, resource #2, resource #4} for transmission.

Next, a description will be given of a method for configuring rate matching resources for the purpose of rate matching in a 5G communication system. Rate matching indicates that the size of a signal is adjusted in consideration of the number of resources available to transmitting the signal. For example, rate matching of a data channel may indicate that the size of data is adjusted without mapping the data channel to a specific time-frequency resource region for transmission.

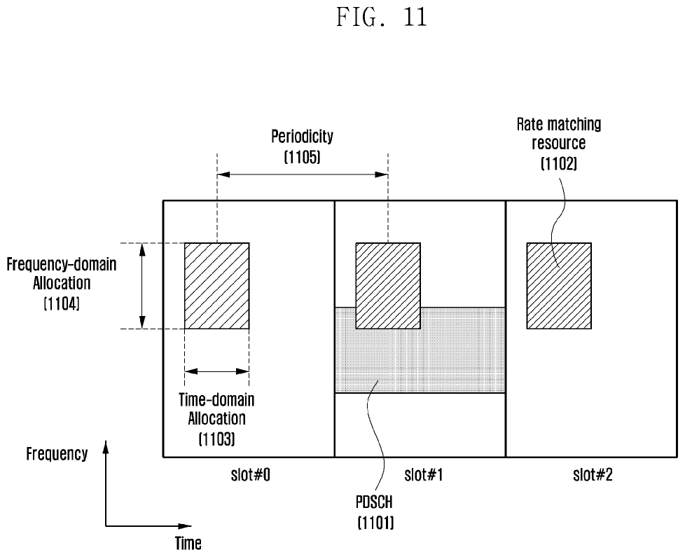

FIG. 11 is a diagram describing a method for a base station and a UE to transmit and receive data in consideration of downlink data channel and rate matching resources.

In FIG. 11, a downlink data channel (PDSCH) 1101 and rate matching resources 1102 are shown. The base station may configure one or more rate matching resources 1102 to the UE through higher layer signaling (e.g., RRC signaling). Configuration information of the rate matching resource 1102 may include time domain resource allocation information 1103, frequency domain resource allocation information 1104, and periodicity information 1105. In the following description, the bitmap corresponding to the frequency domain resource allocation information 1104 will be referred to as “first bitmap”, the bitmap corresponding to the time domain resource allocation information 1103 will be referred to as “second bitmap”, and the bitmap corresponding to the periodicity information 1105 will be referred to as “third bitmap”. If all or some of the time-frequency resources of the scheduled data channel 1101 overlap the configured rate matching resources 602, the base station may rate-match the data channel 1101 in a part of the rate matching resource 1102 and transmit the same, and the UE may perform reception and decoding by assuming that the data channel 1101 is rate-matched in a part of the rate matching resource 1102.

The base station may dynamically notify the UE through DCI of whether to rate-match the data channel in a part of the configured rate matching resource by using additional configuration (this corresponds to a “rate matching indicator” in the DCI format described above). Specifically, the base station may select some of the configured rate matching resources to group them into rate matching resource groups, and notify whether to rate-match the data channel for each rate matching resource group to the UE through DCI in a bitmap manner. For example, in the case where four rate matching resources, RMR #1, RMR #2, RMR #3, and RMR #4, are configured, the base station may configure RMG #1={RMR #1, RMR #2} and RMG #2={RMR #3, RMR #4} as rate matching groups, and may notify whether to rate-match the data channel in each of RMG #1 and RMG #2 to the UE by using a bitmap of 2 bits in the DCI field. For example, the case that requires rate-matching may be indicated by “1”, and the case that does not require rate-matching may be indicated by “0”.

5G supports the granularity of “RB symbol level” and “RE level” as a method of configuring the above-described rate matching resources for the UE. More specifically, the following configuration method may be followed.

### RB Symbol Level

The UE may be configured with up to four RateMatchPatterns for each bandwidth part through higher layer signaling, and one RateMatchPattern may include the following.
As a reserved resource in the bandwidth part, a resource in which a time-frequency resource region of the corresponding reserved resource is configured by a combination of a RB level bitmap and a symbol level bitmap in the frequency domain may be included. The reserved resource may span one or two slots. A time domain pattern (periodicityAndPattern) in which time-frequency regions composed of a pair of RB level and symbol level bitmaps are repeated may be further configured.
A time-frequency domain resource region configured as a control resource set in the bandwidth part, and a resource region corresponding to a time domain pattern set by a search space configuration where the corresponding resource region is repeated may be included.

### RE Level

The UE may be configured with the following information through higher layer signaling.
The number of LTE CRS ports (nrofCRS-Ports) and an LTE-CRS-vshift(s) value (v-shift) as configuration information (lte-CRS-ToMatchAround) for an RE corresponding to an LTE CRS (cell-specific reference signal or common reference signal) pattern, center subcarrier position information (carrierFreqDL) of an LTE carrier from a reference frequency point (e.g., reference point A), information on the bandwidth size of an LTE carrier (carrierBandwidthDL), subframe configuration information (mbsfn-SubframConfigList) corresponding to a multicast-broadcast single-frequency network (MBSFN), and the like may be included. The UE may determine the position of the CRS in the NR slot corresponding to an LTE subframe based on the above-described information.
Configuration information on a resource set corresponding to one or more ZP (zero power) CSI-RSs in a bandwidth part may be included.

### [LTE CRS Rate Match Related]

Next, the rate matching process for the above-described LTE CRS will be described in detail. For the coexistence of LTE (Long Term Evolution) and NR (New RAT) (LTE-NR coexistence), NR provides an NR UE with a function of configuring a CRS (cell-specific reference signal) pattern of LTE. More specifically, this CRS pattern may be provided by RRC signaling including at least one parameter in ServingCellConfig IE (information element) or ServingCellConfigCommon IE. Examples of the parameter may include lte-CRS-ToMatchAround, lte-CRS-PatternList1-r16, lte-CRS-PatternList2-r16, crs-RateMatch-PerCORESETPoolIndex-r16, and the like.

Rel-15 NR provides a function by which one CRS pattern may be configured per serving cell through parameter lte-CRS-ToMatchAround. In Rel-16 NR, this function has been expanded to enable plural CRS patterns to be configured for each serving cell. More specifically, one CRS pattern may be configured per LTE carrier in a single-TRP (transmission and reception point) UE, and two CRS patterns may be configured per LTE carrier in a multi-TRP UE. For example, it is possible to configure up to three CRS patterns per serving cell in a single-TRP UE through parameter lte-CRS-PatternList1-r16. As another example, a CRS may be configured for each TRP in a multi-TRP UE. That is, a CRS pattern for TRP1 may be configured through parameter lte-CRS-PatternList1-r16, and a CRS pattern for TRP2 may be configured through parameter lte-CRS-PatternList2-r16. Meanwhile, when two TRPs are configured as described above, whether to apply both the CRS patterns of TRP1 and TRP2 to a specific PDSCH (physical downlink shared channel) or whether to apply only the CRS pattern of one TRP thereto is determined through parameter crs-RateMatch-PerCORESETPoolIndex-r16; if parameter crs-RateMatch-PerCORESETPoolIndex-r16 is set to “enabled”, the CRS pattern of only one TRP is applied, otherwise, the CRS patterns of both TRPs are applied.

Table 17 illustrates the ServingCellConfig IE including the above CRS pattern, and Table 18 illustrates the RateMatchPatternLTE-CRS IE including at least one parameter for the CRS pattern.

TABLE 17

| | |
|---|---|
| ServingCellConfig ::= | SEQUENCE { |

| | |
|---|---|
| tdd-UL-DL-ConfigurationDedicated | TDD-UL-DL- |

ConfigDedicated
OPTIONAL, -- Cond TDD

| | |
|---|---|
| initialDownlinkBWP | BWP- |

DownlinkDedicated
OPTIONAL, -- Need M

| downlinkBWP-ToReleaseList | | SEQUENCE (SIZE |
|---|---|---|
| (1..maxNrofBWPs)) | OF | BWP-Id |

OPTIONAL, -- Need N

| downlinkBWP-ToAddModList | | SEQUENCE (SIZE |
|---|---|---|
| (1..maxNrofBWPs)) | OF | BWP-Downlink |

OPTIONAL, -- Need N

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED {ms2, |

ms3, ms4, ms5, ms6, ms8, ms10, ms20, ms30,
ms40,ms50, ms60, ms80,ms100, ms200,ms300, ms500,
ms750, ms1280, ms1920, ms2560, spare10, spare9, spare8,

| | |
|---|---|
| spare7, spare6, spare5, spare4, spare3, spare2, spare1 | } |

OPTIONAL, -- Need R

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementary Uplink | UplinkConfig |

OPTIONAL, -- Need M

| | |
|---|---|
| pdcch-ServingCellConfig | SetupRelease { PDCCH- |

| | |
|---|---|
| ServingCellConfig | } |

OPTIONAL, -- Need M

| | |
|---|---|
| pdsch-ServingCellConfig | SetupRelease { PDSCH- |

| | |
|---|---|
| ServingCellConfig | } |

OPTIONAL, -- Need M

| | |
|---|---|
| csi-MeasConfig | SetupRelease { CSI- |

| | |
|---|---|
| MeasConfig | } |

OPTIONAL, -- Need M

| | |
|---|---|
| sCellDeactivationTimer | ENUMERATED {ms20, |

ms40, ms80, ms160, ms200, ms240,
ms320, ms400, ms480, ms520, ms640, ms720,

| | |
|---|---|
| ms840, ms1280, spare2,spare1} | OPTIONAL, -- Cond |

ServingCellWithoutPUCCH
crossCarrierSchedulingConfig
CrossCarrierSchedulingConfig
OPTIONAL, -- Need M

| | |
|---|---|
| tag-Id | TAG-Id, |
| dummy | ENUMERATED |

{enabled}
OPTIONAL, -- Need R

| pathlossReferenceLinking | ENUMERATED | |
|---|---|---|
| {spCell, | sCell | } |

OPTIONAL, -- Cond SCellOnly

| | |
|---|---|
| servingCellMO | MeasObjectId |

```
OPTIONAL, -- Cond MeasObject
  ...,
  [[
```

| | | |
|---|---|---|
| lte-CRS-ToMatchAround | SetupRelease | { |

| | |
|---|---|
| RateMatchPatternLTE-CRS | } |

OPTIONAL, -- Need M

| rateMatchPatternToAddModList | | SEQUENCE (SIZE |
|---|---|---|
| (1..maxNrofRateMatchPatterns)) | OF | RateMatchPattern |

OPTIONAL, -- Need N

| rateMatchPatternToReleaseList | | SEQUENCE (SIZE |
|---|---|---|
| (1..maxNrofRateMatchPatterns)) | OF | RateMatchPatternId |

OPTIONAL, -- Need N

| downlinkChannelBW-PerSCS-List | | SEQUENCE (SIZE |
|---|---|---|
| (1..maxSCSs)) | OF | SCS-SpecificCarrier |

```
OPTIONAL -- Need S
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL- |

DL-ConfigDedicated-IAB-MT-r16
OPTIONAL, -- Cond TDD_IAB

| | | |
|---|---|---|
| dormantBWP-Config-r16 | SetupRelease | { |

| | |
|---|---|
| DormantBWP-Config-r16 | } |

OPTIONAL, -- Need M

| | |
|---|---|
| ca-SlotOffset-r16 | CHOICE { |
| refSCS15kHz | INTEGER (− |

2..2),

| | |
|---|---|
| refSCS30KHz | INTEGER (− |

5..5),

| | |
|---|---|
| refSCS60KHz | INTEGER (− |

10..10),

| | |
|---|---|
| refSCS120KHz | INTEGER (− |

20..20)
}
OPTIONAL, -- Cond AsyncCA

| | | |
|---|---|---|
| channelAccessConfig-r16 | SetupRelease | { |

| | |
|---|---|
| ChannelAccessConfig-r16 | } |

OPTIONAL, -- Need M

| intraCellGuardBandsDL-List-r16 | | SEQUENCE (SIZE |
|---|---|---|
| (1..maxSCSs)) | OF IntraCellGuardBandsPerSCS-r16 | |

OPTIONAL, -- Need S

| intraCellGuardBandsUL-List-r16 | | SEQUENCE (SIZE |
|---|---|---|
| (1..maxSCSs)) | OF IntraCellGuardBandsPerSCS-r16 | |

OPTIONAL, -- Need S

| | |
|---|---|
| csi-RS-ValidationWith-DCI-r16 | ENUMERATED |

{enabled}
OPTIONAL, -- Need R

| | |
|---|---|
| lte-CRS-PatternList1-r16 | SetupRelease { LTE-CRS- |
| PatternList-r16 } | OPTIONAL, |

-- Need M

| | |
|---|---|
| lte-CRS-PatternList2-r16 | SetupRelease { LTE-CRS- |
| PatternList-r16 } | OPTIONAL, |

-- Need M

| | |
|---|---|
| crs-RateMatch-PerCORESETPoolIndex-r16 | ENUMERATED |

{enabled}
OPTIONAL, -- Need R

| | |
|---|---|
| enableTwoDefaultTCI-States-r16 | ENUMERATED |

{enabled}
OPTIONAL, -- Need R
enableDefaultTCI-StatePerCoresetPoolIndex-r16

| | |
|---|---|
| ENUMERATED | {enabled} |

OPTIONAL, -- Need R

| | |
|---|---|
| enableBeamSwitchTiming-r16 | ENUMERATED |

{true}
OPTIONAL, -- Need R

| | |
|---|---|
| cbg-TxDiffTBsProcessingType1-r16 | ENUMERATED |

{enabled}
OPTIONAL, -- Need R

| | |
|---|---|
| cbg-TxDiffTBsProcessingType2-r16 | ENUMERATED |

{enabled}
OPTIONAL -- Need R
]]
}

TABLE 18
RateMatchPatternLTE-CRS

The IE RateMatchPatternLTE-CRS is used to configure a pattern to rate match around LTE CRS.
See TS 38.214 [19], clause 5.1.4.2.
RateMatchPatternLTE-CRS information element
-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, |

n100, spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns- |

r16)) OF RateMatchPatternLTE-CRS
TAG RATEMATCHPATTERNLTE CRS STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2)
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

### [PDSCH: Frequency Resource Allocation Related]

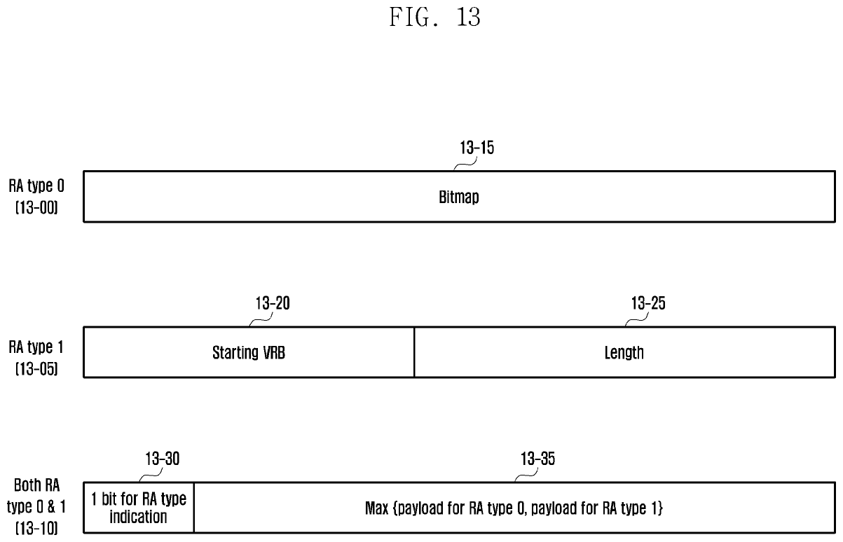

FIG. 13 is a diagram illustrating an example of frequency domain resource assignment of the physical downlink shared channel (PDSCH) in a wireless communication system according to an embodiment of the disclosure.

FIG. 13 is a diagram showing three frequency domain resource assignment methods of type 0 (13-00), type 1 (13-05), and dynamic switch (13-10) that may be configured through a higher layer in an NR wireless communication system. With reference to FIG. 13, if the UE is configured to use only resource type 0 through higher layer signaling (13-00), some of downlink control information (DCI) allocating the PDSCH to the UE includes a bitmap of NRBG bits. The conditions for this will be described later. Here, NRBG indicates the number of RBGs (resource block groups) determined as shown in Table 19 below according to the BWP size allocated by a BWP indicator and higher layer parameter rbg-Size, and data is transmitted on the RBG indicated to be ‘l’ by the bitmap.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 through higher layer signaling (13-05), some DCI for allocating the PDSCH to the UE includes frequency domain, resource assignment information composed of ┌log₂(N_{RB}^{DL,BWP}(N_{RB}^{DL,BWP}+1)/2┐ bits. The conditions for this will be described later. Thereby, the base station may configure a starting VRB 13-20 and a length 13-25 of frequency domain resources allocated successively therefrom.

If the UE is configured to use both resource type 0 and resource type 1 through higher layer signaling (13-10), some DCI allocating the PDSCH to the UE includes frequency domain resource assignment information of Y bits, where Y corresponds to a larger value 13-35 of a payload 13-15 for configuring resource type 0 and a payload 13-20 and 13-25 for configuring resource type 1. The conditions for this will be described later. In this case, one bit may be prepended to the front part (MSB) of the frequency domain resource assignment information in DCI; if the bit has a value of ‘0’, it may indicate that resource type 0 is used, and if the bit has a value of ‘1’, it may indicate that resource type 1 is used.

### [PDSCH/PUSCH: Time Resource Allocation Related]

Next, a time domain resource assignment method for a data channel in a next-generation mobile communication system (5G or NR system) will be described. The base station may configure the UE with a table for time domain resource allocation information about a downlink data channel (physical downlink shared channel, PDSCH) and an uplink data channel (physical uplink shared channel, PUSCH) by using higher layer signaling (e.g., RRC signaling). A table composed of up to maxNrofDL-Allocations=16 entries may be configured for the PDSCH, and a table composed of up to maxNrofUL-Allocations=16 entries may be configured for the PUSCH. In one embodiment, the time domain resource allocation information may include PDCCH-to-PDSCH slot timing (corresponding to the time gap in slots between the time at which the PDCCH is received and the time at which the PDSCH scheduled by the received PDCCH is transmitted, denoted by K0), PDCCH-to-PUSCH slot timing (corresponding to the time gap in slots between the time at which the PDCCH is received and the time at which the PUSCH scheduled by the received PDCCH is transmitted, denoted by K2), information about the start position and length of symbols in the slot at which the PDSCH or PUSCH is scheduled, a mapping type for the PDSCH or PUSCH, and the like. For example, information as shown in Table 20 or Table 21 below may be transmitted from the base station to the UE.

TABLE 20
PDSCH-TimeDomainResourceAllocationList information element

| | |
|---|---|
| PDSCH-TimeDomainResourceAllocationList | ::= SEQUENCE (SIZE(1..maxNrofUL-Allocations)) OF |

PDSCH-TimeDomainResourceAllocation

| | |
|---|---|
| PDSCH-TimeDomainResourceAllocation ::= | SEQUENCE { |

| | |
|---|---|
| k0 | INTEGER (0..32) |

OPTIONAL, -- Need E

| | |
|---|---|
| mappingType | ENUMERATED (typeA, typeB), |
| startSymbolAndLength | INTEGER (0..127) |

)

TABLE 21
PUSCH-TimeDomainResourceAllocation information element

| | | |
|---|---|---|
| PUSCH-TimeDomainResourceAllocationList | ::= SEQUENCE | (SIZE(1..maxNrofUL-Allocations)) OF |

PUSCH-TimeDomainResourceAllocation

| PUSCH-TimeDomainResourceAllocation ::= | SEQUENCE { | |
|---|---|---|
| k2 | INTEGER (0..32) | OPTIONAL, -- Need S |

| | |
|---|---|
| mappingType | ENUMERATED (typeA, typeB), |
| startSymbolAndLength | INTEGER (0..127) |

)

The base station may notify the UE of one of the entries in the table for the time domain resource assignment information described above through L1 signaling (e.g., DCI) (for example, may be indicated by field “time domain resource assignment” in DCI). The UE may obtain time domain resource assignment information for the PDSCH or PUSCH based on the DCI received from the base station.

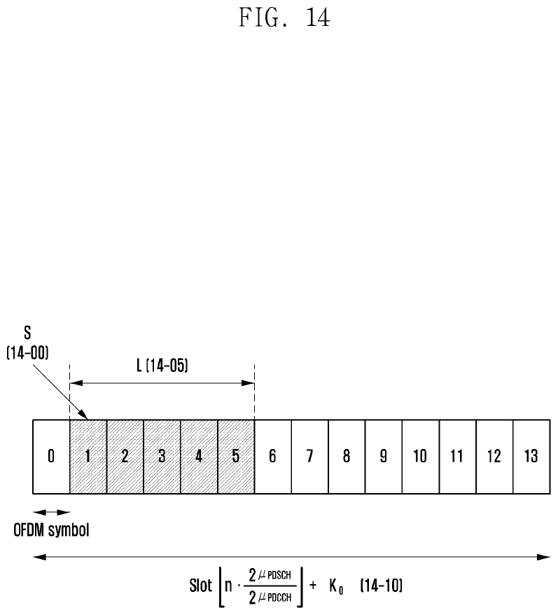

FIG. 14 is a diagram illustrating an example of time domain resource assignment of the PDSCH in a wireless communication system according to an embodiment of the disclosure.

With reference to FIG. 14, the base station may indicate the time domain position of a PDSCH resource according to the subcarrier spacings (SCS) (μ_{PDSCH} and μ_{PDCCH}) of the data channel and control channel configured using a higher layer, a scheduling offset value (K0), a start position 14-00 and length 14-05 of OFDM symbols in a slot dynamically indicated through DCI.

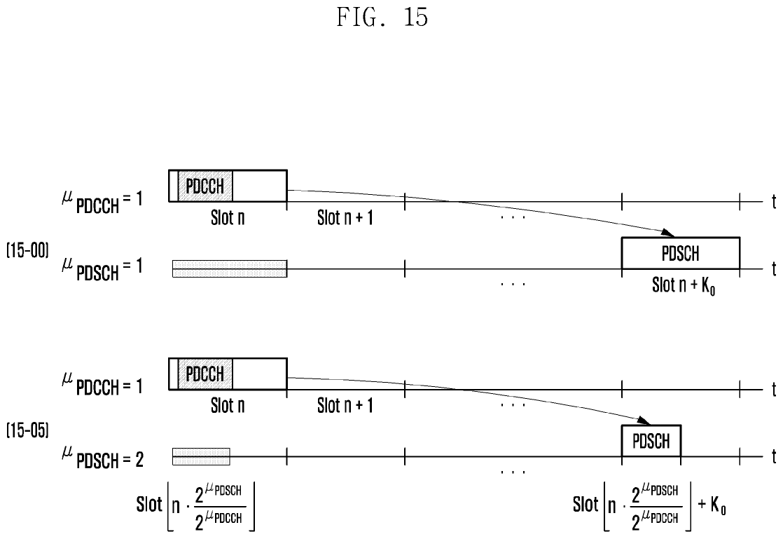

FIG. 15 is a diagram illustrating an example of time domain resource assignment based on the subcarrier spacing of a data channel and a control channel in a wireless communication system according to an embodiment of the disclosure.

With reference to FIG. 15, if the subcarrier spacing of the data channel is the same as that of the control channel (15-00, μ_{PDSCH}=μ_{PDCCH}), the slot numbers for the data and the control are the same, so the base station and the UE may produce a scheduling offset according to a preset slot offset K0. On the other hand, if the subcarrier spacing of the data channel is different from that of the control channel (15-05, μ_{PDSCH}=μ_{PDCCH}), the slot numbers for the data and the control are different from each other, so the base station and the UE may produce a scheduling offset according to a preset slot offset K0 with respect to the subcarrier spacing of the PDCCH.

### [PDSCH: Processing Procedure Time]

Next, the PDSCH processing procedure time will be described. In the case where the base station performs scheduling to transmit a PDSCH to the UE by using DCI format 1_0, 1_1 or 1_2, the UE may require a PDSCH processing procedure time to receive the PDSCH by applying a transmission scheme indicated through DCI (modulation/demodulation and coding indication index (MCS), demodulation reference signal-related information, time-frequency resource allocation information, etc.). In NR, a PDSCH processing procedure time is defined in consideration of this. The PDSCH processing procedure time of the UE may follow Equation 3 below.

$${T}_{p r o c , 1} = ( {N}_{1} + {d}_{1 , 1} + {d}_{2} ) ( 2048 + 144 ) κ {2}^{- μ} {T}_{c} + {T}_{e x t} \qquad [ Equation 3 ]$$

Variables in T_{proc,1} described above as Equation 3 may have the following meanings.
N₁: the number of symbols determined according to UE processing capability 1 or 2 based on the UE capability and numerology μ. It may have the values shown in Table 22 in the case where UE processing capability 1 is reported according to the UE capability report, and may have the values shown in Table 23 in the case where UE processing capability 2 is reported and availability of UE processing capability 2 is indicated through higher layer signaling. Numerology u may correspond to the minimum value among μ_{PDCCH}, μ_{PDSCH} and μ_{UL} so as to maximize T_{proc,1}, where μ_{PDCCH}, μ_{PDSCH} and μ_{UL} may indicate the numerology of the PDCCH having scheduled the PDSCH, the numerology of the scheduled PDSCH, and the numerology of an uplink channel through which HARQ-ACK is to be transmitted, respectively.

TABLE 22
PDSCH processing procedure time
for PDSCH processing capability 1

| | PDSCH decoding time N₁ [symbols] | |
|---|---|---|
| | | dmrs-AdditionalPosition ≠ |
| | | pos0 in higher layer signaling |
| | dmrs-AdditionalPosition = | DMRS-DownlinkConfig in either |
| | pos0 in higher layer signaling | PDSCH mapping type A or B or |
| | DMRS-DownlinkConfig in both | if the higher layer parameter |
| μ | PDSCH mapping type A and B | is not configured |
| 0 | 8 | N_{1, 0} |
| 1 | 10 | 13 |
| 2 | 17 | 20 |
| 3 | 20 | 24 |

TABLE 23
PDSCH processing procedure time
for PDSCH processing capability 2

| | PDSCH decoding time N₁ [symbols] |
|---|---|
| | mrs-AdditionalPosition = pos0 in higher layer signaling DMRS- |
| μ | DownlinkConfig in both PDSCH mapping type A and B |
| 0 | 3 |
| 1 | 4.5 |
| 2 | 9 for frequency range 1 |

κ: 64
Tₑₓₜ: if the UE uses a shared spectrum channel access method, the UE may calculate Text and apply it to the PDSCH processing procedure time. Otherwise, Text is assumed to be 0.
If l₁ indicating the PDSCH DMRS position is 12, N_{1,0} in Table 22 has a value of 14, otherwise it has a value of 13.
For PDSCH mapping type A, if the last symbol of the PDSCH is the i^{th} symbol in the slot in which the PDSCH is transmitted, and i<7, d_{1,1} is 7-i, otherwise d_{1,1} is 0.
d₂: if the PUCCH having a high priority index and the PUCCH or PUSCH having a low priority index overlap in time, d₂ of the PUCCH having a high priority index may be configured as a value reported by the UE. Otherwise, d₂ is 0.
If PDSCH mapping type B is used for UE processing capability 1, the value d_{1,1} may be determined according to L indicating the number of symbols of the scheduled PDSCH and d indicating the number of overlapping symbols between the PDCCH having scheduled the PDSCH and the scheduled PDSCH as follows.
   If L≥7, d_{1,1}=0.
   If L≥4 and L≤6, d_{1,1}=7-L.
   If L=3, d_{1,1}=min (d, 1).
   if L=2, d_{1,1}=3+d.
If PDSCH mapping type B is used for UE processing capability 2, the value d_{1,1} may be determined according to L indicating the number of symbols of the scheduled PDSCH and d indicating the number of overlapping symbols between the PDCCH having scheduled the PDSCH and the scheduled PDSCH as follows.
   If L≥7, d_{1,1}=0.
   If L≥4 and L≤6, d_{1,1}=7-L.
   In the case of L=2,
   If the scheduling PDCCH is present in a CORESET composed of three symbols, and if the corresponding CORESET and the scheduled PDSCH have the same start symbol, d_{1,1}=3.
   Otherwise, d_{1,1}=d
In the case of a UE supporting capability 2 in a given serving cell, the PDSCH processing procedure time according to UE processing capability 2 may be applied when higher layer signaling “processingType2Enabled” of the UE is set to “enable” for the corresponding cell.

If the position of a first uplink transmission symbol of a PUCCH including HARQ-ACK information (this position may involve consideration of K1 being defined as a transmission time of HARQ-ACK, a PUCCH resource used for HARQ-ACK transmission, and a timing advance effect) does not start before the first uplink transmission symbol that occurs after time T_{proc,1} from the last symbol of the PDSCH, the UE should transmit a valid HARQ-ACK message. That is, the UE should transmit a PUCCH including HARQ-ACK only when the PDSCH processing procedure time is sufficient. Otherwise, the UE is unable to provide the base station with valid HARQ-ACK information corresponding to the scheduled PDSCH. T_{proc,1} may be used for both normal CP and extended CP. In the case of a PDSCH composed of two PDSCH transmission occasions in a slot, d_{1,1} is calculated with respect to the first PDSCH transmission occasion in the corresponding slot.

### [PDSCH: Reception Preparation Time in Cross-Carrier Scheduling]

Next, in the case of cross-carrier scheduling where numerology μ_{PDCCH} with which a scheduling PDCCH is transmitted is different from numerology μ_{PDSCH} with which a PDSCH scheduled by the corresponding PDCCH is transmitted, a description will be given of N_{pdsch} being the UE's PDSCH reception preparation time defined for the time gap between the PDCCH and the PDSCH.

If μ_{PDCCH}<μ_{PDSCH}, the scheduled PDSCH cannot be transmitted earlier than the first symbol of a slot occurring after N_{pdsch} symbols from the last symbol of the PDCCH having scheduled the PDSCH. A transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH having scheduled the PDSCH. A transmission symbol of the corresponding PDSCH may include a DM-RS.

TABLE 24
N_{pdsch} according to subcarrier spacing of scheduled PDCCH

| μ_{PDCCH} | N_{pdsch} [symbols] |
|---|---|
| 0 | 4 |
| 1 | 5 |
| 2 | 10 |
| 3 | 14 |

### [PDSCH: TCI State Activation MAC CE]

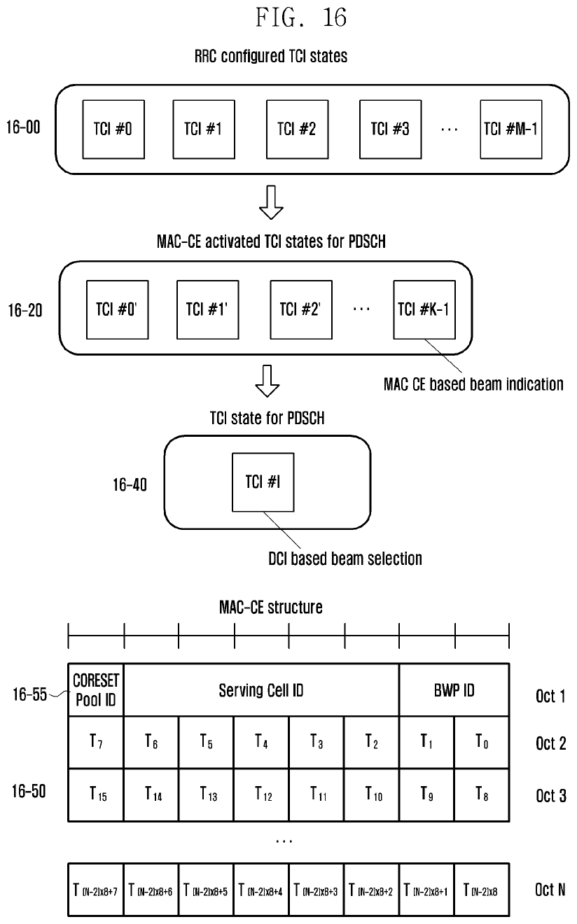

Next, a beam configuration method for the PDSCH will be described. FIG. 16 illustrates a process for beam configuration and activation for the PDSCH. A list of TCI states for the PDSCH may be indicated through a higher layer list such as RRC or the like (16-00). The list of TCI states may be indicated by, for example, tci-StatesToAddModList and/or tci-StatesToReleaseList in the PDSCH-Config IE for each BWP. Thereafter, some of the TCI states in the list may be activated through a MAC CE (16-20). The maximum number of activated TCI states may be determined according to the capability reported by the UE. Indicia 16-50 shows an example of a MAC CE format for PDSCH TCI state activation/deactivation. The meaning of each field in the MAC CE and the values that may be set for each field are as follows.

Serving Cell ID: This field indicates the identity of the Serving Cell for which
the MAC CE applies. The length of the field is 5 bits. If the indicated Serving
Cell is configured as part of a simultaneousTCI-UpdateList1 or
simultaneousTCI-UpdateList2 as specified in TS 38.331 [5], this MAC CE
applies to all the Serving Cells configured in the set simultaneousTCI-
UpdateList1 or simultaneousTCI-UpdateList2, respectively;
BWP ID: This field indicates a DL BWP for which the MAC CE applies as the
codepoint of the DCI bandwidth part indicator field as specified in TS 38.212
[9]. The length of the BWP ID field is 2 bits. This field is ignored if this MAC
CE applies to a set of Serving Cells;
Tᵢ: If there is a TCI state with TCI-StateId i as specified in TS 38.331 [5], this
field indicates the activation/deactivation status of the TCI state with TCI-
StateId i, otherwise MAC entity shall ignore the Ti field. The Ti field is set to 1
to indicate that the TCI state with TCI-StateId i shall be activated and mapped
to the codepoint of the DCI Transmission Configuration Indication field, as
specified in TS 38.214 [7]. The Ti field is set to 0 to indicate that the TCI state
with TCI-StateId i shall be deactivated and is not mapped to the codepoint of the
DCI Transmission Configuration Indication field. The codepoint to which the
TCI State is mapped is determined by its ordinal position among all the TCI
States with Ti field set to 1, i.e. the first TCI State with Tᵢ field set to 1 shall be
mapped to the codepoint value 0, second TCI State with Ti field set to 1 shall be
mapped to the codepoint value 1 and so on. The maximum number of activated
TCI states is 8;
CORESET Pool ID: This field indicates that mapping between the activated
TCI states and the codepoint of the DCI Transmission Configuration Indication
set by field Ti is specific to the ControlResourceSetId configured with
CORESET Pool ID as specified in TS 38.331 [5]. This field set to 1 indicates
that this MAC CE shall be applied for the DL transmission scheduled by
CORESET with the CORESET pool ID equal to 1, otherwise, this MAC CE
shall be applied for the DL transmission scheduled by CORESET pool ID equal
to 0. If the coresetPoolIndex is not configured for any CORESET, MAC entity
shall ignore the CORESET Pool ID field in this MAC CE when receiving the
MAC CE. If the Serving Cell in the MAC CE is configured in a cell list that
contains more than one Serving Cell, the CORESET Pool ID field shall be
ignored when receiving the MAC CE.

### [SRS Related]

Next, an uplink channel estimation method using sounding reference signal (SRS) transmission of the UE will be described. The base station may configure at least one SRS configuration for each uplink BWP to transmit configuration information for SRS transmission to the UE, and also configure at least one SRS resource set for each SRS configuration. For example, the base station and the UE may exchange higher layer signaling information below to transmit information about the SRS resource set.
srs-ResourceSetId: SRS resource set index
srs-ResourceIdList: a set of SRS resource indexes referenced in the SRS resource set
resourceType: it is a time domain transmission configuration of the SRS resource referenced in the SRS resource set, and may be set to one of “periodic”, “semi-persistent”, and “aperiodic”. If being set to “periodic” or “semi-persistent”, associated CSI-RS information may be provided depending on the usage of the SRS resource set. If being set to “aperiodic”, an aperiodic SRS resource trigger list and slot offset information may be provided, and associated CSI-RS information may be provided depending on the usage of the SRS resource set.
usage: it is a setting for the usage of the SRS resource referenced in the SRS resource set, and may be set to one of “beamManagement”, “codebook”, “nonCodebook”, and “antennaSwitching”.
alpha, p0, pathlossReferenceRS, srs-PowerControlAdjustmentStates: these provide parameter settings for adjusting the transmission power of the SRS resource referenced in the SRS resource set.

The UE may understand that the SRS resources included in a set of SRS resource indexes referenced in the SRS resource set follow the information configured in the SRS resource set.

In addition, the base station and the UE may transmit and receive higher layer signaling information to transfer individual configuration information for the SRS resources. For example, the individual configuration information for the SRS resources may include time-frequency domain mapping information in the slot for the SRS resource, which may include information about intra-slot or inter-slot frequency hopping of the SRS resource. In addition, the individual configuration information for the SRS resource may include a time domain transmission configuration of the SRS resource, and may be set to one of “periodic”, “semi-persistent”, and “aperiodic”. This may be constrained to have the same time domain transmission configuration as the SRS resource set including the SRS resource. If the time domain transmission configuration of the SRS resource is set to “periodic” or “semi-persistent”, an SRS resource transmission periodicity and a slot offset (e.g., periodicity AndOffset) may be additionally included in the time domain transmission configuration.

The base station may activate, deactivate, or trigger SRS transmission to the UE through higher layer signaling including RRC signaling or MAC CE signaling, or L1 signaling (e.g., DCI). For example, the base station may activate or deactivate periodic SRS transmission to the UE through higher layer signaling. The base station may instruct to activate an SRS resource set whose resourceType is set to “periodic” through higher layer signaling, and the UE may transmit an SRS resource referenced in the activated SRS resource set. The time-frequency domain resource mapping of the transmitted SRS resource in the slot follows the resource mapping information configured in the SRS resource, and the slot mapping including a transmission periodicity and slot offset follow periodicity AndOffset configured in the SRS resource. In addition, a spatial domain transmission filter applied to the SRS resource to be transmitted may refer to spatial relation info configured in the SRS resource, or may refer to associated CSI-RS information configured in the SRS resource set including the SRS resource. The UE may transmit the SRS resource in the uplink BWP activated for the periodic SRS resource activated through higher layer signaling.

For example, the base station may activate or deactivate semi-persistent SRS transmission to the UE through higher layer signaling. The base station may instruct to activate the SRS resource set through MAC CE signaling, and the UE may transmit the SRS resource referenced in the activated SRS resource set. The SRS resource set activated through MAC CE signaling may be restricted to the SRS resource whose resourceType is set to “semi-persistent”. The time-frequency domain resource mapping of the SRS resource to be transmitted in the slot follows the resource mapping information configured in the SRS resource, and the slot mapping including a transmission periodicity and slot offset follows periodicity AndOffset configured in the SRS resource. In addition, a spatial domain transmission filter applied to the SRS resource to be transmitted may refer to spatial relation info configured in the SRS resource, or may refer to associated CSI-RS information configured in the SRS resource set including the SRS resource. Instead of following this, if spatial relation info is configured in the SRS resource, the spatial domain transmission filter may be determined with reference to configuration information on spatial relation info transmitted through MAC CE signaling that activates semi-persistent SRS transmission. The UE may transmit the SRS resource in the uplink BWP activated for the semi-persistent SRS resource activated through higher layer signaling.

For example, the base station may trigger aperiodic SRS transmission to the UE through DCI. The base station may indicate one of aperiodic SRS resource triggers (aperiodicSRS-ResourceTrigger) through an SRS request field of the DCI. The UE may understand this as triggering of the SRS resource set including the aperiodic SRS resource trigger indicated through DCI in the aperiodic SRS resource trigger list among the configuration information of the SRS resource set. The UE may transmit the SRS resource referenced in the triggered SRS resource set. The time-frequency domain resource mapping of the SRS resource being transmitted in the slot follows the resource mapping information configured in the SRS resource. In addition, the slot mapping of the SRS resource being transmitted may be determined through a slot offset between the PDCCH including DCI and the SRS resource, which may refer to the value(s) included in the slot offset set configured in the SRS resource set. Specifically, as the slot offset between the PDCCH including DCI and the SRS resource, a value indicated by the time domain resource assignment field of the DCI, among the offset value(s) included in the slot offset set configured in the SRS resource set, may be applied. In addition, a spatial domain transmission filter applied to the SRS resource being transmitted may refer to spatial relation info configured in the SRS resource, or may refer to associated CSI-RS information configured in the SRS resource set including the SRS resource. The UE may transmit the SRS resource in the uplink BWP activated for the aperiodic SRS resource triggered through DCI.

When the base station triggers aperiodic SRS transmission to the UE through DCI, in order for the UE to transmit the SRS by applying configuration information about the SRS resource, a minimum time interval between the PDCCH including the DCI triggering the aperiodic SRS transmission and the SRS to be transmitted may be required. The time interval for SRS transmission of the UE may be defined as the number of symbols between the last symbol of the PDCCH including the DCI triggering aperiodic SRS transmission and the first symbol to which the SRS resource transmitted first among the SRS resource(s) to be transmitted is mapped. This minimum time interval may be determined with reference to the PUSCH preparation procedure time required for the UE to prepare for PUSCH transmission. Additionally, the minimum time interval may have different values depending on the usage of the SRS resource set including the SRS resource being transmitted. For example, the minimum time interval may be determined as N2 symbols defined in consideration of the UE processing capability according to the UE capability with reference to the PUSCH preparation procedure time of the UE. Further, in consideration of the usage of the SRS resource set including the SRS resource being transmitted, if the usage of the SRS resource set is set to “codebook” or “antennaSwitching”, the minimum time interval may be determined as N2 symbols, and if the usage of the SRS resource set is set to “nonCodebook” or “beamManagement”, the minimum time interval may be determined as (N2+14) symbols. If the time interval for aperiodic SRS transmission is greater than or equal to the minimum time interval, the UE may perform aperiodic SRS transmission, and if the time interval for aperiodic SRS transmission is less than the minimum time interval, the UE may ignore the DCI triggering the aperiodic SRS.

TABLE 25

| SRS-Resource ::= | SEQUENCE { |
|---|---|
| srs-ResourceId | SRS-ResourceId, |
| nrofSRS-Ports | ENUMERATED |
| {port1, ports2, ports4}, | |
| ptrs-PortIndex | ENUMERATED |
| {n0, n1 } | OPTIONAL, |
| -- Need R | |
| transmissionComb | CHOICE { |
| n2 | |
| SEQUENCE { | |
| combOffset-n2 | |
| INTEGER (0..1), | |
| cyclicShift-n2 | |
| INTEGER (0..7) | |
| }, | |
| n4 | |
| SEQUENCE { | |
| combOffset-n4 | |
| INTEGER (0..3), | |
| cyclicShift-n4 | |
| INTEGER (0..11) | |
| } | |
| }, | |
| resourceMapping | SEQUENCE { |
| startPosition | INTEGER |
| (0..5), | |
| nrofSymbols | |
| ENUMERATED {n1, n2, n4}, | |
| repetitionFactor | |
| ENUMERATED {n1, n2, n4} | |
| }, | |
| freqDomainPosition | INTEGER (0..67), |
| freqDomainShift | INTEGER |
| (0..268), | |
| freqHopping | SEQUENCE { |
| c-SRS | INTEGER |
| (0..63), | |
| b-SRS | INTEGER |
| (0..3), | |
| b-hop | INTEGER |
| (0..3) | |
| }, | |
| groupOrSequenceHopping | ENUMERATED |
| { neither, groupHopping, sequenceHopping }, | |
| resourceType | CHOICE { |
| aperiodic | SEQUENCE |
| }, | |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE |
| { | |
| periodicityAndOffset-p | SRS- |
| PeriodicityAndOffset, | |
| ... | |
| } | |
| }, | |
| sequenceId | INTEGER |
| (0..1023), | |
| spatialRelationInfo | SRS- |

SpatialRelationInfo
OPTIONAL, -- Need R
...
}

Configuration information “spatialRelationInfo” in Table 25 is intended to apply beam information of the reference signal to the beam used in transmission of the corresponding SRS with reference to one reference signal. For example, the configuration of “spatialRelationInfo” may include information as shown in Table 26 below.

TABLE 26

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS- |
| ResourceId, | |
| srs | SEQUENCE { |
| resourceId | SRS- |
| ResourceId, | |
| uplinkBWP | BWP-Id |

```
    }
  }
}
```

Referring to the above spatialRelationInfo configuration, an SS/PBCH block index, a CSI-RS index, or an SRS index may be configured as an index of a reference signal to be referenced in order to use beam information of a specific reference signal. Higher layer signaling “referenceSignal” is configuration information indicating beam information of a reference signal to be referred to for the corresponding SRS transmission, where ssb-Index indicates the index of the SS/PBCH block, csi-RS-Index indicates the index of the CSI-RS, and srs indicates the index of the SRS. If the value of higher layer signaling referenceSignal is set to “ssb-Index”, the UE may apply the receive beam used to receive the SS/PBCH block corresponding to the ssb-Index as a transmit beam of the corresponding SRS transmission. If the value of higher layer signaling referenceSignal is set to “csi-RS-Index”, the UE may apply the receive beam used to receive the CSI-RS corresponding to the csi-RS-Index as a transmit beam of the corresponding SRS transmission. If the value of higher layer signaling referenceSignal is set to “srs”, the UE may apply the transmit beam used to transmit the SRS corresponding to the srs as a transmit beam of the corresponding SRS transmission.

### [PUSCH: Transmission Scheme Related]

Next, a scheduling method for PUSCH transmission will be described. PUSCH transmission may be dynamically scheduled by a UL grant in the DCI, or may be operated by configured grant Type 1 or Type 2. Dynamic scheduling indication for PUSCH transmission may be performed through DCI format 0_0 or 0_1.

PUSCH transmission of configured grant Type 1 may be semi-statically configured by reception of configuredGrantConfig including rrc-ConfiguredUplinkGrant shown in Table 27 through higher layer signaling, without receiving a UL grant in DCI. PUSCH transmission of configured grant Type 2 may be semi-persistently scheduled by a UL grant in DCI after reception of configuredGrantConfig not including rrc-ConfiguredUplinkGrant shown in Table 27 through higher layer signaling. In the case where PUSCH transmission is operated by a configured grant, parameters applied to PUSCH transmission are applied through higher layer signaling configuredGrantConfig shown in Table 27, except for dataScramblingIdentityPUSCH, txConfig, codebookSubset, maxRank, and scaling of UCI-OnPUSCH, which are provided through higher layer signaling pusch-Config shown in Table 28. If the UE is provided with transformPrecoder in configuredGrantConfig being higher layer signaling shown in Table 27, the UE applies tp-pi2BPSK in pusch-Config of Table 28 to PUSCH transmission operated by a configured grant.

TABLE 27

| | |
|---|---|
| ConfiguredGrantConfig ::= | SEQUENCE { |
| frequencyHopping | ENUMERATED |
| {intraSlot, | interSlot} |

OPTIONAL, -- Need S,

| | |
|---|---|
| cg-DMRS-Configuration | DMRS-UplinkConfig, |
| mcs-Table | ENUMERATED |
| {qam256, | qam64LowSE} |

OPTIONAL, -- Need S

| | |
|---|---|
| mcs-TableTransformPrecoder | ENUMERATED |
| {qam256, | qam64LowSE} |

OPTIONAL, -- Need S

| | |
|---|---|
| uci-OnPUSCH | SetupRelease { CG- |
| UCI-OnPUSCH | } |

OPTIONAL, -- Need M

| | |
|---|---|
| resourceAllocation | ENUMERATED |
| { resourceAllocationType0, | resourceAllocationType1, |

dynamicSwitch },

| | |
|---|---|
| rbg-Size | ENUMERATED |

{config2}
OPTIONAL, -- Need S

| | |
|---|---|
| powerControlLoopToUse | ENUMERATED {n0, |

n1},

| | |
|---|---|
| p0-PUSCH-Alpha | P0-PUSCH- |

AlphaSetId,

| | |
|---|---|
| transformPrecoder | ENUMERATED |
| {enabled, | disabled} |

OPTIONAL, -- Need S

| | |
|---|---|
| nrofHARQ-Processes | INTEGER(1..16), |
| repK | ENUMERATED {n1, |

n2, n4, n8},

| | |
|---|---|
| repK-RV | ENUMERATED |
| {s1-0231, s2-0303, | s3-0000} |

OPTIONAL, -- Need R

| | |
|---|---|
| periodicity | ENUMERATED { |
| | sym2, |

sym7, sym1x14, sym2x14, sym4x14, sym5x14, sym8x14, sym10x14,
sym16x14, sym20x14,

sym32x14,

sym40x14, sym64x14, sym80x14, sym128x14, sym160x14,
sym256x14, sym320x14, sym512x14,
sym640x14, sym1024x14, sym1280x14, sym2560x14, sym5120x14,

sym6,

sym1x12, sym2x12, sym4x12, sym5x12, sym8x12, sym10x12,
sym16x12, sym20x12, sym32×12,

sym40x12,

sym64x12, sym80x12, sym128x12, sym160x12, sym256x12,
sym320x12, sym512x12, sym640x12,
sym1280x12, sym2560x12
},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER |

(0..5119),

| | |
|---|---|
| timeDomainAllocation | INTEGER |

(0..15),

| | |
|---|---|
| frequencyDomainAllocation | BIT STRING |

(SIZE(18)),

| | |
|---|---|
| antennaPort | INTEGER |

(0..31),

| | |
|---|---|
| dmrs-SeqInitialization | INTEGER (0..1) |

OPTIONAL, -- Need R

| | |
|---|---|
| precodingAndNumberOfLayers | INTEGER |

(0..63),

| | |
|---|---|
| srs-ResourceIndicator | INTEGER |

(0..15)
OPTIONAL, -- Need R
mcsAndTBS
INTEGER (0..31),

| | |
|---|---|
| frequencyHoppingOffset | INTEGER (1.. |

maxNrofPhysicalResourceBlocks-1)
OPTIONAL, -- Need R

| | |
|---|---|
| pathlossReferenceIndex | INTEGER |

```
(0..maxNrofPUSCH-PathlossReferenceRSs-1),
    ...
  }
OPTIONAL, -- Need R
  ...
}
```

Next, a PUSCH transmission method will be described. The DMRS antenna port for PUSCH transmission is the same as the antenna port for SRS transmission. PUSCH transmission may be performed using a codebook-based transmission method or a non-codebook-based transmission method depending on whether the value of txConfig in higher layer signaling pusch-Config of Table 28 is “codebook” or “nonCodebook”.

As described above, PUSCH transmission may be dynamically scheduled through DCI format 0_0 or 0_1, and may be semi-statically configured by a configured grant. If the UE is notified of scheduling of PUSCH transmission by DCI format 0_0, the UE performs beam configuration for PUSCH transmission by using pucch-spatialRelationInfoID associated with a UE-specific PUCCH resource corresponding to the minimum ID in the uplink BWP activated in the serving cell, and PUSCH transmission is based on a single antenna port in this case. The UE does not expect scheduling for PUSCH transmission through DCI format 0_0 in the BWP where a PUCCH resource including pucch-spatialRelationInfo is not configured. If the UE is not configured with txConfig in pusch-Config shown in Table 28, the UE does not expect scheduling through DCI format 0_1.

TABLE 28

| | |
|---|---|
| PUSCH-Config ::= | SEQUENCE { |
| dataScramblingIdentityPUSCH | INTEGER |

(0..1023)
OPTIONAL, -- Need S

| | |
|---|---|
| txConfig | ENUMERATED |
| {codebook, | nonCodebook} |

OPTIONAL, -- Need S

| dmrs-UplinkForPUSCH-MappingTypeA | | SetupRelease |
|---|---|---|
| { | DMRS-UplinkConfig | } |

OPTIONAL, -- Need M

| dmrs-UplinkForPUSCH-MappingTypeB | | SetupRelease |
|---|---|---|
| { | DMRS-UplinkConfig | } |

OPTIONAL, -- Need M

| | |
|---|---|
| pusch-PowerControl | PUSCH- |

PowerControl
OPTIONAL, -- Need M

| | |
|---|---|
| frequencyHopping | ENUMERATED |
| {intraSlot, | interSlot} |

OPTIONAL, -- Need S

| | |
|---|---|
| frequencyHoppingOffsetLists | SEQUENCE (SIZE |

(1..4)) OF INTEGER (1..maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| pusch-TimeDomainAllocationList | | SetupRelease |
|---|---|---|
| { | PUSCH-TimeDomainResourceAllocationList | } |

OPTIONAL, -- Need M

| | |
|---|---|
| pusch-AggregationFactor | ENUMERATED |
| { n2, n4, n8 | } |

OPTIONAL, -- Need S

| | |
|---|---|
| mcs-Table | ENUMERATED |
| {qam256, | qam64LowSE} |

OPTIONAL, -- Need S

| | |
|---|---|
| mcs-TableTransformPrecoder | ENUMERATED |
| {qam256, | qam64LowSE} |

OPTIONAL, -- Need S

| | |
|---|---|
| transformPrecoder | ENUMERATED |
| {enabled, | disabled} |

OPTIONAL, -- Need S

| | |
|---|---|
| codebookSubset | ENUMERATED |

{fullyAndPartialAndNonCoherent,
partialAndNonCoherent,nonCoherent}
OPTIONAL, -- Cond codebookBased

| | |
|---|---|
| maxRank | INTEGER |

(1..4)
OPTIONAL, -- Cond codebookBased

| | |
|---|---|
| rbg-Size | ENUMERATED |
| { config2} | OPTIONAL, - |

- Need S

| | |
|---|---|
| uci-OnPUSCH | SetupRelease |
| { UCI-OnPUSCH} | OPTIONAL, |

-- Need M

| | |
|---|---|
| tp-pi2BPSK | ENUMERATED |
| {enabled} | OPTIONAL, |

-- Need S
...
}

Next, codebook-based PUSCH transmission will be described. Codebook-based PUSCH transmission may be dynamically scheduled through DCI format 0_0 or 0_1, and may be operated semi-statically by a configured grant. If a codebook-based PUSCH is dynamically scheduled by DCI format 0_1 or is semi-statically configured by a configured grant, the UE determines a precoder for PUSCH transmission based on an SRS resource indicator (SRI), a transmission precoding matrix indicator (TPMI), and a transmission rank (the number of PUSCH transmission layers).

Here, the SRI may be given through a SRS resource indicator field in DCI or may be configured through higher layer signaling srs-ResourceIndicator. The UE may be configured with at least one SRS resource during codebook-based PUSCH transmission, and may be configured with up to two SRS resources. When the UE is provided with the SRI through DCI, the SRS resource indicated by the SRI indicates an SRS resource corresponding to the SRI among the SRS resources transmitted prior to the PDCCH including the SRI. Additionally, the TPMI and the transmission rank may be given through a field of precoding information and number of layers in DCI, or may be configured through higher layer signaling precodingAndNumberOfLayers. The TPMI is used to indicate a precoder applied to PUSCH transmission. When the UE is configured with one SRS resource, the TPMI is used to indicate the precoder to be applied in the configured SRS resource. When the UE is configured with a plurality of SRS resources, the TPMI is used to indicate a precoder to be applied in the SRS resource indicated by the SRI.

The precoder to be used for PUSCH transmission is selected from an uplink codebook having the same number of antenna ports as the value of nrofSRS-Ports in higher layer signaling SRS-Config. In codebook-based PUSCH transmission, the UE determines a codebook subset based on the TPMI and codebookSubset in higher layer signaling pusch-Config. CodebookSubset in higher layer signaling pusch-Config may be set to one of “fully AndPartialAndNonCoherent”, “partialAndNonCoherent”, and “noncoherent” on the basis of the UE capability reported by the UE to the base station. If the UE has reported “partialAndNonCoherent” as UE capability, the UE does not expect that the value of higher layer signaling codebookSubset is set to “fully AndPartialAndNonCoherent”. In addition, if the UE has reported “noncoherent” as UE capability, the UE does not expect that the value of higher layer signaling codebookSubset is set to “fully AndPartialAndNonCoherent” or “partialAndNonCoherent”. If nrofSRS-Ports in higher layer signaling SRS-ResourceSet indicates two SRS antenna ports, the UE does not expect that the value of higher layer signaling codebookSubset is set to “partialAndNonCoherent”. The UE may be configured with one SRS resource set in which the value of usage in higher layer signaling SRS-ResourceSet is set to “codebook”, and one SRS resource in the corresponding SRS resource set may be indicated by the SRI. If several SRS resources are configured in the SRS resource in which the value of usage in higher layer signaling SRS-ResourceSet is set to “codebook”, the UE expects that nrofSRS-Ports in higher layer signaling SRS-Resource is set to the same value for all the SRS resources.

The UE transmits, to the base station, one or multiple SRS resources included in the SRS resource set in which the value of usage is set to “codebook” according to higher layer signaling, and the base station selects one of the SRS resources transmitted by the UE and instructs the UE to perform PUSCH transmission by using transmit beam information of the selected SRS resource. Here, in codebook-based PUSCH transmission, the SRI is used as information for selecting the index of one SRS resource and is included in DCI. Additionally, the base station includes information indicating the TPMI and rank to be used by the UE for PUSCH transmission in the DCI. The UE may use the SRS resource indicated by the SRI to perform PUSCH transmission by applying the rank indicated based on the transmit beam of the SRS resource and the precoder indicated by the TPMI.

Next, non-codebook-based PUSCH transmission will be described. Non-codebook-based PUSCH transmission may be dynamically scheduled through DCI format 0_0 or 0_1 and may be semi-statically operated by a configured grant. If at least one SRS resource is configured in the SRS resource set in which the value of usage in higher layer signaling SRS-ResourceSet is set to “nonCodebook”, the UE may be scheduled with non-codebook-based PUSCH transmission through DCI format 0_1.

For the SRS resource set in which the value of usage in higher layer signaling SRS-ResourceSet is set to “nonCodebook”, the UE may be configured with one associated NZP CSI-RS resource (non-zero power CSI-RS). The UE may perform a calculation on the precoder for SRS transmission by measuring the NZP CSI-RS resource associated with the SRS resource set. If the difference between the last received symbol of the aperiodic NZP CSI-RS resource associated with the SRS resource set and the first symbol of aperiodic SRS transmission in the UE is less than 42 symbols, the UE does not expect that the information on the precoder for SRS transmission will be updated.

If the value of resourceType in higher layer signaling SRS-ResourceSet is set to “aperiodic”, the associated NZP CSI-RS is indicated by a SRS request being a field in DCI format 0_1 or 1_1. In this case, if the associated NZP CSI-RS resource is an aperiodic NZP CSI-RS resource, this indicates that there is an associated NZP CSI-RS for the case where the value of the SRS request field in DCI format 0_1 or 1_1 is not ‘00’. Here, the corresponding DCI should not indicate cross carrier or cross BWP scheduling. Additionally, if the value of the SRS request indicates the presence of an NZP CSI-RS, the corresponding NZP CSI-RS is positioned in the slot in which the PDCCH including the SRS request field is transmitted. Here, the TCI state configured in the scheduled subcarrier is not configured as QCL-TypeD. If a periodic or semi-persistent SRS resource set is configured, an associated NZP CSI-RS may be indicated by associatedCSI-RS in higher layer signaling SRS-ResourceSet. For non-codebook-based transmission, the UE does not expect that both spatialRelationInfo being higher layer signaling for the SRS resource and associatedCSI-RS in higher layer signaling SRS-ResourceSet are configured together.

If the UE is configured with plural SRS resources, it may determine the precoder and transmission rank to be applied to PUSCH transmission based on the SRI indicated by the base station. Here, the SRI may be indicated through a SRS resource indicator field in DCI or may be configured through higher layer signaling srs-ResourceIndicator. Like codebook-based PUSCH transmission described above, if the UE is provided with the SRI through DCI, the SRS resource indicated by the SRI indicates the SRS resource corresponding to the SRI among the SRS resources transmitted prior to the PDCCH including the SRI. The UE may use one or multiple SRS resources for SRS transmission, and the maximum number of SRS resources and the maximum number of SRS resources that can be simultaneously transmitted at the same symbol in one SRS resource set are determined by the UE capability reported by the UE to the base station. Here, the SRS resources simultaneously transmitted by the UE occupy the same RB. The UE configures one SRS port for each SRS resource. Only one SRS resource set in which the value of usage in higher layer signaling SRS-ResourceSet is set to “nonCodebook” may be configured, and up to four SRS resources may be configured for non-codebook-based PUSCH transmission.

The base station transmits one NZP-CSI-RS associated with the SRS resource set to the UE, and the UE calculates a precoder to be used for transmission of one or multiple SRS resources in the corresponding SRS resource set based on measurement results obtained upon receiving the NZP-CSI-RS. The UE applies the calculated precoder when transmitting one or multiple SRS resources in the SRS resource set in which the usage is set to “nonCodebook” to the base station, and the base station selects one or more of the received one or multiple SRS resources. Here, in non-codebook-based PUSCH transmission, the SRI indicates an index capable of representing one SRS resource or a combination of plural SRS resources, and this SRI is included in the DCI. In this case, the number of SRS resources indicated by the SRI transmitted by the base station may be the number of transmission layers of the PUSCH, and the UE performs PUSCH transmission by applying the precoder applied to SRS resource transmission to each layer.

### [PUSCH: Preparation Procedure Time]

Next, the PUSCH preparation procedure time will be described. In the case where the base station schedules the UE to transmit a PUSCH by using DCI format 0_0, 0_1 or 0_2, the UE may require a PUSCH preparation procedure time for transmitting a PUSCH by applying the transmission method indicated by the DCI (transmission precoding scheme for SRS resources, number of transmission layers, and spatial domain transmission filter). In NR, a PUSCH preparation procedure time is defined in consideration of this. The PUSCH preparation procedure time of the UE may follow Equation 4 below.

$${T}_{p r o c , 2} = max ( ( {N}_{2} + {d}_{2 , 1} + {d}_{2} ) ( 2048 + 144 ) κ {2}^{- μ} {T}_{c} + {T}_{e x t} + {T}_{s w i t c h} , {d}_{2 , 2} ) \qquad [ Equation 4 ]$$

Variables in T_{proc,2} described above as Equation 4 may have the following meanings.
N₂: the number of symbols determined based on UE processing capability 1 or 2 according to the UE capability and numerology μ. It may have the values shown in Table 29 in the case where UE processing capability 1 is reported according to the UE capability report, and may have the values shown in Table 30 in the case where UE processing capability 2 is reported and the availability of UE processing capability 2 is set through higher layer signaling.

TABLE 29

| | PUSCH preparation time N₂ |
|---|---|
| μ | [symbols] |
| 0 | 10 |
| 1 | 12 |
| 2 | 23 |
| 3 | 36 |

TABLE 30

| | PUSCH preparation time N₂ |
|---|---|
| μ | [symbols] |
| 0 | 5 |
| 1 | 5.5 |
| 2 | 11 for frequency range 1 |

d_{2,1}: the number of symbols determined to be ‘0’ if all resource elements of the first OFDM symbol of PUSCH transmission are composed of only DM-RSs, otherwise determined to be ‘1’.
κ: 64
μ: it follows one of μ_{DL} and μ_{UL} that makes T_{proc,2} larger. μ_{DL} indicates the numerology of a downlink in which the PDCCH including the DCI scheduling the PUSCH is transmitted, and μ_{UL} indicates the numerology of an uplink in which the PUSCH is transmitted.
T_{c}: it has 1/(Δfₘₐₓ·N_{f}) where Δfₘₐₓ=480·10³ Hz and N_{f}=4096.
d_{2,2}: it follows a BWP switching time if the DCI scheduling the PUSCH indicates BWP switching, otherwise it is ‘0’.
d₂: if OFDM symbols of the PUCCH, the PUSCH having a high priority index, and the PUCCH having a low priority index overlap in time, the value d₂ of the PUSCH having a high priority index is used. Otherwise, d₂ is ‘0’.
Tₑₓₜ: if the UE uses a shared spectrum channel access scheme, the UE may calculate Tₑₓₜ and apply it to the PUSCH preparation procedure time. Otherwise, Tₑₓₜ is assumed to be ‘0’.
T_{switch}: if an uplink switching interval is triggered, T_{switch} is assumed to be a switching interval time. Otherwise, it is assumed to be ‘0’.

Considering time domain resource mapping information of the PUSCH scheduled through the DCI and the influence of a timing advance between uplink and downlink, if the first symbol of the PUSCH starts earlier than the first uplink symbol at which CP starts after T_{proc,2} from the last symbol of the PDCCH including the DCI having scheduled the PUSCH, the base station and the UE determine that the PUSCH preparation procedure time is not sufficient. Otherwise, the base station and the UE determine that the PUSCH preparation procedure time is sufficient. The UE may transmit the PUSCH only if the PUSCH preparation procedure time is sufficient, and may ignore the DCI having scheduled the PUSCH if the PUSCH preparation procedure time is not sufficient.

### [PUSCH: Repetitive Transmission Related]

Next, repetitive transmission of an uplink data channel in a 5G system will be described in detail. As repetitive transmission methods of an uplink data channel, the 5G system supports two types, i.e., PUSCH repetition type A and PUSCH repetition type B. The UE may be configured with one of PUSCH repetition type A and PUSCH repetition type B through higher layer signaling.

### PUSCH Repetition Type A

As described above, the symbol length and the position of a start symbol of an uplink data channel may be determined in one slot by a time domain resource allocation method, and the base station may notify the UE of the number of repetitions through higher layer signaling (e.g., RRC signaling) or L1 signaling (e.g. DCI).
The UE may repetitively transmit an uplink data channel having the same length and start symbol as the configured uplink data channel in contiguous slots on the basis of the number of repetitions received from the base station. Here, if at least one symbol among the symbols of a slot configured as downlink for the UE by the base station or the uplink data channel configured for the UE is configured as downlink, the UE omits uplink data channel transmission but counts the number of repetitions for the uplink data channel.

### PUSCH Repetition Type B

As described above, the symbol length and the position of a start symbol of an uplink data channel may be determined in one slot by a time domain resource assignment method, and the base station may notify the UE of the number of repetitions numberofrepetitions through higher layer signaling (e.g., RRC signaling) or L1 signaling (e.g. DCI).
First, based on the start symbol and length of the configured uplink data channel, the nominal repetition of the uplink data channel is determined as follows. The slot where the n^{th} nominal repetition starts is given by

$${K}_{s} + ⌊ \frac{S + n \cdot L}{{N}_{symb}^{slot}} ⌋$$

and the symbol starting in that slot is given by mod(S+n·L,N_{symb}^{slot}). The slot where the n^{th} nominal repetition ends is given by

$${K}_{S} + ⌊ \frac{S + ( n + 1 ) \cdot L - 1}{{N}_{symb}^{slot}} ⌋$$

and the symbol ending in that slot is given by mod(S+(n+1)·L−1,N_{symb}^{slot}). Here, n=0, . . . , numberofrepetitions−1, S indicates the start symbol of the configured uplink data channel, and L indicates the symbol length of the configured uplink data channel. Kₛ indicates the slot where PUSCH transmission starts, and N_{symb}^{slot} indicates the number of symbols per slot.
The UE determines invalid symbols for PUSCH repetition type B. The symbol configured as downlink by tdd-UL-DL-ConfigurationCommon or tdd-UL-DL-ConfigurationDedicated is determined as an invalid symbol for PUSCH repetition type B. Additionally, invalid symbols may be configured by a higher layer parameter (e.g., InvalidSymbolPattern). A higher layer parameter (e.g. InvalidSymbolPattern) may provide a symbol-level bitmap spanning one or two slots so as to configure invalid symbols. In the bitmap, ‘1’ indicates an invalid symbol. Additionally, the periodicity and pattern of the bitmap may be configured via a higher layer parameter (e.g., periodicity AndPattern). When the higher layer parameter (e.g. InvalidSymbolPattern) is configured, if parameter InvalidSymbolPatternIndicator-ForDCIFormat0_1 or InvalidSymbolPatternIndicator-ForDCIFormat0_2 indicates ‘1’, the UE applies the invalid symbol pattern, and if the parameter indicates ‘0’, the UE does not apply the invalid symbol pattern. When the higher layer parameter (e.g. InvalidSymbolPattern) is configured, if parameter InvalidSymbolPatternIndicator-ForDCIFormat0_1 or InvalidSymbolPatternIndicator-ForDCIFormat0_2 is not configured, the UE applies the invalid symbol pattern.

After the invalid symbol is determined, for each nominal repetition, the UE may consider symbols other than the invalid symbol as valid symbols. If one or more valid symbols are included in each nominal repetition, the nominal repetition may include one or more actual repetitions. Each of the actual repetitions includes a set of consecutive valid symbols in one slot that may be used for PUSCH repetition type B.

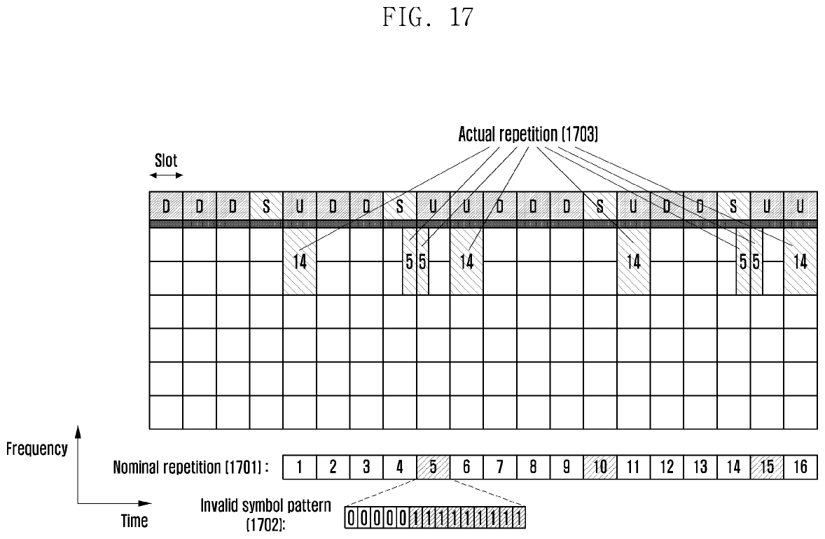

FIG. 17 is a diagram illustrating an example of PUSCH transmission with repetition type B in a wireless communication system according to an embodiment of the disclosure. For the UE, a start symbol S of an uplink data channel may be configured as ‘0’, the length L of the uplink data channel may be configured as ‘14’, and the number of repetitions may be configured as ‘16’. In this case, a nominal repetition is shown in 16 consecutive slots (1701). Thereafter, in each nominal repetition 1701, the UE may determine the symbol configured as a downlink symbol to be an invalid symbol. Additionally, the UE determines the symbols set to ‘l’ in an invalid symbol pattern 1702 to be invalid symbols. In each nominal repetition, if the valid symbols other than the invalid symbols are composed of one or more consecutive symbols in one slot, they are configured as an actual repetition and transmitted (1703).

In addition, for repetitive PUSCH transmission, in NR Release 16, the following methods may be further defined for UL grant-based PUSCH transmission and configured grant-based PUSCH transmission across a slot boundary.
Method 1 (mini-slot level repetition): Two or more repetitive PUSCH transmissions are scheduled within one slot or across the boundaries of consecutive slots via one UL grant. In addition, for method 1, the time domain resource assignment information in DCI indicates the resource of the first repetitive transmission. In addition, time domain resource information of the remaining repetitive transmissions may be determined according to the time domain resource information of the first repetitive transmission and the uplink or downlink direction set for each symbol in each slot. Each repetitive transmission occupies consecutive symbols.
Method 2 (multi-segment transmission): two or more repetitive PUSCH transmissions are scheduled in consecutive slots via one UL grant. In this case, one transmission is designated for each slot, and the individual transmissions may have different start points or different repetition lengths. Additionally, in method 2, the time domain resource allocation information in the DCI indicates the start point and repetition length of all repetitive transmissions. Additionally, in the case of performing repetitive transmission in a single slot by using method 2, if there are multiple bundles of consecutive uplink symbols in the corresponding slot, repetitive transmission is performed for each bundle of uplink symbols. If there is a single bundle of consecutive uplink symbols in the corresponding slot, repetitive PUSCH transmission is performed once according to the method of NR Release 15.
Method 3: two or more repetitive PUSCH transmissions are scheduled in consecutive slots via two or more UL grants. In this case, one transmission is designated for each slot, and the n^{th} UL grant may be received before PUSCH transmission scheduled by the (n−1)^{th} UL grant is finished.
Method 4: one or multiple repetitive PUSCH transmissions in a single slot, or two or more repetitive PUSCH transmissions across the boundaries of consecutive slots may be supported through one UL grant or one configured grant. The number of repetitions indicated by the base station to the UE is simply a nominal value, and the number of repetitive PUSCH transmissions actually performed by the UE may be greater than the nominal number of repetitions. The time domain resource assignment information in the DCI or in the configured grant indicates the resource of the first repetitive transmission indicated by the base station. The time domain resource information of the remaining repetitive transmissions may be determined with reference to at least the resource information of the first repetitive transmission and the uplink or downlink directions of the symbols. If the time domain resource information of the repetitive transmission indicated by the base station crosses the slot boundary or includes an uplink/downlink switch point, this repetitive transmission may be divided into a plurality of repetitive transmissions. Here, one repetitive transmission may be included in one slot for each uplink period.

### [PUSCH: Frequency Hopping Process]

Next, frequency hopping of an uplink data channel (physical uplink shared channel, PUSCH) in a 5G system will be described in detail.

5G supports two frequency hopping methods of an uplink data channel for each PUSCH repetition type. Intra-slot frequency hopping and inter-slot frequency hopping are supported for PUSCH repetition type A, and inter-repetition frequency hopping and inter-slot frequency hopping are supported for PUSCH repetition type B.

The intra-slot frequency hopping method supported for PUSCH repetition type A is a method in which the UE changes the allocated resource in the frequency domain by a configured frequency offset in two hops within one slot and transmits the same. The start RB of each hop in intra-slot frequency hopping may be given by Equation 5.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 5 ]$$

In Equation 5, i=0 and i=1 represent the first hop and the second hop, respectively, and RBₛₜₐᵣₜ represents a start RB in the UL BWP and is calculated by a frequency resource allocation method. RB_{offset} indicates a frequency offset between two hops through a higher layer parameter. The number of symbols of the first hop may be given by └N_{symb}^{PUSCH,s}/2┘, and the number of symbols of the second hop may be given by N_{symb}^{PUSCH,s}−└N_{symb}^{PUSCH,s}/2┘. N_{symb}^{PUSCH,s} is the length of PUSCH transmission in one slot and is expressed as the number of OFDM symbols.

Next, the inter-slot frequency hopping method supported for PUSCH repetition type A and B is a method in which the UE changes the allocated resource in the frequency domain by a configured frequency offset in each slot and transmits the same. In inter-slot frequency hopping, the start RB during nₛ^{μ} slots may be given by Equation 6.

$$R {B}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 6 ]$$

In Equation 6, nₛ^{μ} indicates the current slot number in multi-slot PUSCH transmission, and RBₛₜₐᵣₜ indicates a start RB in the UL BWP and is calculated by a frequency resource allocation method. RB_{offset} indicates a frequency offset between two hops through a higher layer parameter.

Next, the inter-repetition frequency hopping method supported for PUSCH repetition type B is to shift the allocated resource in the frequency domain for one or more actual repetitions of each nominal repetition by a configured frequency offset and transmit the same. RBₛₜₐᵣₜ(n), which is the index of a start RB in the frequency domain for one or multiple actual repetitions in the n^{th} nominal repetition, may follow Equation 7 below.

$$P {B}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix}$$

In Equation 7, n indicates the index of the nominal repetition, and RB_{offset} indicates an RB offset between two hops through a higher layer parameter.

### [UE Capability Report Related]

In LTE and NR, the UE may perform a procedure of reporting capabilities supported by the UE to the serving base station while being connected thereto. This will be referred to as “UE capability report” in the following description.

The base station may transmit a UE capability enquiry message for requesting capability reporting to the UE in a connected state. This message may include a UE capability request for each RAT (radio access technology) type of the base station. The request for each RAT type may include information on a supported frequency band combination. In addition, for UE capability enquiry, a single RRC message container transmitted by the base station may be used to request reporting of multiple UE capabilities for multiple RAT types, or the base station may include multiple UE capability enquiries each including a UE capability request for one specific RAT type in a message and transmit the same to the UE. That is, multiple instances of a UE capability enquiry may be included in a single message, and the UE may compose multiple UE capability information messages correspondingly and perform reporting multiple times. In the next-generation mobile communication system, the UE capability request may be made for NR, LTE, and MR-DC (multi-RAT dual connectivity) such as EN-DC (E-UTRA-NR dual connectivity). In addition, the UE capability enquiry message is normally transmitted in the initial stage after the UE is connected to the base station, but the base station may make a UE capability request under any conditions if necessary. In the above stage, upon receiving a UE capability report request from the base station, the UE composes UE capabilities according to the RAT type and band information requested by the base station. A method for the UE to compose the UE capability in an NR system may be summarized as follows.

1. If the UE receives a list of LTE and/or NR bands as a UE capability request from the base station, the UE composes a band combination (BC) for EN-DC and NR standalone (SA). That is, the UE composes a list of BC candidates for EN-DC and NR SA based on the bands requested in FreqBandList from the base station. In addition, the bands are prioritized in the order listed in FreqBandList.

2. If the base station has requested a UE capability report by setting the “eutra-nr-only” flag or “eutra” flag, the UE completely removes NR SA BCs from the composed list of BC candidates. This operation may be performed only when an LTE base station (eNB) makes a request for the “eutra” capability.

3. Then, the UE removes fallback BCs from the list of BC candidates composed at the above step. Here, a fallback BC indicates a BC that may be obtained by removing a band corresponding to at least one SCell from a certain BC, and may be omitted because the BC before removing a band corresponding to at least one SCell may cover the fallback BC. This step is also applied to MR-DC, i.e., LTE bands. The remaining BCs after this step constitute a final “candidate BC list”.

4. The UE selects BCs to be reported by selecting BCs matching the requested RAT type from the final “candidate BC list” above. In this step, the UE composes supportedBandCombinationList in a preset order. That is, the UE composes the BCs and UE capabilities to be reported according to a preset order of the RAT types (nr->eutra-nr->eutra). In addition, the UE composes featureSetCombination for composed supportedBandCombinationList and composes a list of “candidate feature set combinations” from the candidate BC list from which the list of fallback BCs (including a capability at the equal or lower level) is removed. The “candidate feature set combinations” include all feature set combinations for NR and EUTRA-NR BCs, and may be obtained from the feature set combinations of UE-NR-Capabilities and UE-MRDC-Capabilities containers.

5. In addition, if the requested RAT type is eutra-nr and has influences, featureSetCombinations is included in both UE-MRDC-Capabilities and UE-NR-Capabilities containers. However, the feature set of NR is included only in UE-NR-Capabilities.

After the UE capability is composed, the UE transmits a UE capability information message including the UE capability to the base station. Thereafter, the base station performs scheduling and transmission/reception management appropriately for the UE based on the UE capability received from the UE.

### [CA/DC Related]

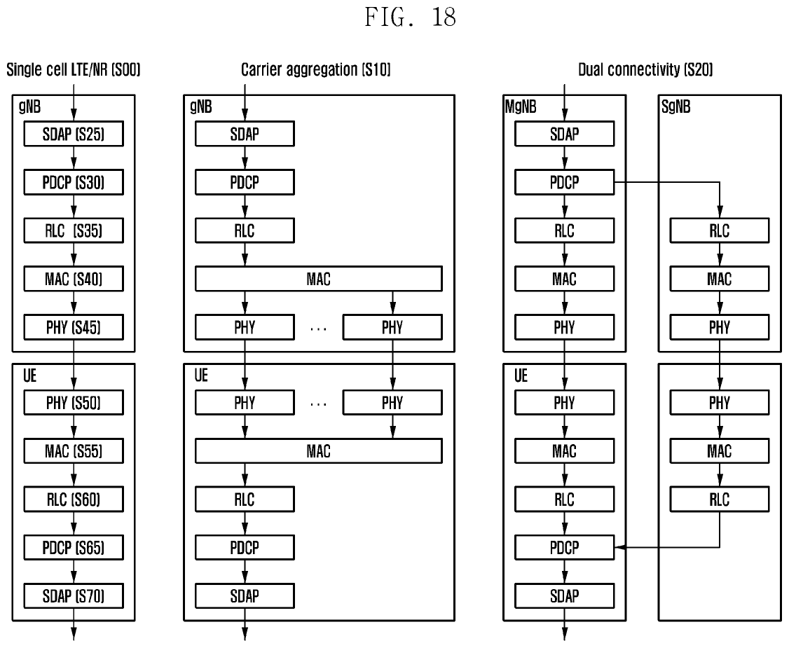

FIG. 18 is a diagram illustrating the structure of radio protocols in a base station and a UE under situations of a single cell, carrier aggregation, and dual connectivity according to an embodiment of the disclosure.

With reference to FIG. 18, in the UE and NR base station of a next-generation mobile communication system, the radio protocol is composed of NR SDAP (service data adaption protocol) S25 or S70, NR PDCP (packet data convergence protocol) S30 or S65, NR RLC (radio link control) S35 or S60, and NR MAC (medium access control) S40 or S55.

The main functions of NR SDAP S25 or S70 may include some of the following functions.
Transfer of user plane data
Mapping between a QoS flow and a DRB for both DL and UL
Marking QoS flow ID in both DL and UL packets
Mapping reflective QoS flow to DRB for UL SDAP PDUs

With respect to the SDAP entity, the UE may be configured with, through an RRC message, whether to use a header of the SDAP entity or whether to use a function of the SDAP entity for each PDCP entity, bearer, or logical channel. Also, if a SDAP header is configured, the SDAP entity may use a NAS reflective QoS 1-bit indication and AS reflective QoS 1-bit indication of the SDAP header to instruct the UE to update or reconfigure the mapping information between QoS flows and data bearers for the uplink and downlink. The SDAP header may include QoS flow ID information indicating the QoS. The QoS information may be used as data processing priority and scheduling information for supporting smooth services.

The main functions of NR PDCP S30 or S65 may include some of the following functions.
Header compression and decompression (ROHC only)
Transfer of user plane data
In-sequence delivery of upper layer PDUs
Out-of-sequence delivery of upper layer PDUs
PDCP PDU reordering for reception
Duplicate detection of lower layer SDUs)
Retransmission of PDCP SDUs
Ciphering and deciphering
Timer-based SDU discard in uplink

In the above description, the reordering function of the NR PDCP entity means reordering of PDCP PDUs received from a lower layer in order based on the PDCP sequence number (SN), and may include delivering data to an upper layer in reordered sequence. Alternatively, the reordering function of the NR PDCP entity may include directly delivering data without considering the order, recording lost PDCP PDUs through reordering, reporting the status of lost PDCP PDUs to the transmitting side, or requesting retransmission of the lost PDCP PDUs.

The main functions of NR RLC S35 or S60 may include some of the following functions.
Transfer of upper layer PDUs
In-sequence delivery of upper layer PDUs
Out-of-sequence delivery of upper layer PDUs
Error correction through ARQ
Concatenation, segmentation, and reassembly of RLC SDUs
Re-segmentation of RLC data PDUs
Reordering of RLC data PDUs
Duplicate detection
Protocol error detection
RLC SDU discard
RLC re-establishment

In the above description, in-sequence delivery of the NR RLC entity means in-sequence delivery of RLC SDUs received from a lower layer to an upper layer. In-sequence delivery of the NR RLC entity may include reassembly and delivery of RLC SDUs when several RLC SDUs belonging to one original RLC SDU are received after segmentation, reordering of received RLC PDUs based on the RLC sequence number (SN) or the PDCP SN, recording lost RLC PDUs through reordering, reporting the status of the lost RLC PDUs to the transmitting side, and requesting retransmission of the lost RLC PDUs. If there is a lost RLC SDU, in-sequence delivery of the NR RLC entity may include in-sequence delivery of only RLC SDUs before the lost RLC SDU to an upper layer. Or, although there is a lost RLC SDU, if a specified timer has expired, in-sequence delivery of the NR RLC entity may include in-sequence delivery of all the RLC SDUs received before the starting of the timer to an upper layer. Alternatively, although there is a lost RLC SDU, if a specified timer has expired, in-sequence delivery of the NR RLC entity may include in-sequence delivery of all the RLC SDUs received up to now to an upper layer. In addition, the NR RLC entity may process RLC PDUs in the order of reception (in the order of their arrival regardless of the order of the sequence number), and transfer them to the PDCP entity in an out-of-sequence delivery manner, and in the case of a segment, the NR RLC entity may concatenate segments stored in the buffer or received later into one whole RLC PDU, process it, and transfer it to the PDCP entity. The NR RLC layer may not include a concatenation function, and this function may be performed by the NR MAC layer or may be replaced with a multiplexing function of the NR MAC layer.

Out-of-sequence delivery of the NR RLC entity described above means a function of transferring RLC SDUs received from a lower layer directly to a higher layer regardless of their order; if several RLC SDUs belonging to one original RLC SDU are received after segmentation, out-of-sequence delivery may include reassembly and delivery of the RLC SDUs; and out-of-sequence delivery may include storing the RLC SNs or PDCP SNs of received RLC PDUs and ordering them to record lost RLC PDUs.

NR MAC S40 or S55 may be connected to several NR RLC entities configured in one UE, and the main function of NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The NR PHY layer S45 or S50 may compose OFDM symbols from higher layer data through channel coding and modulation and transmit them through a radio channel, or may demodulate and channel-decode OFDM symbols received through a radio channel and forward the result to a higher layer.

The detailed structure of the radio protocols may be changed in various ways depending on a carrier (or cell) operation scheme. For example, in the case where the base station transmits data to the UE based on a single carrier (or cell), the base station and the UE use a protocol structure with a single entity for each layer as shown by S00. Meanwhile, in the case where the base station transmits data to the UE based on carrier aggregation (CA) using multiple carriers with a single TRP, the base station and the UE use a protocol structure in which a single entity is provided until the RLC layer and the PHY layer entities are multiplexed through the MAC layer as shown by S10. As another example, in the case where the base station transmits data to the UE based on dual connectivity (DC) using multiple carriers with multiple TRPs, the base station and the UE use a protocol structure in which a single entity is provided until the RLC layer and the PHY layer entities are multiplexed through the MAC layer as shown by S20.

Referring to the above descriptions of PDCCH and beam configuration, repetitive PDCCH transmission is not currently supported in Rel-15 and Rel-16 NR, so it is difficult to attain the required reliability in scenarios requiring high reliability such as URLLC. The disclosure provides a repetitive PDCCH transmission method through multiple transmission and reception points (TRPs) to improve PDCCH reception reliability of the UE. A detailed method thereof will be described in the following embodiments.

Hereinafter, embodiments of the disclosure will be described in detail with reference to the accompanying drawings. The content of the disclosure is applicable to FDD and TDD systems. Higher signaling (or higher layer signaling) in the disclosure indicates a signal transmission method in which signals are transmitted from a base station to a UE using a downlink data channel of the physical layer or from a UE to a base station using an uplink data channel of the physical layer, and may be referred to as RRC signaling, PDCP signaling, or medium access control (MAC) control element (MAC CE).

Hereinafter in this disclosure, the UE may use various methods to determine whether to apply cooperative communication, such as a case where the PDCCH(s) for allocating a PDSCH to which cooperative communication is applied has a specific format, a case where the PDCCH(s) for allocating a PDSCH to which cooperative communication is applied includes a specific indicator indicating whether to apply cooperative communication, a case where the PDCCH(s) for allocating a PDSCH to which cooperative communication is applied is scrambled with a specific RNTI, or a case where cooperative communication is assumed to be applied in a specific period indicated by a higher layer. Hereinafter, the case where the UE receives a PDSCH to which cooperative communication is applied based on conditions similar to the above will be referred to as NC-JT case for convenience of description.

In the following description of the disclosure, determining the priority between A and B may be referred to in various ways, such as selecting one with a higher priority and performing the corresponding operation according to a preset priority rule, or omitting or dropping the operation corresponding to one with a lower priority.

Although the examples will be described through a plurality of embodiments in the disclosure, these are not independent and one or more embodiments may be applied simultaneously or in combination.

### [NC-JT Related]

According to an embodiment of the disclosure, non-coherent joint transmission (NC-JT) may be used for the UE to receive a PDSCH from multiple TRPs.

Unlike existing communication systems, a 5G wireless communication system may support not only a service requiring a high transmission rate but also a service having a very short transmission delay or a service requiring a high connection density. In a wireless communication network including a plurality of cells, transmission and reception points (TRPs), or beams, coordinated transmission between cells, TRPs, and/or beams may satisfy various service requirements by increasing the strength of a signal received by a UE or efficiently controlling interference between cells, TRPs, and/or beams.

Joint transmission (JT), as a representative transmission technology for the above-mentioned cooperative communication, is a technology that may increase the strength or throughput of a signal received by a specific UE by transmitting signals to one UE through a number of different cells, TRPs, and/or beams. Here, the characteristics of the channels between cells, TRPs, or beams and the UE may be significantly different; in particular, non-coherent joint transmission (NC-JT) supporting non-coherent precoding between cells, TRPs, and/or beams may require separate precoding, MCS, resource allocation, TCI indication, or the like depending on the channel characteristics for individual links between cells, TRPs, and/or beams.

NC-JT transmission described above may be applied to at least one of a downlink data channel (physical downlink shared channel, PDSCH), a downlink control channel (physical downlink control channel, PDCCH), an uplink data channel (physical uplink shared channel, PUSCH), or an uplink control channel (physical uplink control channel, PUCCH). For PDSCH transmission, transmission information such as precoding, MCS, resource allocation, TCI, or the like is indicated by DL DCI, and this transmission information should be independently indicated for each cell, TRP, and/or beam for NC-JT transmission. This is a major factor that increases the payload required for DL DCI transmission, which may adversely affect reception performance of a PDCCH transmitting DCI. Hence, it is necessary to carefully design the tradeoff between the amount of DCI information and the control information reception performance to support PDSCH JT.

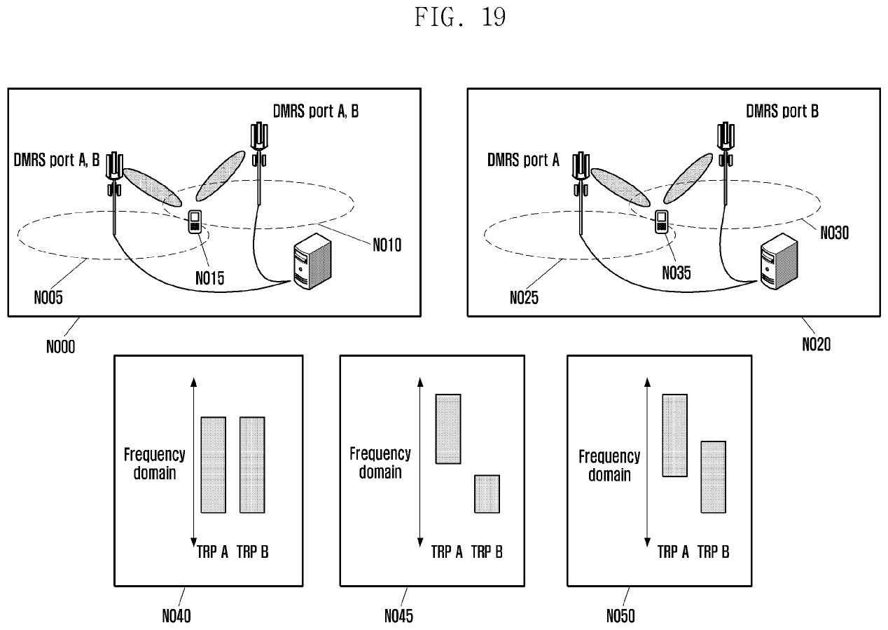

FIG. 19 is a diagram illustrating an example of antenna port configuration and resource allocation for PDSCH transmission using cooperative communication in a wireless communication system according to an embodiment of the disclosure. In FIG. 19, examples of PDSCH transmission are depicted according to techniques of joint transmission (JT), and examples of allocating radio resources for each TRP are shown.

With reference to FIG. 19, an example N000 of coherent joint transmission (C-JT) supporting coherent precoding between cells, TRPs and/or beams is shown. In the case of C-JT, TRP A (N005) and TRP B (N010) may transmit single data (PDSCH) to a UE N015, and multiple TRPs may perform joint precoding. This may indicate that, for TRP A (N005) and TRP B (N010) to transmit the same PDSCH, a DMRS is transmitted through the same DMRS ports. For example, TRP A (N005) and TRP B (N010) may each transmit a DRMS to the UE through DMRS port A and DMRS port B. In this case, the UE may receive one piece of DCI information for receiving one PDSCH to be demodulated based on the DMRS transmitted via DMRS port A and DMRS port B.

FIG. 19 shows an example N020 of non-coherent joint transmission (NC-JT) supporting non-coherent precoding between cells, TRPs, and/or beams for PDSCH transmission.

In the case of NC-JT, each cell, TRP, and/or beam may transmit a PDSCH to the UE N035, and separate precoding may be applied to each PDSCH. Individual cells, TRPs, and/or beams may transmit different PDSCHs or different PDSCH layers to the UE, thereby improving throughput in comparison to single cell, TRP, and/or beam transmission. In addition, individual cells, TRPs or/and beams may transmit the same PDSCH to the UE in a repetitive manner, thereby improving reliability in comparison to single cell, TRP, or/and beam transmission. Hereinafter, for convenience of description, the cell, TRP, and/or beam are collectively referred to as TRP.

Here, various radio resource allocation schemes may be considered, such as a case where the frequency and time resources used by a plurality of TRPs for PDSCH transmission are all the same (N040), a case where the frequency and time resources used by a plurality of TRPs do not overlap at all (N045), or a case where the frequency and time resources used by a plurality of TRPs overlap in part (N050).

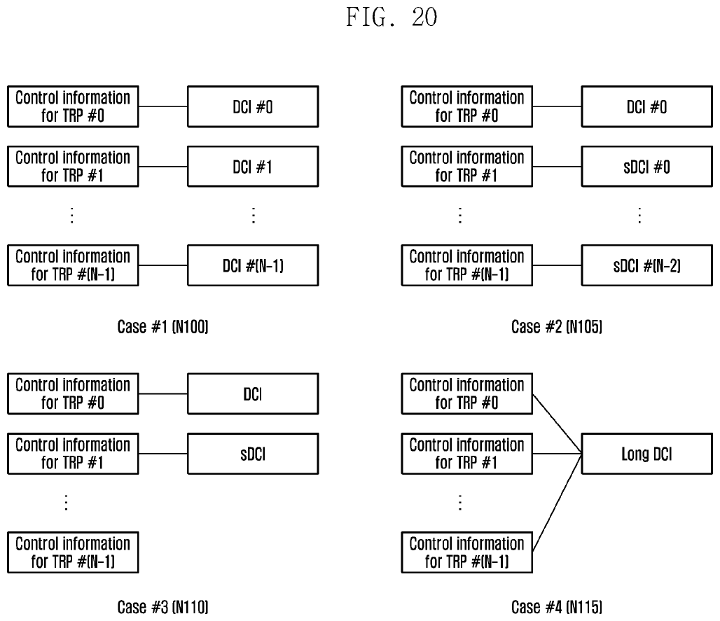

To support NC-JT, it is possible to consider DCIs in various forms, structures, and relationships so as to allocate a plurality of PDSCHs to one UE at the same time. FIG. 20 is a diagram illustrating an example of configuring downlink control information (DCI) for NC-JT in which individual TRPs transmit different PDSCHs or different PDSCH layers to a UE in a wireless communication system according to an embodiment of the disclosure.

With reference to FIG. 20, case #1 (N100) is an example where, in addition to a serving TRP (TRP #0) used for single PDSCH transmission, (N−1) different PDSCHs are transmitted from (N−1) additional TRPs (TRP #1 to TRP #(N−1)), and control information about the PDSCHs transmitted from the (N−1) additional TRPs is transmitted independently of control information about the PDSCH transmitted from the serving TRP. That is, the UE may obtain control information about the PDSCHs transmitted from different TRPs (TRP #0 to TRP #(N−1)) through independent DCIs (DCI #0 to DC1 #(N−1)). The formats of the independent DCIs may be the same or different from each other, and the payloads of the DCIs may also be the same or different from each other. In case #1 described above, although control or allocation freedom of individual PDSCHs may be completely guaranteed, DCIs being transmitted from different TRPs may cause a difference in coverage between DCIs, thereby degrading reception performance. Case #2 (N105) is an example where, in addition to a serving TRP (TRP #0) used for single PDSCH transmission, (N−1) different PDSCHs are transmitted from (N−1) additional TRPs (TRP #1 to TRP #(N−1)), and control information (DCIs) about PDSCHs are separately transmitted from the (N−1) additional TRPs and these DCIs are dependent on the control information about the PDSCH transmitted from the serving TRP.

For example, DCI #0, which is control information on the PDSCH transmitted from the serving TRP (TRP #0), may include all information elements of DCI format 1_0, DCI format 1_1, or DCI format 1_2, but shortened DCIs (hereinafter, “sDCI”) (sDCI #0 to sDCI #(N−2)), which are control information on the PDSCHs transmitted from the cooperating TRPs (TRP #1 to TRP #(N−1)), may include some of information elements of DCI format 1_0, DCI format 1_1, or DCI format 1_2. Hence, an sDCI carrying control information about the PDSCH transmitted from a cooperating TRP has a smaller payload than that of a normal DCI (nDCI) carrying control information about the PDSCH transmitted from the serving TRP, so the sDCI may include reserved bits compared to the nDCI.

In case #2 described above, control or allocation freedom of individual PDSCHs may be restricted depending on the content of information elements included in sDCIs, but reception performance of sDCI is superior to that of nDCI, so that the probability of occurrence of a coverage difference between DCIs may be reduced. Case #3 (N110) is an example where, in addition to a serving TRP (TRP #0) used for single PDSCH transmission, (N−1) different PDSCHs are transmitted from (N−1) additional TRPs (TRP #1 to TRP #(N−1)), and a single piece of control information about the PDSCHs of the (N−1) additional TRPs is transmitted and this DCI is dependent on the control information about the PDSCH transmitted from the serving TRP.

For example, DCI #0, which is control information on the PDSCH transmitted from the serving TRP (TRP #0), may include all information elements of DCI format 1_0, DCI format 1_1, or DCI format 1_2; for control information about the PDSCHs transmitted from the cooperating TRPs (TRP #1 to TRP #(N−1)), some of the information elements of DCI format 1_0, DCI format 1_1, or DCI format 1_2 may be collected in one piece of “secondary” DCI (sDCI) and transmitted. For instance, sDCI may include at least one piece of information among frequency domain resource assignment, time domain resource assignment, and HARQ-related information such as MCS of the cooperating TRPs. Additionally, information being not included in the sDCI, such as bandwidth part (BWP) indicator, or carrier indicator, may follow the DCI (DCI #0, normal DCI, nDCI) of the serving TRP.

In case #3 (N110), although control or allocation freedom of individual PDSCHs may be restricted depending on the content of information elements included in the sDCI, it is possible to control the reception performance of sDCI, and the complexity of DCI blind decoding for the UE may be reduced in comparison to case #1 (N100) or case #2 (N105).

Case #4 (N115) is an example where, in addition to a serving TRP (TRP #0) used for single PDSCH transmission, (N−1) different PDSCHs are transmitted from (N−1) additional TRPs (TRP #1 to TRP #(N−1)), and control information about the PDSCHs transmitted from the (N−1) additional TRPs is transmitted in the same DCI (long DCI) as the DCI carrying control information about the PDSCH transmitted from the serving TRP. That is, the UE may obtain control information about the PDSCHs transmitted from different TRPs (TRP #0 to TRP #(N−1)) through a single DCI. For case #4 (N115), although the complexity of DCI blind decoding in the UE may not increase, the degree of freedom in PDSCH control or allocation may be low, for example, the number of cooperative TRPs may be limited, according to the long DCI payload limit.

In the following description and embodiments, “sDCI” may refer to various auxiliary DCIs, such as shortened DCI, secondary DCI, or normal DCI (DCI formats 1_0 to 1_1 described above) including PDSCH control information transmitted from cooperating TRPs, and a description thereof may be applied to various auxiliary DCIs in a similar manner if particular restrictions are not specified.

In the following description and embodiments, cases such as case #1 (N100), case #2 (N105), and case #3 (N110) described above where one or more DCIs (PDCCHs) are used to support NC-JT may be classified as multiple PDCCH-based NC-JT, and cases such as case #4 (N115) described above where a single DCI (PDCCH) is used to support NC-JT may be classified as single PDCCH-based NC-JT. In multiple PDCCH-based PDSCH transmission, the CORESET in which the DCI of the serving TRP (TRP #0) is scheduled may be distinguished from the CORESET in which the DCI of the cooperating TRPs (TRP #1 to TRP #(N−1)) is scheduled. To distinguish CORESETs, a method of distinguishing CORESETs through a higher layer indicator for each CORESET, a method of distinguishing CORESETs through a beam configuration for each CORESET, or the like may be provided. Additionally, in single PDCCH-based NC-JT, one DCI may schedule a single PDSCH having plural layers instead of scheduling plural PDSCHs, where the plural layers described above may be transmitted from a plurality of TRPs. Here, a linking relationship between a layer and a TRP transmitting the layer may be indicated through a transmission configuration indicator (TCI) for a layer. In embodiments of the disclosure, “cooperating TRP” may be replaced with various terms such as “cooperating panel” or “cooperating beam” when applied in practice.

In embodiments of the disclosure, “the case in which NC-JT is applied” may be variously construed depending on the situation, such as “the case where the UE simultaneously receives one or more PDSCHs in one BWP”, “the case where the UE receives PDSCHs based simultaneously on two or more TCIs (transmission configuration indicators) in one BWP”, “the case where the PDSCH received by the UE is associated with one or more DMRS port groups”, but the single expression is used for convenience of description.

In the disclosure, the radio protocol structure for NC-JT may be used in various ways according to the TRP deployment scenario. For example, if there is no or small backhaul latency between cooperating TRPs, a method using the structure based on MAC layer multiplexing similar to S10 in FIG. 18 is possible (CA-like method). On the other hand, if the backhaul latency between cooperating TRPs is too large to ignore (e.g., exchange of CSI, scheduling, HARQ-ACK information between cooperating TRPs requires 2 ms or more), a method of securing a characteristic resistant to delay by using an independent structure for each TRP from the RLC layer similar to S20 in FIG. x4 is possible (DC-like method).

The UE supporting C-JT/NC-JT may receive C-JT/NC-JT-related parameters or setting values from higher layer configuration to set RRC parameters of the UE based thereon. The UE may utilize UE capability parameters, for example, tci-StatePDSCH, for higher layer configuration. Here, the UE capability parameter, for example, tci-StatePDSCH, may define the TCI states for the purpose of PDSCH transmission, and the number of TCI states may be set to 4, 8, 16, 32, 64 and 128 in FRI and to 64 and 128 in FR2, where up to 8 states that may be indicated by 3 bits of the TCI field in DCI through a MAC CE message may be configured among the set numbers thereof. The maximum value of 128 means the value indicated by maxNumberConfiguredTCIstatesPerCC in parameter tci-StatePDSCH included in the UE capability signaling. As described above, a series of configuration processes from the higher layer configuration to the MAC CE configuration may be applied to a beamforming indication or beamforming switch command for at least one PDSCH in one TRP.

### [Multi-DCI Based Multi-TRP]

As an embodiment of the disclosure, a multi-DCI based multi-TRP transmission method will be described. In the multi-DCI based multi-TRP transmission method, a downlink control channel for NC-JT transmission may be configured based on multiple PDCCHs.

NC-JT based on multiple PDCCHs may have CORESETs or search spaces separate for each TRP when transmitting DCI for scheduling PDSCHs of the individual TRPs. The CORESET or search space for each TRP may be configured as at least one of the following cases.
Configuring a higher layer index for each CORESET: CORESET configuration information configured by a higher layer may include an index value, and the TRP transmitting a PDCCH in the corresponding CORESET may be identified by the index value set for each CORESET. That is, in a set of CORESETs having the same higher layer index value, it may be regarded that the same TRP transmits a PDCCH or that a PDCCH scheduling the PDSCH of the same TRP is transmitted. The index for each CORESET described above may be named as CORESETPoolIndex, and it may be regarded that a PDCCH is transmitted from the same TRP for CORESETs whose CORESETPoolIndex values are the same. For a CORESET whose CORESETPoolIndex value is not set, it may be regarded that a default CORESETPoolIndex value is set, where the default value may be ‘0’.
In the disclosure, if the number of types of CORESETPoolIndex values of multiple CORESETs included in higher layer signaling PDCCH-Config exceeds one, that is, if the individual CORESETs have different CORESETPoolIndex values, the UE may regard that the base station may use a multi-DCI based multi-TRP transmission method.
Otherwise, in the disclosure, if the number of types of CORESETPoolIndex values of multiple CORESETs included in higher layer signaling PDCCH-Config is one, that is, if all CORESETs have the same CORESETPoolIndex value of 0 or 1, the UE may regard that the base station performs transmission using a single TRP without using a multi-DCI based multi-TRP transmission method.
Multiple PDCCH-Config configurations: a plurality of PDCCH-Config's may be configured in one BWP, and each PDCCH-Config may include a PDCCH configuration for each TRP. That is, a list of CORESETs for each TRP and/or a list of search spaces for each TRP may be configured in one PDCCH-Config, and one or more CORESETs and one or more search spaces included in one PDCCH-Config may be regarded as corresponding to a specific TRP.
CORESET beam/beam group configuration: a beam or beam group configured for each CORESET may be used to distinguish a TRP corresponding to the CORESET. For example, if the same TCI state is configured in plural CORESETs, it may be regarded that the CORESETs are transmitted through the same TRP or that the PDCCH scheduling a PDSCH of the same TRP is transmitted in the CORESETs.
Search space beam/beam group configuration: a beam or beam group may configured for each search space, and TRPs for individual search spaces may be distinguished accordingly. For example, if the same beam/beam group or TCI state is configured in plural search spaces, it may be regarded that the same TRP transmits a PDCCH in the corresponding search space or that the PDCCH scheduling a PDSCH of the same TRP is transmitted in the corresponding search space.

By distinguishing CORESETs or search spaces for individual TRPs as described above, PDSCHs and HARQ-ACK information may be classified for each TRP, and thus it is possible to independently generate HARQ-ACK codebooks and to independently utilize PUCCH resources for each TRP.

The above configurations may be independent for each cell or BWP. For example, while two different CORESETPoolIndex values may be set in the PCell, a CORESETPoolIndex value may be not set in a specific SCell. In this case, it may be regarded that NC-JT transmission is configured in the PCell whereas NC-JT transmission is not configured in the SCell where a CORESETPoolIndex value is not set.

A PDSCH TCI state activation/deactivation MAC CE applicable to the multi-DCI based multi-TRP transmission method may follow FIG. 16 above. If CORESETPoolIndex is not set for each of all CORESETs in higher layer signaling PDCCH-Config, the UE may ignore the CORESET Pool ID field 16-55 in the corresponding MAC CE 16-50. If the UE is capable of supporting a multi-DCI based multi-TRP transmission method, that is, if the UE has different CORESETPoolIndex values for the individual CORESETs in higher layer signaling PDCCH-Config, the UE may activate the TCI state in DCI included in the PDCCHs transmitted from the CORESETs having the same CORESETPoolIndex value as the value of the CORESET Pool ID field 16-55 in the corresponding MAC CE 16-50. For example, if the value of the CORESET Pool ID field 16-55 in the corresponding MAC CE 16-50 is ‘0’, the TCI state in DCI included in the PDCCHs transmitted from the CORESETs having a CORESETPoolIndex value of ‘0’ may follow activation information of the corresponding MAC CE.

If the UE is configured to use a multi-DCI based multi-TRP transmission method from the base station, that is, if the number of types of CORESETPoolIndex values of plural CORESETs included in higher layer signaling PDCCH-Config exceeds one, or if the individual CORESETs have different CORESETPoolIndex values, the UE may recognize the following restrictions for PDSCHs scheduled by the PDCCHs in the CORESETs having two different CORESETPoolIndex values.
1) If PDSCHs indicated by the PDCCHs in individual CORESETs having two different CORESETPoolIndex values overlap in whole or in part, the UE may apply the TCI states indicated by the PDCCHs respectively to different CDM groups. That is, two or more TCI states may be not applied to one CDM group.
2) If PDSCHs indicated by the PDCCHs in individual CORESETs having two different CORESETPoolIndex values overlap in whole or in part, the UE may expect that the PDSCHs are not different from each other in terms of actual number of front loaded DMRS symbols, actual number of additional DMRS symbols, actual positions of DMRS symbols, or DMRS type.
3) The UE may expect that the bandwidth parts indicated by the PDCCHs in the CORESETs having two different CORESETPoolIndex values are the same and that the subcarrier spacings thereof are also the same.
4) The UE may expect that information about the PDSCHs scheduled by the PDCCHs in the CORESETs having two different CORESETPoolIndex values is completely included in the corresponding PDCCHs.

### [Single-DCI Based Multi-TRP]

As an embodiment of the disclosure, a single-DCI based multi-TRP transmission method will be described. The single-DCI based multi-TRP transmission method may configure a downlink control channel for NC-JT transmission on the basis of a single PDCCH.

In the single-DCI based multi-TRP transmission method, the PDSCHs transmitted by plural TRPs may be scheduled by using one DCI. Here, the number of TCI states may be used as a method of indicating the number of TRPs transmitting the PDSCHs. That is, if the number of TCI states indicated in the DCI scheduling PDSCHs is two, this may be regarded as single-PDCCH based NC-JT transmission; if the number of TCI states is one, this may be regarded as single-TRP transmission. The TCI states indicated in the DCI may correspond to one or two TCI states among the TCI states activated by a MAC CE. If the TCI states of the DCI correspond to two TCI states activated by a MAC CE, a correspondence relationship may be established between a TCI codepoint indicated in the DCI and the TCI states activated by the MAC CE, in which case there may be two TCI states that correspond to the TCI codepoint and are activated by the MAC CE.

As another example, if at least one codepoint among all codepoints of a TCI state field in the DCI indicates two TCI states, the UE may regard that the base station may perform transmission based on a single-DCI based multi-TRP method. In this case, the at least one codepoint indicating two TCI states in the TCI state field may be activated through an enhanced PDSCH TCI state activation/deactivation MAC CE.

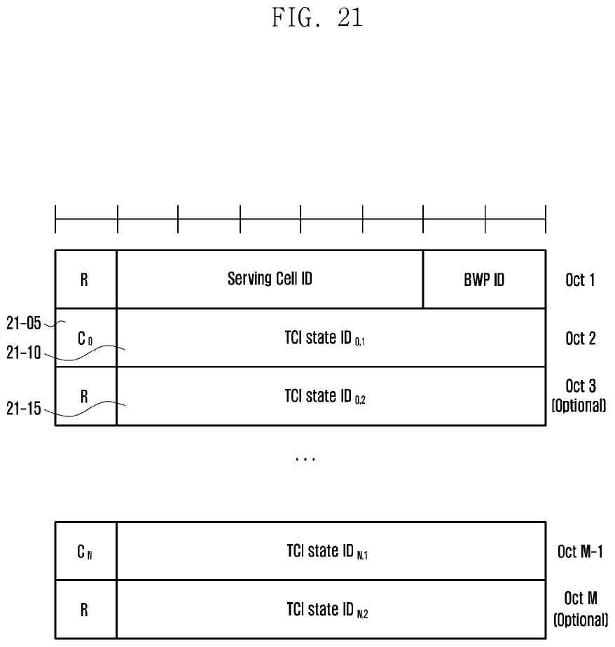

FIG. 21 is a diagram illustrating the structure of an enhanced PDSCH TCI state activation/deactivation MAC CE. Meanings of the fields in the MAC CE and available values for the fields are as follows.

Serving Cell ID: This field indicates the identity of the Serving Cell for which the MAC CE applies. The length
of the field is 5 bits. If the indicated Serving Cell is configured as part of a simultaneousTCI-UpdateList1 or
simultaneousTCI-UpdateList2 as specified in TS 38.331 [5], this MAC CE applies to all the Serving Cells
configured in the set simultaneousTCI-UpdateList1 or simultaneousTCI-UpdateList2, respectively;
BWP ID: This field indicates a DL BWP for which the MAC CE applies as the codepoint of the DCI bandwidth
part indicator field as specified in TS 38.212 [9]. The length of the BWP ID field is 2 bits;
Cᵢ: This field indicates whether the octet containing TCI state ID_{i, 2} is present. If this field is set to “1”, the octet
containing TCI state ID_{i, 2} is present. If this field is set to “0”, the octet containing TCI state ID_{i, 2} is not present;
TCI state ID_{i, j}: This field indicates the TCI state identified by TCI-StateId as specified in TS 38.331 [5], where
i is the index of the codepoint of the DCI Transmission configuration indication field as specified in TS 38.212
[9] and TCI state ID_{i, j} denotes the j-th TCI state indicated for the i-th codepoint in the DCI Transmission
Configuration Indication field. The TCI codepoint to which the TCI States are mapped is determined by its
ordinal position among all the TCI codepoints with sets of TCI state ID_{i, j} fields, i.e. the first TCI codepoint with
TCI state ID_{0, 1} and TCI state ID_{0, 2} shall be mapped to the codepoint value 0, the second TCI codepoint with
TCI state ID_{1, 1} and TCI state ID_{1, 2} shall be mapped to the codepoint value 1 and so on. The TCI state ID_{i, 2} is
optional based on the indication of the Ci field. The maximum number of activated TCI codepoint is 8 and
the maximum number of TCI states mapped to a TCI codepoint is 2.
R: Reserved bit, set to “0”.

In FIG. 21, if the value of the C₀ field 21-05 is ‘1’, the corresponding MAC CE may include a TCI state ID_{0,2} field 21-15 in addition to the TCI state ID_{0,1} field 21-10. This may indicate that TCI state ID_{0,1} and TCI state ID_{0,2} are activated for the 0^{th} codepoint of the TCI state field included in the DCI; if the base station indicates this codepoint to the UE, the UE may receive an indication of two TCI states. If the value of the C₀ field 21-05 is ‘0’, the corresponding MAC CE may not include a TCI state ID_{0,2} field 21-15, which indicates that one TCI state corresponding to TCI state ID_{0,1} is activated for the 0^{th} codepoint of the TCI state field included in the DCI.

The above configuration may be independent for individual cells or BWPs. For example, there may be a maximum of two activated TCI states corresponding to one TCI codepoint in the PCell, whereas there may be a maximum of one activated TCI state corresponding to one TCI codepoint in a specific SCell. In this case, it may be regarded that NC-JT transmission is configured in the PCell, whereas NC-JT transmission is not configured in the SCell described above.

### [Distinguishing Between Single-DCI Based Multi-TRP Repetitive PDSCH Transmission Schemes (TDM/FDM/SDM)]

Next, a description is given of a method for distinguishing between single-DCI based multi-TRP repetitive PDSCH transmission schemes. The UE may receive an indication from the base station of different single-DCI based multi-TRP repetitive PDSCH transmission schemes (e.g., TDM, FDM, SDM) depending on the value indicated in a DCI field and higher layer signaling settings. Table 31 below illustrates a method of distinguishing between single or multiple TRP based schemes indicated to the UE according to the value of a specific DCI field and higher layer signaling settings.

TABLE 31

| | | | repetitionNumber | | transmission |
|---|---|---|---|---|---|
| | number | number | configuration | repetitionScheme | scheme |
| | of TCI | of CDM | and indication | configuration | indicated |
| combination | states | groups | condition | related | to UE |
| 1 | 1 | ≥1 | Condition 2 | Not | Single-TRP |
| | | | | configured | |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured | Single-TRP |
| | | | | or not | TDM scheme B |
| | | | | configured | |
| 5 | 2 | 2 | Condition 2 | Not | Multi-TRP |
| | | | | configured | SDM |
| 6 | 2 | 2 | Condition 3 | Not | Multi-TRP |
| | | | | configured | SDM |
| 7 | 2 | 2 | Condition 3 | Configured | Multi-TRP |
| | | | | | SDM |
| 8 | 2 | 2 | Condition 3 | Configured | Multi-TRP |
| | | | | | FDM scheme |
| | | | | | A/FDM scheme |
| | | | | | B/TDM scheme A |
| 9 | 2 | 2 | Condition 1 | Not | Multi-TRP |
| | | | | configured | TDM scheme B |

In Table 31 above, each column may be described as follows.
Number of TCI states (column 2): this refers to the number of TCI states indicated by a TCI state field in the DCI, and may be 1 or 2.
Number of CDM groups (column 3): this refers to the number of different CDM groups of DMRS ports indicated by an antenna port field in the DCI. It may be 1, 2 or 3.
RepetitionNumber configuration and indication condition (column 4): there may be three conditions depending on whether the repetitionNumber is configured for all TDRA entries that may be indicated by a time domain resource allocation field in the DCI and whether the actually indicated TDRA entry has a repetitionNumber configuration.
Condition 1: at least one of all TDRA entries that may be indicated by the time domain resource allocation field includes a configuration for repetitionNumber, and the TDRA entry indicated by the time domain resource allocation field in the DCI includes a repetitionNumber setting greater than 1
Condition 2: at least one of all TDRA entries that may be indicated by the time domain resource allocation field includes a configuration for repetitionNumber, but the TDRA entry indicated by the time domain resource allocation field in the DCI does not include a configuration for repetitionNumber
Condition 3: none of the TDRA entries that may be indicated by the time domain resource allocation field includes a configuration for repetitionNumber
repetitionScheme configuration related (column 5): this indicates whether higher layer signaling repetitionScheme is configured. Higher layer signaling repetitionScheme may be set to one of “tdmSchemeA”, “fdmSchemeA”, and “fdmSchemeB”.
Transmission scheme indicated to UE (column 6): this refers to single or multiple TRP schemes indicated by one of the combinations (column 1) represented in Table 31 above.
Single-TRP: this refers to single TRP-based PDSCH transmission. If the UE is configured with pdsch-AggegationFactor in higher layer signaling PDSCH-config, the UE may be scheduled with single-TRP based repetitive PDSCH transmission as many times as set. Otherwise, the UE may be scheduled with single-TRP based single PDSCH transmission.
TDM scheme B: this refers to single-TRP-based inter-slot time resource division-based repetitive PDSCH transmission. According to condition 1 related to repetitionNumber described above, the UE repeatedly transmits the PDSCH on the time domain over as many slots as the value of repetitionNumber (greater than 1) set in the TDRA entry indicated by the time domain resource allocation field. At this time, the same start symbol and symbol length of the PDSCH indicated by the TDRA entry are applied in each of as many slots as the value of repetitionNumber, and the same TCI state is applied to each repetitive PDSCH transmission. This scheme is similar to a slot aggregation scheme in that inter-slot repetitive PDSCH transmission is performed on the time resources, but differs from slot aggregation in that whether to indicate repetitive transmission may be dynamically determined based on the time domain resource allocation field in the DCI.
Multi-TRP SDM: this refers to a multi-TRP based spatial resource division PDSCH transmission scheme. This is a scheme of receiving separated layers from each TRP, and is not a repetitive transmission scheme, but may increase the reliability of PDSCH transmission in that transmission is performed at a lowered coding rate while increasing the number of layers. The UE may perform PDSCH reception by applying two TCI states indicated by a TCI state field in the DCI respectively to two CDM groups indicated by the base station.
Multi-TRP FDM scheme A: this refers to a multi-TRP based frequency resource division PDSCH transmission scheme. Since this scheme provides one PDSCH transmission occasion, although it is not repetitive transmission like multi-TRP SDM, it enables high-reliability transmission by lowering the coding rate while increasing the amount of frequency resources. Multi-TRP FDM scheme A may apply two TCI states indicated through a TCI state field in the DCI respectively to non-overlapping frequency resources. In a case where the PRB bundling size is determined to be wideband, if the number of RBs indicated by the frequency domain resource allocation field is N, the UE performs reception by applying the first TCI state to the first ceil (N/2) RBs and applying the second TCI state to the remaining floor (N/2) RBs. Here, ceil(.) and floor(.) are operators that mean rounding up and rounding down at the first decimal place. If the PRB bundling size is determined to be 2 or 4, reception is performed by applying the first TCI state to even-numbered PRGs and applying the second TCI state to odd-numbered PRGs.
Multi-TRP FDM scheme B: this refers to a multi-TRP based frequency resource division repetitive PDSCH transmission scheme, and provides two PDSCH transmission occasions, enabling repetitive PDSCH transmission at individual occasions. In the same way as multi-TRP FDM scheme A, multi-TRP FDM scheme B may also apply two TCI states indicated by a TCI state field in the DCI respectively to non-overlapping frequency resources. In a case where the PRB bundling size is determined to be wideband, if the number of RBs indicated by the frequency domain resource allocation field is N, the UE performs reception by applying the first TCI state to the first ceil (N/2) RBs and applying the second TCI state to the remaining floor (N/2) RBs. Here, ceil(.) and floor(.) are operators that mean rounding up and rounding down at the first decimal place. If the PRB bundling size is determined to be 2 or 4, reception is performed by applying the first TCI state to even-numbered PRGs and applying the second TCI state to odd-numbered PRGs.
Multi-TRP TDM scheme A: this refers to a multi-TRP based time resource division intra-slot repetitive PDSCH transmission scheme. The UE may have two PDSCH transmission occasions in a slot, and the first reception occasion may be determined based on the start symbol and symbol length of the PDSCH indicated by the time domain resource allocation field in the DCI. The start symbol of the second reception occasion of the PDSCH may be at a position obtained by applying a symbol offset corresponding to higher layer signaling StartingSymbolOffsetK from the last symbol of the first transmission occasion, and the transmission occasion may be determined as long as the symbol length indicated therefrom. If higher layer signaling StartingSymbolOffsetK is not configured, the symbol offset may be regarded as 0.
Multi-TRP TDM scheme B: this refers to a multi-TRP based time resource division inter-slot repetitive PDSCH transmission scheme. The UE may have one PDSCH transmission occasion in a slot, and receive repetitive transmission based on the same start symbol and the same symbol length of a PDSCH over as many slots as the value of repetitionNumber indicated by the time domain resource allocation field in the DCI. If repetitionNumber is 2, the UE may receive repetitive PDSCH transmission in the first and second slots by applying the first and second TCI states, respectively. If repetitionNumber is greater than 2, the UE may use different TCI state application schemes according to the value indicated by higher layer signaling tciMapping. If tciMapping is set to cyclicMapping, the first and second TCI states are applied respectively to the first and second PDSCH transmission occasions, and this TCI state application scheme is also applied to the remaining PDSCH transmission occasions in the same way. If tciMapping is set to sequenticalMapping, the first TCI state is applied to the first and second PDSCH transmission occasions and the second TCI state is applied to the third and fourth PDSCH transmission occasions, and this TCI state application scheme is also applied to the remaining PDSCH transmission occasions in the same way.

### [RLM RS Related]

Next, a description will be given of a method of selecting or determining an RLM RS when a radio link monitoring reference signal (RLM RS) is configured or not configured. The UE may be configured by the base station with a set of RLM RSs through RadioLinkMonitoringRS in higher layer signaling RadioLinkMonitoringConfig for each downlink bandwidth part of the SpCell. A detailed higher layer signaling structure may follow Table 32 below.

TABLE 32
RadioLinkMonitoringConfig ::= SEQUENCE {

| | |
|---|---|
| failureDetectionResourcesToAddModList | SEQUENCE |
| (SIZE(1..maxNrofFailureDetectionResources) | OF |

| | |
|---|---|
| RadioLinkMonitoringRS | OPTIONAL, -- Need N |

| | |
|---|---|
| failureDetectionResourcesToReleaseList | SEQUENCE |
| (SIZE(1..maxNrofFailureDetectionResources)) | OF |

RadioLinkMonitoringRS-Id OPTIONAL, -- Need N
beamFailureInstanceMaxCount ENUMERATED {n1, n2, n3, n4,

| | |
|---|---|
| n5, n6, n8, n10} | OPTIONAL, -- |

```
Need R
  beamFailureDetectionTimer ENUMERATED {pbfd1, pbfd2,
pbfd3, pbfd4, pbfd5, pbfd6, pbfd8, pbfd10}
OPTIONAL, -- Need R
...
}
RadioLinkMonitoringRS ::= SEQUENCE {
  radioLinkMonitoringRS-Id RadioLinkMonitoringRS-Id,
```

| | |
|---|---|
| purpose | ENUMERATED { beamFailure, rlf, both}, |
| detectionResource | CHOICE { |
| ssb-Index | SSB-Index, |
| csi-RS-Index | NZP-CSI-RS-ResourceId |

},
...
}

Table 33 below may illustrate the number of RLM RSs that may be configured or selected for specific purposes according to the maximum number of SSBs per half frame (Lₘₐₓ). As shown in Table 33, NLR-RLM RSs may be used for link recovery or radio link monitoring according to the value of Lₘₐₓ, and N_{RLM} RSs among the N_{LR-RLM} RSs may be used for radio link monitoring.

TABLE 33
Table 5-1: N_{LR-RLM} and N_{RLM} as a function of maximum
number Lₘₐₓ of SS/PBCH blocks per half frame

| Lₘₐₓ | N_{LR-RLM} | N_{RLM} |
|---|---|---|
| 4 | 2 | 2 |
| 8 | 6 | 4 |
| 64 | 8 | 8 |

In a case where the UE is not configured with higher layer signaling RadioLinkMonitoringRS, when the UE is configured with a TCI state for receiving a PDSCH in a control resource set, and at least one CSI-RS is included in the corresponding TCI state, an RLM RS may be selected according to the following RLM RS selection methods.
RLM RS selection method 1) if the activated TCI state to be used for receiving the PDCCH has one reference RS (that is, one activated TCI state has only one of QCL-TypeA, B, and C), the UE may select the reference RS of the activated TCI state to be used for receiving the PDCCH as a RLM RS.
RLM RS selection method 2) if the activated TCI state to be used for receiving the PDCCH has two reference RSs (that is, one activated TCI state has one of QCL-TypeA, B, and C, and additionally has QCL-TypeD), the UE may select the reference RS of QCL-TypeD as a RLM RS. The UE does not expect that two QCL-TypeD's are set in one activated TCI state.
RLM RS selection method 3) the UE does not expect that an aperiodic or semi-persistent RS is selected as a RLM RS.
RLM RS selection method 4) when Lₘₐₓ=4, the UE may select N_{RLM} RSs (two RSs may be selected since Lₘₐₓ is 4). Selection of RLM RSs may be performed by selecting ones among the reference RSs of the TCI state configured in the control resource set for receiving the PDCCH according to RLM RS selection methods 1 to 3, where a control resource set associated with a search space having a short periodicity is determined to have higher priority, so RLM RS selection is performed first from the reference RS of the TCI state configured in the control resource set associated with a search space having the shortest periodicity. If there are multiple control resource sets associated with plural search spaces having the same periodicity, RLM RS selection is performed first from the reference RS of the TCI state configured in a higher control resource set index.

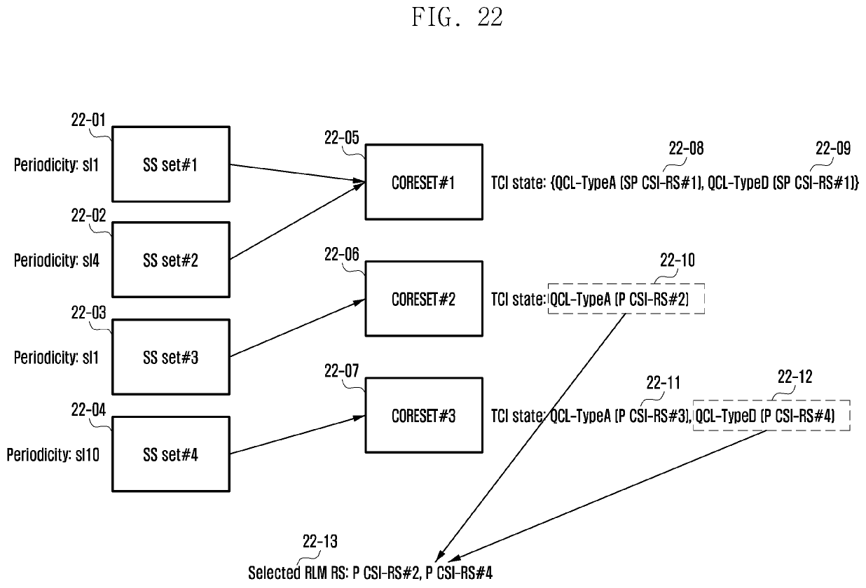

FIG. 22 is a diagram illustrating a RLM RS selection process according to an embodiment of the disclosure. This diagram illustrates control resource sets #1 to #3 (22-05 to 22-07) associated with search spaces #1 to #4 (22-01 to 22-04) having different periodicities in an activated downlink bandwidth part, and reference RSs of TCI states configured in each control resource set. According to RLM RS selection method 4, the RLM RS selection may use a TCI state configured in a control resource set associated with a search space having the shortest periodicity; as search space #1 (22-01) and search space #3 (22-03) have the same periodicity, the reference RS of a TCI state configured in control resource set #2 having a higher index among control resource set #1 (22-05) and control resource set #2 (22-06) associated with these search spaces may be used first as the highest priority in RLM RS selection. Further, since the TCI state configured in control resource set #2 has QCL-TypeA only and the corresponding reference RS is a periodic RS, P CSI-RS #2 (22-10) may be selected first as a RLM RS according to RLM RS selection methods 1 and 3. Next, among reference RSs of the TCI states configured in control resource set #1 having a next highest priority, a reference RS of QCL-TypeD may become a selection candidate according to RLM RS selection method 2, but the corresponding RS is a semi-persistent RS as indicated by indicia 22-09 and thus is not selected as a RLM RS according to RLM RS selection method 3. Hence, reference RSs of the TCI states configured in control resource set #3 may be considered as the next higher priority, the reference RS of QCL-TypeD may become a selection candidate according to RLM RS selection method 2; as the corresponding RS is a periodic RS, P CSI-RS #4 (22-12) may be selected second as a RLM RS according to RLM RS selection method 3. Consequently, the finally selected RLM RS may be P CSI-RS #2 and P CSI-RS #4 as indicated by indicia 22-13.

For convenience in the following description of the disclosure, a cell, a transmission reception point (TRP), a panel, a beam, and/or a transmission direction, which may be identified by a higher layer/L1 parameter such as TCI state and spatial relation information or an indicator such as cell ID, TRP ID, or panel ID, or the like, may be uniformly described as TRP, beam, or TCI state. Accordingly, in actual application, TRP, beam, or TCI state may be appropriately replaced with one of the above terms.

Hereinafter in the disclosure, the UE may use various methods to determine whether to apply cooperative communication, such as a case where the PDCCH(s) for allocating a PDSCH to which cooperative communication is applied has a specific format, a case where the PDCCH(s) for allocating a PDSCH to which cooperative communication is applied includes a specific indicator indicating whether to apply cooperative communication, a case where the PDCCH(s) for allocating a PDSCH to which cooperative communication is applied is scrambled with a specific RNTI, or a case where cooperative communication is assumed to be applied in a specific period indicated by a higher layer. Hereinafter, the case where the UE receives a PDSCH to which cooperative communication is applied based on conditions similar to the above will be referred to as NC-JT case for convenience of description.

Hereinafter, embodiments of the disclosure will be described in detail with reference to the accompanying drawings. In the following description, the term “base station” refers to a main agent allocating resources to terminals and may be at least one of gNode B, gNB, eNode B, Node B, BS, radio access unit, base station controller, or network node. The term “terminal” may refer to at least one of user equipment (UE), mobile station (MS), cellular phone, smartphone, computer, or multimedia system with a communication function. Although embodiments of the disclosure are described using a 5G system as an example, the embodiments of the disclosure may also be applied to other communication systems with similar technical backgrounds or channel configurations. For example, LTE or LTE-A mobile communication and mobile communication technologies developed after 5G may be included. Therefore, it should be understood by those skilled in the art that the embodiments of the disclosure are applicable to other communication systems without significant modifications departing from the scope of the disclosure. The content in this disclosure is applicable to FDD and TDD systems. Additionally, in describing the disclosure, if it is determined that a detailed description of a related function or configuration may unnecessarily obscure the gist of the disclosure, the detailed description will be omitted. Further, the terms described below are defined in consideration of their functions in the disclosure, and these may vary depending on the intention of the user, the operator, or the custom. Hence, their meanings should be determined based on the overall contents of this specification.

In describing the disclosure below, higher layer signaling may be signaling corresponding to at least one of the following signalings or a combination thereof.
MIB (master information block)
SIB (system information block) or SIB X (X=1, 2, . . . )
RRC (radio resource control)
MAC (medium access control) CE (control element)

Additionally, L1 signaling may be signaling corresponding to at least one of the following physical layer channels or signaling methods or a combination thereof.
PDCCH (physical downlink control channel)
DCI (downlink control information)
UE-specific DCI
Group common DCI
Common DCI
Scheduling DCI (e.g., DCI used for scheduling downlink or uplink data)
Non-scheduling DCI (e.g., DCI not intended for scheduling downlink or uplink data)
PUCCH (physical uplink control channel)
UCI (uplink control information)

In the following description of the disclosure, determining the priority between A and B may be referred to in various ways, such as selecting one with a higher priority and performing the corresponding operation according to a preset priority rule, or omitting or dropping the operation corresponding to one with a lower priority.

The term ‘slot’ used in the disclosure below is a general term that may refer to a specific time unit corresponding to the TTI (transmit time interval). Specifically, it may indicate a slot used in a 5G NR system and may also indicate a slot or subframe used in a 4G LTE system.

Although the examples will be described through a plurality of embodiments in the disclosure below, these are not independent and one or more embodiments may be applied simultaneously or in combination.

### First Embodiment: Single TCI State Activation and Indication Method Based on Unified TCI Framework

As an embodiment of the disclosure, a description is given of a method for indicating and activating a single TCI state based on a unified TCI framework. The unified TCI framework may refer to a transmit/receive beam management method that unifies the TCI state based scheme used for downlink reception of the UE in existing Rel-15 and 16 and the spatial relation info based scheme used for uplink transmission into a TCI state based scheme. Hence, when the UE receives an indication from the base station based on the unified TCI framework, it may perform beam management by using a TCI state even for uplink transmission. If the UE is configured by the base station with higher layer signaling TCI-State having higher layer signaling tci-stateId-r17, the UE may perform an operation based on the unified TCI framework by using corresponding TCI-State. TCI-State may occur in two forms of joint TCI state and separate TCI state.

The first form is a joint TCI state, and the UE may be indicated, by the base station, with a TCI state to be applied to both uplink transmission and downlink reception through one TCI-State. If the UE is indicated with TCI-State based on a joint TCI state, the UE may be indicated with a parameter to be used for downlink channel estimation by using an RS of qcl-Type1 in TCI-State based on the joint TCI state, and with a parameter to be used as a downlink receive beam or reception filter by using an RS of qcl-Type2. If the UE is indicated with TCI-State based on a joint TCI state, the UE may be indicated with a parameter to be used as an uplink transmit beam or transmission filter by using an RS of qcl-Type2 in TCI-State based on the joint DL/UL TCI state. At this time, if the UE is indicated with a joint TCI state, the UE may apply the same beam to both uplink transmission and downlink reception.

The second form is a separate TCI state, and the UE may be separately indicated, by the base station, with a UL TCI state to be applied to uplink transmission and a DL TCI state to be applied to downlink reception. If the UE is indicated with a UL TCI state, the UE may be indicated with a parameter to be used as an uplink transmit beam or transmission filter by using a reference RS or source RS configured in the UL TCI state. If the UE is indicated with a DL TCI state, the UE may be indicated with a parameter to be used for downlink channel estimation by using an RS of qcl-Type1 configured in the DL TCI state, and with a parameter to be used as a downlink receive beam or reception filter by using an RS of qcl-Type2. If the UE is indicated with a DL TCI state and a UL TCI state, the UE may be indicated with a parameter to be used as an uplink transmit beam or transmission filter by using a reference RS or source RS configured in the UL TCI state, and be indicated with a parameter to be used for downlink channel estimation by using an RS of qcl-Type1 configured in the DL TCI state and with a parameter to be used as a downlink receive beam or reception filter by using an RS of qcl-Type2 configured therein. Here, if the reference RSs or source RSs configured in the indicated DL TCI state and UL TCI state are different, the UE may separately apply the beams to uplink transmission and downlink reception based on the indicated UL TCI state and DL TCI state.

The UE may be configured by the base station with up to 128 joint TCI states through higher layer signaling for each bandwidth part in a specific cell, and be configured with up to 64 or 128 DL TCI states among the separate TCI states according to the UE capability report through higher layer signaling for each bandwidth part in a specific cell, where the DL TCI state among separate TCI states and the joint TCI state may use the same higher layer signaling structure. For example, if 128 joint TCI states are configured and 64 DL TCI states are configured among the separate TCI states, the 64 DL TCI states may be included in the 128 joint TCI states.

The UE may be configured with up to 32 or 64 UL TCI states among the separate TCI states according to the UE capability report through higher layer signaling for each bandwidth part in a specific cell, where the UL TCI state among separate TCI states and the joint TCI state may use the same higher layer signaling structure like the relationship between the DL TCI state among separate TCI states and the joint TCI state, or the UL TCI state among separate TCI states may use a different higher layer signaling structure from the joint TCI state and the DL TCI state among separate TCI states. The usage of different or identical higher layer signaling structures may be defined in the standards, or may be identified through another higher layer signaling configured by the base station based on the UE capability report containing information about a usage scheme that may be supported by the UE among the two.

The UE may receive a transmit/receive beam-related indication through a unified TCI framework using one of the joint TCI state and the separate TCI state configured by the base station. Whether to use one of the joint TCI state and the separate TCI state may be indicated to the UE through higher layer signaling from the base station.

The UE may receive a transmit/receive beam related indication by using one of the joint TCI state and separate TCI state through upper layer signaling, where there may be two methods for transmit/receive beam indication from the base station: MAC CE-based indication, and MAC CE-based activation and DCI-based indication.

If the UE receives an indication related to transmit/receive beams by using a joint TCI state scheme through higher layer signaling, the UE may receive a MAC CE indicating a joint TCI state from the base station to perform a transmit/receive beam application operation, and the base station may schedule the UE through a PDCCH to receive a PDSCH including the corresponding MAC CE. If the MAC CE includes one joint TCI state, the UE may determine the uplink transmit beam or transmission filter and the downlink receive beam or reception filter by using the indicated joint TCI state from 3 ms after transmitting a PUCCH including HARQ-ACK information indicating successful or unsuccessful reception of the PDSCH including the corresponding MAC CE. If the MAC CE includes two or more joint TCI states, the UE may, from 3 ms after transmitting a PUCCH including HARQ-ACK information indicating successful or unsuccessful reception of the PDSCH including the corresponding MAC CE, identify that the plural joint TCI states indicated by the MAC CE correspond to individual codepoints of the TCI state field of DCI format 1_1 or 1_2 and activate the indicated joint TCI state. Thereafter, the UE may receive DCI format 1_1 or 1_2 and apply one joint TCI state indicated by the TCI state field in the corresponding DCI to the uplink transmit beam and downlink receive beam. At this time, DCI format 1_1 or 1_2 may include downlink data channel scheduling information (with DL assignment) or may not include the same (without DL assignment).

If the UE receives an indication related to transmit/receive beams by using a separate TCI state scheme through higher layer signaling, the UE may receive a MAC CE indicating a separate TCI state from the base station to perform a transmit/receive beam application operation, and the base station may schedule the UE through a PDCCH to receive a PDSCH including the corresponding MAC CE. If the MAC CE includes one separate TCI state set, the UE may determine the uplink transmit beam or transmission filter and the downlink receive beam or reception filter by using separate TCI states of the indicated separate TCI state set from 3 ms after transmitting a PUCCH including HARQ-ACK information indicating successful or unsuccessful reception of the corresponding PDSCH. Here, a separate TCI state set may mean single or multiple separate TCI states that may be carried by one codepoint of the TCI state field in DCI format 1_1 or 1_2, and one separate TCI state set may include one DL TCI state, one UL TCI state, or one DL TCI state and one UL TCI state. If the MAC CE includes two or more separate TCI state sets, the UE may, from 3 ms after transmitting a PUCCH including HARQ-ACK information indicating successful or unsuccessful reception of the corresponding PDSCH, identify that the plural separate TCI state sets indicated by the MAC CE correspond to individual codepoints of the TCI state field of DCI format 1_1 or 1_2 and activate the indicated separate TCI state set. Here, each codepoint of the TCI state field in DCI format 1_1 or 1_2 may indicate one DL TCI state, one UL TCI state, or one DL TCI state and one UL TCI state. The UE can receive DCI format 1_1 or 1_2 and apply a separate TCI state set indicated by the TCI state field in the corresponding DCI to the uplink transmit beam and downlink receive beam. At this time, DCI format 1_1 or 1_2 may include downlink data channel scheduling information (with DL assignment) or may not include the same (without DL assignment).

The MAC CE used to activate or indicate the single joint TCI state or separate TCI state described above may be present separately for joint and separate TCI state schemes, or one MAC CE may be used to activate or indicate the TCI state based on one of joint and separate TCI state schemes. Through the drawings described later, various MAC CE structures for joint or separate TCI state activation and indication may be considered.

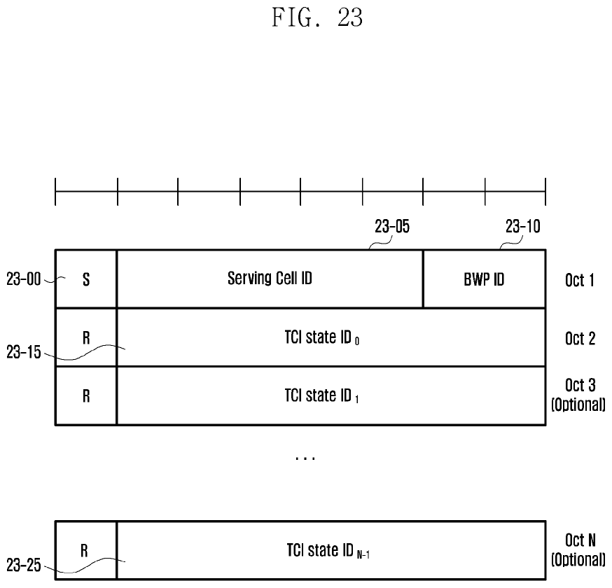

FIG. 23 is a diagram illustrating a MAC CE structure for activating and indicating joint TCI states in a wireless communication system according to an embodiment of the disclosure. In FIG. 23, if the value of the S field 23-00 is ‘1’, the corresponding MAC CE may indicate one joint TCI state and may have a length of up to the second octet. If the value of the S field 23-00 is ‘0’, the corresponding MAC CE may include information about two or more joint TCI states, where the joint TCI state may be activated in each codepoint of the TCI state field in DCI format 1_1 or 1_2, and up to 8 joint TCI states may be activated. Those TCI states indicated by the TCI state ID₀ to TCI state ID_{N-1} fields 23-15 to 23-25 correspond respectively to the 0^{th} to N−1^{th} codepoints of the TCI state field in DCI format 1_1 or 1_2. The serving cell ID field 23-05 and BWP ID field 23-10 may indicate the serving cell ID and bandwidth part ID, respectively.

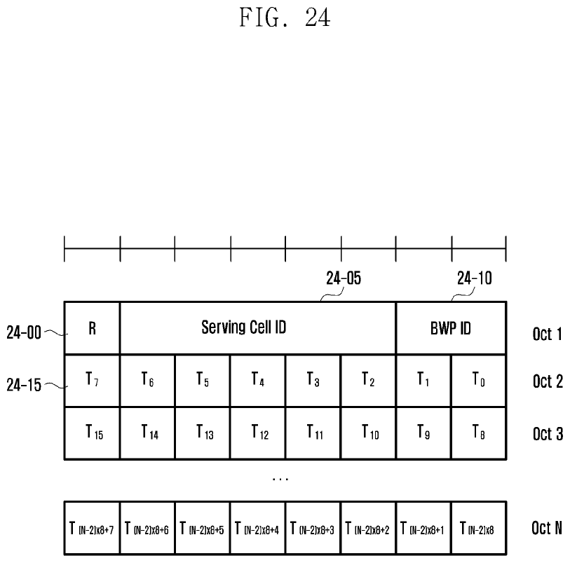

FIG. 24 is a diagram illustrating another MAC CE structure for activating and indicating joint TCI states in a wireless communication system according to an embodiment of the disclosure. In FIG. 24, the serving cell ID field 24-05 and the BWP ID field 24-10 may indicate the serving cell ID and bandwidth part ID, respectively. The R field 24-00 may be a 1-bit reserved field that does not contain indicating information. Each field in the 2^{nd} to N^{th} octets is a bitmap representing a joint TCI state configured through higher layer signaling. For example, the T₇ field 24-15 may be a field indicating whether a 8^{th} joint TCI state configured through higher layer signaling is indicated. If there is one joint TCI state carried by the MAC CE structure of FIG. 24, the UE may apply the joint TCI state indicated by the MAC CE to the uplink transmit beam and downlink receive beam; if there are two or more joint TCI states carried by the MAC CE structure, the UE may identify that the joint TCI states indicated by the MAC CE correspond respectively to codepoints of the TCI state field in DCI format 1_1 or 1_2 and activate each joint TCI state, where the indicated joint TCI states may correspond respectively to the codepoints of the TCI state field in order from the lowest index for activation.

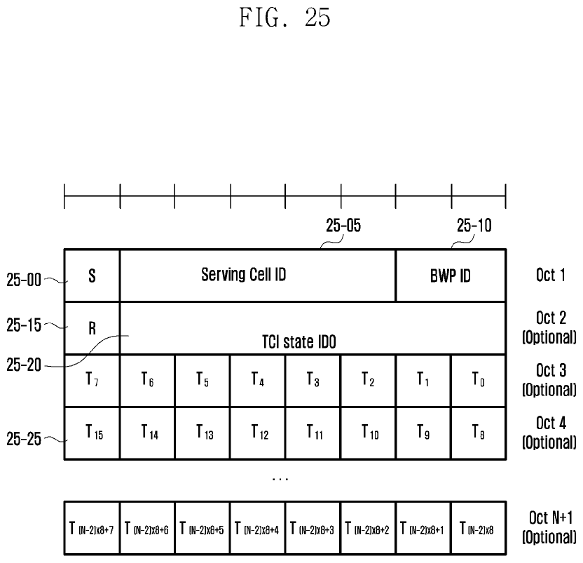

FIG. 25 is a diagram illustrating another MAC CE structure for activating and indicating joint TCI states in a wireless communication system according to an embodiment of the disclosure. In FIG. 25, the serving cell ID field 25-05 and the BWP ID field 25-10 may indicate the serving cell ID and bandwidth part ID, respectively. For example, if the value of the S field 25-00 is ‘1’, the corresponding MAC CE may indicate one joint TCI state and may include up to the 2^{nd} octet only, and the joint TCI state may be indicated to the UE through the TCI state ID₀ field 25-20.

For example, if the value of the S field 25-00 is ‘0’, the corresponding MAC CE may include information about two or more joint TCI states, codepoints of the TCI state field in DCI format 1_1 or 1_2 may respectively activate the joint TCI states and up to 8 joint TCI states may be activated, and the 2^{nd} octet is not present and the 1^{st} octet and 3^{rd} to N+1^{th} octets may be present in the MAC CE structure of FIG. 25. Each field in the 3^{rd} to N+1^{th} octets is a bitmap that represents the joint TCI state configured through higher layer signaling. For example, the Tis field 25-25 may be a field indicating whether a 16^{th} joint TCI state configured through higher layer signaling is indicated.

If there is one joint TCI state carried by the MAC CE structure of FIG. 25, the UE may apply the joint TCI state indicated by the MAC CE to the uplink transmit beam and downlink receive beam; if there are two or more joint TCI states carried by the MAC CE structure, the UE may identify that the joint TCI states indicated by the MAC CE correspond respectively to codepoints of the TCI state field in DCI format 1_1 or 1_2 and activate each joint TCI state, where the indicated joint TCI states may correspond respectively to the codepoints of the TCI state field in order from the lowest index for activation.

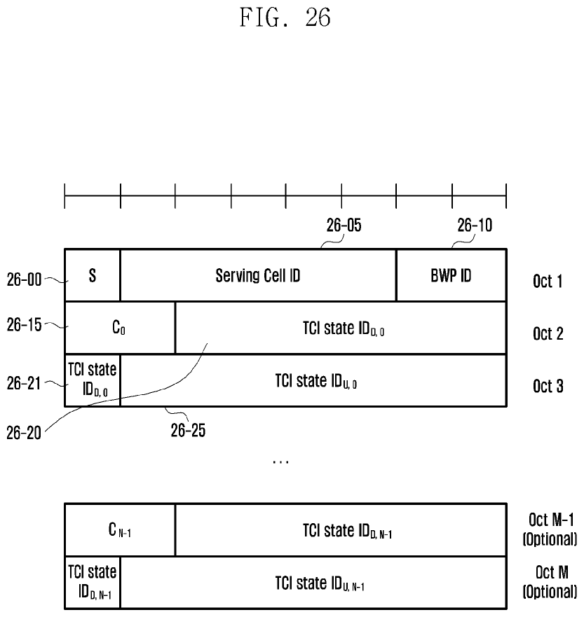

FIG. 26 is a diagram illustrating a MAC CE structure for activating and indicating separate TCI states in a wireless communication system according to an embodiment of the disclosure. In FIG. 26, the serving cell ID field 26-05 and the BWP ID field 26-10 may indicate the serving cell ID and bandwidth part ID, respectively. For example, if the value of the S field 26-00 is ‘1’, the corresponding MAC CE may indicate one separate TCI state set and may include up to the 3^{rd} octet only.

For example, if the value of the S field 26-00 is ‘0’, the corresponding MAC CE may include information about two or more separate TCI state sets, codepoints of the TCI state field in DCI format 1_1 or 1_2 may respectively activate the separate TCI state sets, and up to 8 separate TCI state sets may be activated. The C₀ field 26-15 may be a field indicating constituent TCI states included in the indicated separate TCI state set; for example, the C₀ field values of ‘00’, ‘01’, ‘10’, and ‘11’ may refer respectively to “reserved”, one DL TCI state, one UL TCI state, and one DL TCI state and one UL TCI state, but without being limited thereto. The TCI state ID_{D,0} field 26-20 and the TCI state ID_{U,0} field 26-25 may indicate a DL TCI state and a UL TCI state that may be included in the 0^{th} separate TCI state set, respectively; if the C₀ field value is ‘01’, the TCI state ID_{D,0} field 26-20 may indicate a DL TCI state and the TCI state ID_{V,0} field 26-25 may be ignored; if the C₀ field value is ‘10’, the TCI state ID_{D,0} field 26-20 may be ignored and the TCI state ID_{V,0} field 26-25 may indicate a UL TCI state; if the C₀ field value is ‘11’, the TCI state ID_{D,0} field 26-20 may indicate a DL TCI state and the TCI state ID_{V,0} field 26-25 may indicate a UL TCI state.

FIG. 26 may illustrate an example of MAC CE when the UL TCI state among the separate TCI states uses the same higher layer signaling structure as the DL TCI state among the separate TCI states and the joint TCI state as described above, and thus the length of the TCI state ID_{D,0} field 26-20 and the TCI state ID_{V,0} field 26-25 may be 7 bits to represent up to 128 TCI states. So, to use 7 bits for the TCI state ID_{D,0} field 26-20, 6 bits (26-20) may be allocated in the 2^{nd} octet and 1 bit (26-21) may be allocated in the 3^{rd} octet. In addition, FIG. 26 may illustrate a case where the UL TCI state among the separate TCI states uses a higher layer signaling structure different from that of the DL TCI state among the separate TCI states and the joint TCI state as described above; since representing up to 64 UL TCI states requires 6 bits, the first bit of the TCI state ID_{V,0} field 26-25 may be fixed to ‘0’ or ‘1’, and the actual bits representing a UL TCI state may be a total of 6 bits from the 2^{nd} to 7^{th} bits.

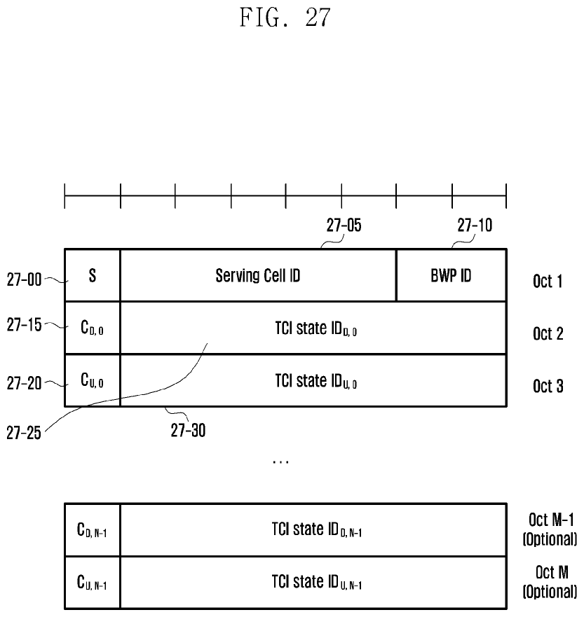

FIG. 27 is a diagram illustrating another MAC CE structure for activating and indicating separate TCI states in a wireless communication system according to an embodiment of the disclosure. In FIG. 27, the serving cell ID field 27-05 and the BWP ID field 27-10 may indicate the serving cell ID and bandwidth part ID, respectively. For example, if the value of the S field 27-00 is ‘1’, the corresponding MAC CE may indicate one separate TCI state set and may include up to the 3^{rd} octet only. For example, if the value of the S field 27-00 is ‘0’, the corresponding MAC CE may include information about two or more separate TCI state sets, codepoints of the TCI state field in DCI format 1_1 or 1_2 may correspond respectively to the separate TCI state sets for activation, and up to 8 separate TCI state sets may be activated. The C_{D,0} field 27-15 may be a field indicating whether the indicated separate TCI state set includes a DL TCI state; if its value is ‘1’, the separate TCI state set includes a DL TCI state and the DL TCI state may be indicated through the TCI state ID_{D,0} field 27-25; if its value is ‘0’, the separate TCI state does not include a DL TCI state and the TCI state ID_{D,0} field 27-25 may be ignored. Similarly, the C_{U,0} field 27-20 may be a field indicating whether the indicated separate TCI state set includes a UL TCI state; if its value is ‘1’, the separate TCI state set includes a UL TCI state and the UL TCI state may be indicated through the TCI state ID_{U,0} field 27-30; if its value is ‘0’, the separate TCI state does not include a UL TCI state and the TCI state ID_{V,0} field 27-30 may be ignored.

FIG. 27 may illustrate an example of MAC CE when the UL TCI state among the separate TCI states uses the same higher layer signaling structure as the DL TCI state among the separate TCI states and the joint TCI state as described above, and thus the length of the TCI state ID_{D,0} field 27-25 and the TCI state ID_{V,0} field 27-30 may be 7 bits to represent up to 128 TCI states. In addition, FIG. 27 may illustrate an example of MAC CE when the UL TCI state among the separate TCI states uses a higher layer signaling structure different from that of the DL TCI state among the separate TCI states and the joint TCI state as described above; since representing up to 64 UL TCI states requires 6 bits, the first bit of the TCI state ID_{V,0} field 27-25 may be fixed to ‘0’ or ‘1’, and the actual bits representing a UL TCI state may be a total of 6 bits from the 2^{nd} to 7^{th} bits.

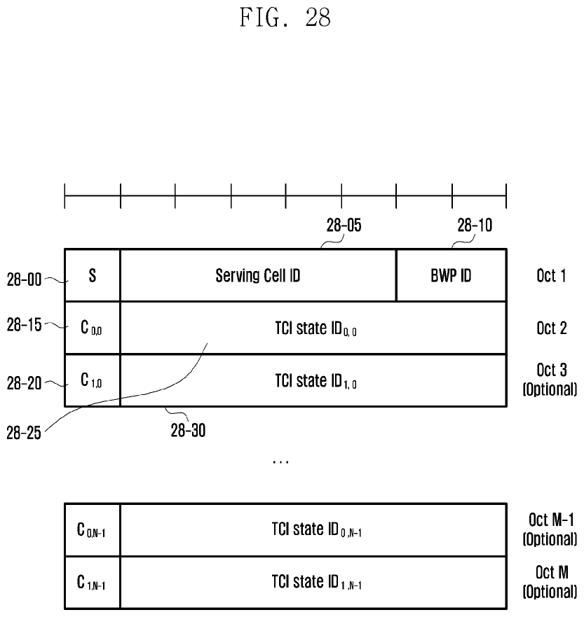

FIG. 28 is a diagram illustrating another MAC CE structure for activating and indicating separate TCI states in a wireless communication system according to an embodiment of the disclosure. In FIG. 28, the serving cell ID field 28-05 and the BWP ID field 28-10 may indicate the serving cell ID and bandwidth part ID, respectively. For example, if the value of the S field 28-00 is ‘1’, the corresponding MAC CE may indicate one separate TCI state set and may include up to the 3^{rd} octet only. The MAC CE structure of FIG. 28 may indicate one separate TCI state set by using two octets; if the corresponding separate TCI state set includes a DL TCI state, the first octet of the two octets may always indicate the DL TCI state, and the second octet may always indicate the UL TCI state. Alternatively, this order may be changed.

For example, if the value of the S field 28-00 is ‘0’, the corresponding MAC CE may include information about two or more separate TCI state sets, codepoints of the TCI state field in DCI format 1_1 or 1_2 may respectively activate the separate TCI state sets, and up to 8 separate TCI state sets may be activated. The C_{0,0} field 28-15 may have the meaning of distinguishing whether the TCI state indicated by the TCI state ID_{0,0} field 28-25 is a DL TCI state or a UL TCI state; its value of ‘1’ may indicate a DL TCI state, the DL TCI state may be indicated by the TCI state ID_{0,0} field 28-25, and the 3^{rd} octet may be present. Here, if the value of the C_{1,0} field 28-20 is ‘1’, a UL TCI state may be indicated by the TCI state ID_{1,0} field 28-30; if the value of the C_{1,0} field 28-20 is ‘0’, the TCI state ID_{1,0} field 28-30 may be ignored. If the value of the C_{0,0} field 28-15 is ‘0’, a UL TCI state may be indicated by the TCI state ID_{0,0} field 28-25, and the 3^{rd} octet may be not present. These examples are just an illustration.

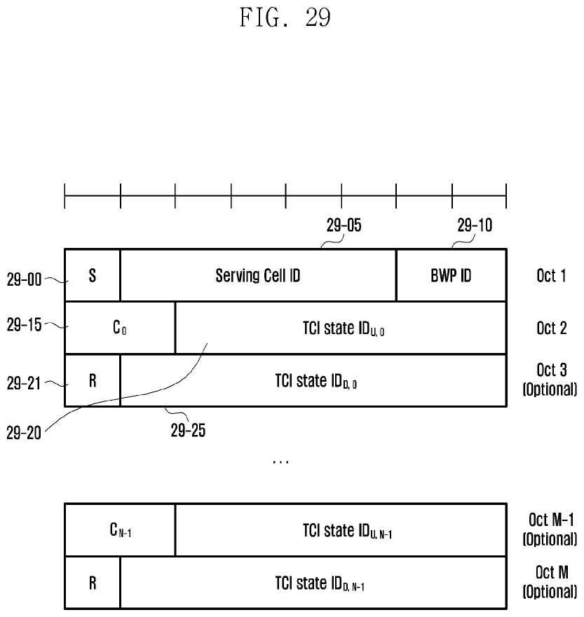

FIG. 28 may illustrate an example of MAC CE when the UL TCI state among the separate TCI states uses the same higher layer signaling structure as the DL TCI state among the separate TCI states and the joint TCI state as described above, and thus the length of the TCI state ID_{0,0} field 28-25 and the TCI state ID_{1,0} field 28-30 may be 7 bits to represent up to 128 TCI states. In addition, FIG. 28 may illustrate an example of MAC CE when the UL TCI state among the separate TCI states uses a higher layer signaling structure different from that of the DL TCI state among the separate TCI states and the joint TCI state as described above; the TCI state ID_{0,0} field 28-25 may have 7 bits capable of representing both up to 64 UL TCI states (6 bits) and up to 128 DL TCI states (7 bits); if the value of the C_{1,0} field 28-15 is ‘l’ and thus the TCI state ID_{0,0} field 28-25 indicates a UL TCI state, the first bit of the TCI state ID_{0,0} field 28-25 may be fixed to ‘0’ or ‘l’, and the actual bits representing a UL TCI state may be a total of 6 bits from the 2^{nd} to 7^{th} bits. FIG. 29 is a diagram illustrating another MAC CE structure for activating and indicating separate TCI states in a wireless communication system according to an embodiment of the disclosure. In FIG. 29, the serving cell ID field 29-05 and the BWP ID field 29-10 may indicate the serving cell ID and bandwidth part ID, respectively. For example, if the value of the S field 29-00 is ‘1’, the corresponding MAC CE may indicate one separate TCI state set and may include up to the 3^{rd} octet only.

For example, if the value of the S field 29-00 is ‘0’, the corresponding MAC CE may include information about two or more separate TCI state sets, codepoints of the TCI state field in DCI format 1_1 or 1_2 may respectively activate the separate TCI state sets, and up to 8 separate TCI state sets may be activated. The C₀ field 29-15 may be a field indicating constituent TCI states included in the indicated separate TCI state set; the C₀ field values of ‘00’, ‘01’, ‘10’, and ‘11’ may refer respectively to “reserved”, one DL TCI state, one UL TCI state, and one DL TCI state and one UL TCI state, but without being limited thereto. The TCI state ID_{V,0} field 29-20 and the TCI state ID_{D,0} field 29-25 may indicate a UL TCI state and a DL TCI state that may be included in the 0^{th} separate TCI state set, respectively; if the C₀ field value is ‘01’, the TCI state ID_{D,0} field 29-25 may indicate a DL TCI state and the TCI state ID_{U,0} field 29-20 may be ignored; if the C₀ field value is ‘10’, the 3^{rd} octet may be ignored, and the TCI state ID_{U,0} field 29-20 may indicate a UL TCI state; if the C₀ field value is ‘11’, the TCI state ID_{D,0} field 29-25 may indicate a DL TCI state, and the TCI state ID_{U,0} field 29-20 may indicate a UL TCI state.

FIG. 29 may illustrate an example of MAC CE when the UL TCI state among the separate TCI states uses a higher layer signaling structure different from that of the DL TCI state among the separate TCI states and the joint TCI state as described above; so, the length of the TCI state ID_{D,0} field 29-25 may be 7 bits to express up to 128 TCI states, and the length of the TCI state ID_{U,0} field 29-20 may be 6 bits to represent up to 64 TCI states.

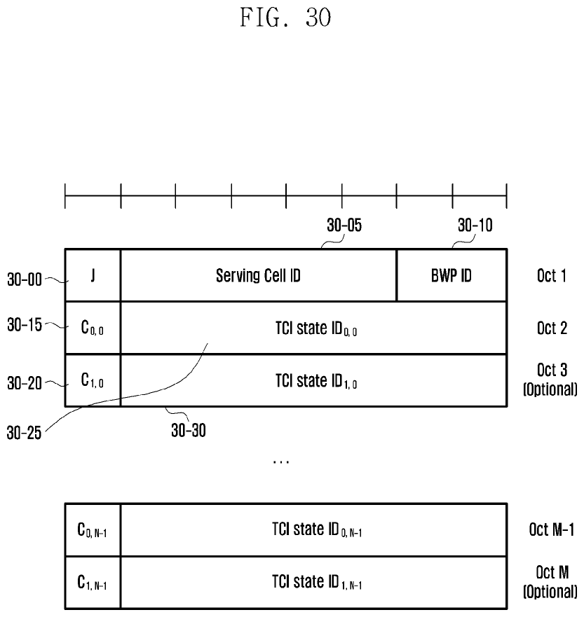

FIG. 30 is a diagram illustrating a MAC CE structure for activating and indicating joint and separate TCI states in a wireless communication system according to an embodiment of the disclosure. In FIG. 30, the serving cell ID field 30-05 and the BWP ID field 30-10 may indicate the serving cell ID and bandwidth part ID, respectively. For example, if the value of the J field 30-00 is ‘1’, the corresponding MAC CE may indicate a joint TCI state; if the value thereof is ‘0’, the MAC CE may indicate a separate TCI state set.
If the corresponding MAC CE indicates a joint TCI state, all odd-numbered octets (3^{rd}, 5^{th}, . . . ) except for the first octet may be ignored. The C_{0,0} field 30-15 may indicate whether the corresponding MAC CE indicates one joint TCI state, or the MAC CE includes information about two or more TCI states and codepoints of the TCI state field in DCI format 1_1 or 1_2 respectively activate TCI states. If the value of the C_{0,0} field 30-15 is ‘1’, the corresponding MAC CE may indicate one joint TCI state and may include up to the 2^{nd} octet only; if the value thereof is ‘0’, two or more joint TCI states indicated by the MAC CE may correspond respectively to codepoints of the TCI state field in DCI format 1_1 or 1_2 and may be activated. TCI state ID_{0,0} may refer to the indicated 1^{st} joint TCI state.
If the corresponding MAC CE indicates a separate TCI state set, for example, the C_{0,0} field 30-15 may have the meaning of distinguishing whether the TCI state indicated by the TCI state ID_{0,0} field 30-25 is a DL TCI state or a UL TCI state; its value being of ‘1’ may indicate a DL TCI state, the DL TCI state may be indicated by the TCI state ID_{0,0} field 30-25, and the 3^{rd} octet may be present. Here, if the value of the C_{1,0} field 30-20 is ‘1’, a UL TCI state may be indicated by the TCI state ID_{1,0} field 30-30; if the value of the C_{1,0} field 30-20 is ‘0’, the TCI state ID_{1,0} field 30-30 may be ignored. If the value of the C_{0,0} field 30-15 is ‘0’, a UL TCI state may be indicated by the TCI state ID_{0,0} field 30-25, and the 3^{rd} octet may be not present.

FIG. 30 may illustrate an example of MAC CE when the UL TCI state among the separate TCI states uses the same higher layer signaling structure as the DL TCI state among the separate TCI states and the joint TCI state as described above, and thus the length of the TCI state ID_{0,0} field 30-25 and the TCI state ID_{1,0} field 30-30 may be 7 bits to represent up to 128 TCI states. In addition, FIG. 30 may illustrate an example of MAC CE when the UL TCI state among the separate TCI states uses a higher layer signaling structure different from that of the DL TCI state among the separate TCI states and the joint TCI state as described above; the TCI state ID_{0,0} field 30-25 may have 7 bits capable of representing both up to 64 UL TCI states (6 bits) and up to 128 DL TCI states (7 bits); if the value of the C_{1,0} field 30-15 is ‘1’ and thus the TCI state ID_{0,0} field 30-25 indicates a UL TCI state, the first bit of the TCI state ID_{0,0} field 30-25 may be fixed to ‘0’ or ‘1’, and the actual bits representing a UL TCI state may be a total of 6 bits from the 2^{nd} to 7^{th} bits.

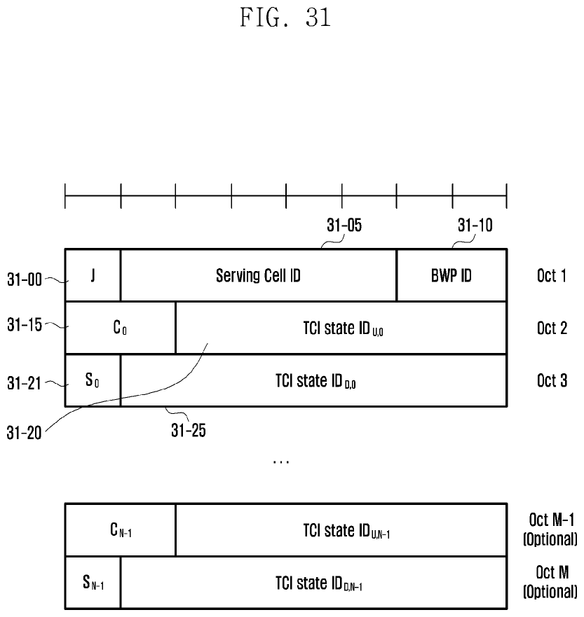

FIG. 31 is a diagram illustrating another MAC CE structure for activating and indicating joint and separate TCI states in a wireless communication system according to an embodiment of the disclosure. In FIG. 31, the serving cell ID field 31-05 and the BWP ID field 31-10 may indicate the serving cell ID and bandwidth part ID, respectively. For example, if the value of the J field 31-00 is ‘l’, the corresponding MAC CE may indicate a joint TCI state; if the value thereof is ‘0’, the MAC CE may indicate a separate TCI state set.
If the corresponding MAC CE indicates a joint TCI state, all odd-numbered octets (3^{rd}, 5^{th}, . . . ) except for the first octet may be ignored. The S₀ field 31-21 may indicate whether the corresponding MAC CE indicates one joint TCI state, or two or more TCI states corresponds respectively to codepoints of the TCI state field in DCI format 1_1 or 1_2 and are activated. If the value of the S₀ field 31-21 is ‘1’, the corresponding MAC CE may indicate one joint TCI state and may include up to the 2^{nd} octet only; if the value thereof is ‘0’, the corresponding MAC CE may include information about two or more joint TCI states, and codepoints of the TCI state field in DCI format 1_1 or 1_2 may respectively activate joint TCI states. TCI state ID_{0,0} may refer to the indicated 1^{st} joint TCI state.
If the corresponding MAC CE indicates a separate TCI state set, the C₀ field 31-15 may be a field indicating constituent TCI states included in the indicated separate TCI state set; the C₀ field values of ‘00’, ‘01’, ‘10’, and ‘11’ may refer respectively to “reserved”, one DL TCI state, one UL TCI state, and one DL TCI state and one UL TCI state. These values are only examples and the disclosure is not limited by these examples. The TCI state ID_{U,0} field 31-20 and the TCI state ID_{D,0} field 31-25 may indicate a UL TCI state and a DL TCI state that may be included in the 0^{th} separate TCI state set, respectively; if the C₀ field value is ‘01’, the TCI state ID_{D,0} field 31-25 may indicate a DL TCI state and the TCI state ID_{V,0} field 31-20 may be ignored; if the C₀ field value is ‘10’, the TCI state ID_{V,0} field 31-20 may indicate a UL TCI state; if the C₀ field value is ‘11’, the TCI state ID_{D,0} field 31-25 may indicate a DL TCI state, and the TCI state ID_{U,0} field 31-20 may indicate a UL TCI state. If the value of the S₀ field 31-21 is ‘1’, the corresponding MAC CE may indicate one separate TCI state set and may include up to the 3^{rd} octet only; if the value of the S₀ field 31-21 is ‘0’, the corresponding MAC CE may include information about two or more separate TCI state sets, codepoints of the TCI state field in DCI format 1_1 or 1_2 may respectively activate the separate TCI state sets, and up to 8 separate TCI state sets may be activated. For example, when the value of the S₀ field 31-21 is ‘0’, if the value of the C₁, . . . , C_{N-1} fields is ‘10’, this means that only the UL TCI state is indicated, so the 5^{th}, 7^{th}, . . . , M^{th} octets may be ignored. Alternatively, the Sn field may indicate whether an octet for the next separate TCI state set is present. For example, if the value of the Sn field is ‘1’, the next octet may be not present; if the value of the Sₙ field is ‘0’, the next octet including Cₙ₊₁ and TCI state ID_{U,n+1} may be present.
FIG. 31 may illustrate an example of MAC CE when the UL TCI state among the separate TCI states uses a higher layer signaling structure different from that of the DL TCI state among the separate TCI states and the joint TCI state as described above; the length of the TCI state ID_{D,0} field 31-25 can be 7 bits to represent up to 128 TCI states, and the length of the TCI state ID_{U,0} field 31-20 may be 6 bits to represent up to 64 TCI states.

If the UE receives an indication related to transmit/receive beams by using a joint TCI state scheme or separate TCI state scheme through higher layer signaling, the UE may receive a PDSCH including a MAC CE indicating a joint TCI state or separate TCI state from the base station to perform a transmit/receive beam application operation. If the MAC CE includes two or more joint TCI states or separate TCI state sets, as described above, the UE may, from 3 ms after transmitting a PUCCH including HARQ-ACK information indicating successful or unsuccessful reception of the corresponding PDSCH, identify that the plural joint TCI states or separate TCI state sets indicated by the MAC CE correspond respectively to individual codepoints of the TCI state field in DCI format 1_1 or 1_2 and activate the indicated joint TCI state or separate TCI state set; thereafter, the UE may receive DCI format 1_1 or 1_2 and apply one joint TCI state or separate TCI state set indicated by the TCI state field in the corresponding DCI to the uplink transmit beam and downlink receive beam. At this time, DCI format 1_1 or 1_2 may include downlink data channel scheduling information (with DL assignment) or may not include the same (without DL assignment).

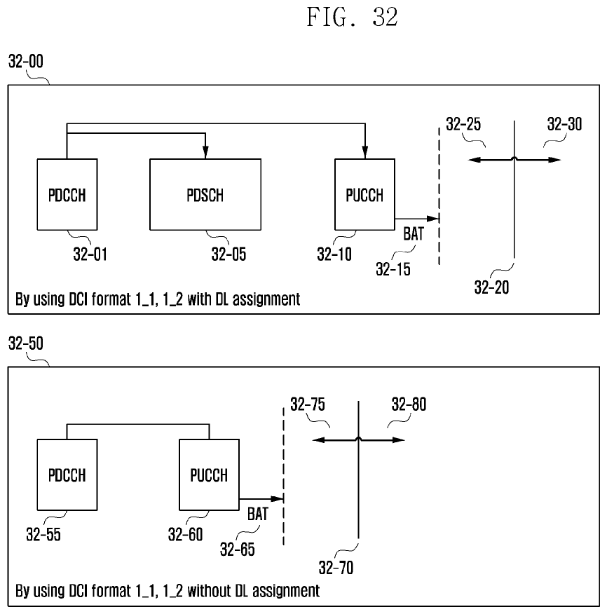

FIG. 32 is a diagram illustrating the beam application time that may be considered when using a unified TCI framework in a wireless communication system according to an embodiment of the disclosure. As described above, the UE may receive DCI format 1_1 or 1_2 containing or not including downlink data channel scheduling information (with DL assignment or without DL assignment) from the base station, and apply one joint TCI state or separate TCI state set indicated by the TCI state field in the corresponding DCI to the uplink transmit beam and downlink receive beam.
DCI format 1_1 or 1_2 with DL assignment (32-00): if the UE receives DCI format 1_1 or 1_2 including downlink data channel scheduling information from the base station (32-01) and is indicated with one joint TCI state or separate TCI state set based on the unified TCI framework, the UE may receive a PDSCH scheduled based on the received DCI (32-05), and transmit a PUCCH including HARQ-ACK indicating successful or unsuccessful reception of the DCI and PDSCH (32-10). At this time, this HARQ-ACK may include the meaning of successful or unsuccessful reception of both DCI and PDSCH; if at least one of the DCI or the PDSCH is not successfully received, the UE may transmit a NACK, and if both are successfully received, the UE may transmit an ACK.
DCI format 1_1 or 1_2 without DL assignment (32-50): if the UE receives DCI format 1_1 or 1_2 not including downlink data channel scheduling information from the base station (32-55) and is indicated with one joint TCI state or separate TCI state set based on the unified TCI framework, the UE may assume the following items for the corresponding DCI.
CRC scrambled with CS-RNTI is included.
The value of all bits allocated to fields used as RV (redundancy version) fields is ‘1’.
The value of all bits allocated to fields used as MCS (modulation and coding scheme) fields is ‘1’.
The value of all bits allocated to fields used as NDI (new data indication) fields is ‘0’.
For FDRA (frequency domain resource allocation) Type 0, the value of all bits allocated to the FDRA field is ‘0’; For FDRA Type 1, the value of all bits allocated to the FDRA field is ‘1’; if the FDRA scheme is dynamicSwitch, the value of all bits allocated to the FDRA field is ‘0’.

The UE may transmit a PUCCH including HARQ-ACK that indicates successful or unsuccessful reception of DCI format 1_1 or 1_2 where the above-described items are assumed (32-60).
For both DCI format 1_1 or 1_2 with DL assignment (32-00) and without DL assignment (32-50), if the new TCI state indicated through the DCI (32-01 or 32-55) is the same as the previous TCI state that has already been indicated and applied to the uplink transmit beam and downlink receive beam, the UE may maintain the previously indicated TCI state; if the new TCI state is different from the previous TCI state, the UE may determine the time to apply the joint TCI state or separate TCI state set indicated by the TCI state field included in the DCI to be a time point (32-30 or 32-80) following the first slot (32-20 or 32-70) occurring after BAT (beam application time, 32-15 or 32-65) from PUCCH transmission, and may use the previously indicated TCI state up to a time point (32-25 or 32-75) before the corresponding slot (32-20 or 32-70).
For both DCI format 1_1 or 1_2 with DL assignment (32-00) and without DL assignment (32-50), BAT is a specific number of OFDM symbols that can be set via higher layer signaling based on UE capability reporting information, and the numerology for BAT and the first slot occurring after BAT may be determined based on the smallest numerology among all cells to which the joint TCI state or separate TCI state set indicated through the DCI is applied.

The UE may apply one joint TCI state indicated through a MAC CE or DCI to reception of control resource sets associated with all UE-specific search spaces, reception of a PDSCH and transmission of a PUSCH scheduled by the PDCCH transmitted from the corresponding control resource set, and transmission of all PUCCH resources.

If one separate TCI state set indicated through a MAC CE or DCI includes one DL TCI state, the UE may apply one separate TCI state set to reception of control resource sets associated with all UE-specific search spaces, reception of a PDSCH scheduled by the PDCCH transmitted from the corresponding control resource set, and may apply it to all PUSCH and PUCCH resources based on the previously indicated UL TCI state.

If one separate TCI state set indicated through a MAC CE or DCI includes one UL TCI state, the UE may apply one separate TCI state set to all PUSCH and PUCCH resources, and may apply, based on the previously indicated DL TCI state, it to reception of control resource sets associated with all UE-specific search spaces and reception of a PDSCH scheduled by the PDCCH transmitted from the corresponding control resource set.

If one separate TCI state set indicated through a MAC CE or DCI includes one DL TCI state and one UL TCI state, the UE may apply the DL TCI state to reception of control resource sets associated with all UE-specific search spaces and reception of a PDSCH scheduled by the PDCCH transmitted from the corresponding control resource set, and may apply the UL TCI state to all PUSCH and PUCCH resources. In the examples of the MAC CE of FIGS. 23 to 31 described above, at least one of their components may be combined with each other.

### Second Embodiment: Multiple TCI State Indication and Activation Method Based on Unified TCI Framework

As an embodiment of the disclosure, a method for indicating and activating multiple TCI states based on a unified TCI framework is described. The method of indicating and activating multiple TCI states may mean a case where the number of indicated joint TCI states is increased to two or more and a case where the number of DL TCI states and the number of UL TCI states included in one separate TCI state set may each be increased to a maximum of two or more. If one separate TCI state set can include up to two DL TCI states and up to two UL TCI states, there may be a total of 8 combinations of DL and UL TCI states that one separate TCI state set may have ({DL, UL}={0,1}, {0,2}, {1,0}, {1,1}, {1,2}, {2,0}, {2,1}, {2,2}, a numerical value indicates the number of TCI states).

If the UE is indicated with multiple TCI states by the base station based on a MAC CE, the UE may receive two or more joint TCI states or one separate TCI state set through the corresponding MAC CE from the base station. The base station may schedule the UE to receive a PDSCH including the corresponding MAC CE through the PDCCH, and the UE may, from 3 ms after transmitting a PUCCH including HARQ-ACK information indicating successful or unsuccessful reception of the PDSCH including the corresponding MAC CE, determine the uplink transmit beam or transmission filter and the downlink receive beam or reception filter based on the indicated two or more joint TCI states or one separate TCI state set.

If the UE is indicated with multiple TCI states by the base station based on DCI format 1_1 or 1_2, each codepoint of one TCI state field in corresponding DCI format 1_1 or 1_2 may indicate two or more joint TCI states or two or more separate TCI state sets. In this case, the UE may receive a MAC CE from the base station and activate two or more joint TCI states or two or more separate TCI state sets corresponding to each codepoint of one TCI state field in corresponding DCI format 1_1 or 1_2. The base station may schedule the UE to receive a PDSCH including the corresponding MAC CE through the PDCCH, and the UE may activate the TCI state information included in the corresponding MAC CE from 3 ms after transmitting a PUCCH including HARQ-ACK information indicating successful or unsuccessful reception of the PDSCH including the MAC CE.

If the UE is indicated with multiple TCI states by the base station based on DCI format 1_1 or 1_2, there may be two or more TCI state fields in corresponding DCI format 1_1 or 1_2, and one of two or more joint TCI states and two or more separate TCI state sets may be indicated based on each TCI state field. At this time, the UE may receive a MAC CE from the base station and activate a joint TCI state or separate TCI state set corresponding to each codepoint of two or more TCI state fields in corresponding DCI format 1_1 or 1_2. The base station may schedule the UE to receive a PDSCH including the corresponding MAC CE through the PDCCH, and the UE may activate the TCI state information included in the corresponding MAC CE from 3 ms after transmitting a PUCCH including HARQ-ACK information indicating successful or unsuccessful reception of the PDSCH including the MAC CE. The UE may be indicated with presence of one or more additional TCI state fields through higher layer signaling, and the length of the additional TCI state field in bits may be the same as the existing TCI state field or the length may be adjusted based on higher layer signaling.

The UE may receive an indication related to transmit/receive beams based on the unified TCI framework by using one of the joint TCI state and the separate TCI state set configured by the base station. The UE may be configured with usage of one of the joint TCI state and the separate TCI state through higher layer signaling from the base station. For the separate TCI state indication, the UE may be configured with a TCI state field having a length of up to 4 bits in DCI format 1_1 or 1_2 through higher layer signaling.

To activate or indicate multiple joint TCI states and separate TCI states described above, the MAC CE may be separately present for each of joint and separate TCI state schemes; one MAC CE may be used to activate or indicate the TCI state based on one of joint and separate TCI state schemes; the MAC CEs for MAC CE-based indication and MAC CE-based activation may share one MAC CE structure or may use separate MAC CE structures. In the following drawings, for convenience of description, the case where two TCI states are activated or indicated is considered, but it may be similarly applied to cases of three or more TCI states.

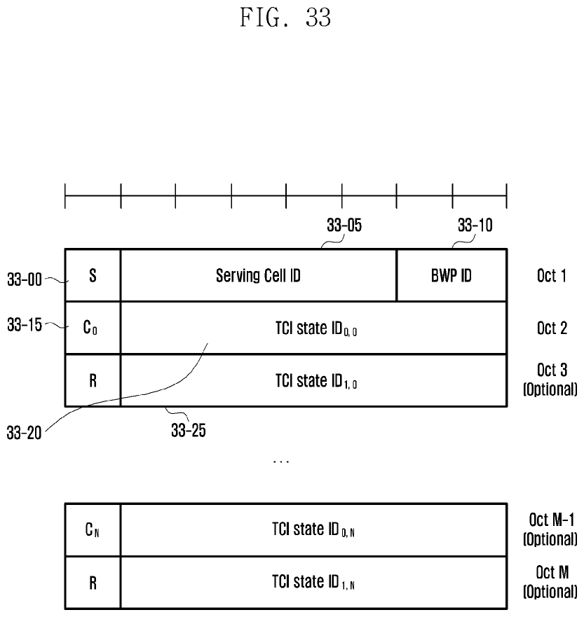

FIG. 33 is a diagram illustrating a MAC CE structure for activating and indicating plural joint TCI states in a wireless communication system according to an embodiment of the disclosure. In FIG. 33, the serving cell ID field 33-05 and the BWP ID field 33-10 may indicate the serving cell ID and bandwidth part ID, respectively. For example, if the value of the S field 33-00 is ‘l’, the corresponding MAC CE may indicate one or two joint TCI states and may include up to the 3^{rd} octet only. Here, if the value of the C₀ field 33-15 is ‘0’, the 3^{rd} octet is not present, and one joint TCI state may be indicated by the TCI state ID_{0,0} field 33-20; if the value of the C₀ field 33-15 is ‘1’, the 3^{rd} octet is present, and two joint TCI states may be indicated respectively by the TCI state ID_{0,0} field 33-20 and the TCI state ID_{1,0} field 33-25.

For example, if the value of the S field 33-00 is ‘0’, the corresponding MAC CE may activate one or two joint TCI states corresponding to each codepoint of the TCI state field in DCI format 1_1 or 1_2, or may activate one joint TCI state corresponding to each codepoint of the two TCI state fields in DCI format 1_1 or 1_2, and joint TCI states for up to 8 codepoints may be activated. If one or two joint TCI states are activated for one codepoint of one TCI state field, the TCI state ID_{0,Y} field and the TCI state ID_{1,Y} field may refer respectively to the first joint TCI state and the second joint TCI state among the two joint TCI states activated by the Y^{th} codepoint of the TCI state field. If one joint TCI state is activated for one codepoint of two TCI state fields, the TCI state ID_{0,Y} field and the TCI state ID_{1,Y} field may refer to each joint TCI state activated in the Y^{th} codepoint of the first and second TCI state fields.

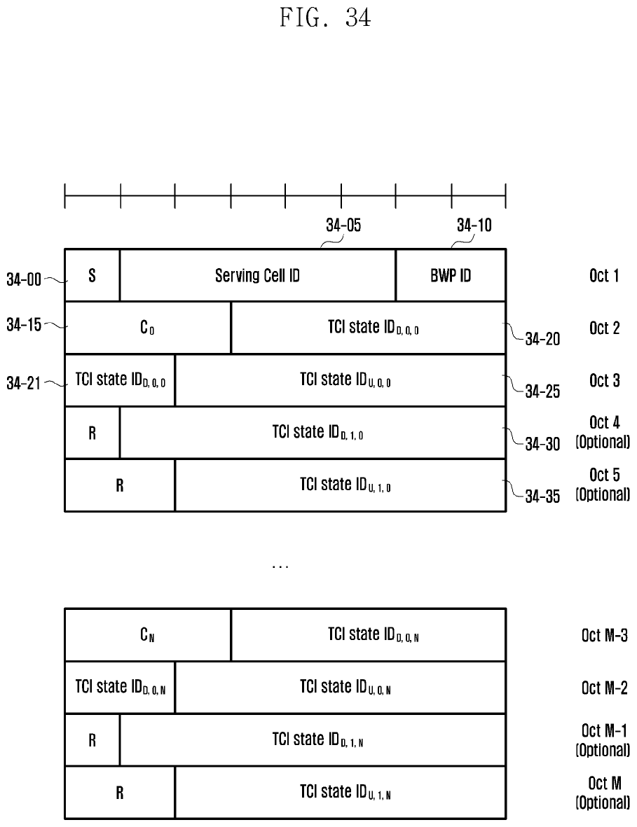

FIG. 34 is a diagram illustrating a MAC CE structure for activating and indicating plural separate TCI states in a wireless communication system according to an embodiment of the disclosure. In FIG. 34, the serving cell ID field 34-05 and the BWP ID field 34-10 may indicate the serving cell ID and bandwidth part ID, respectively. If the value of the S field 34-00 is ‘1’, the corresponding MAC CE may indicate one separate TCI state set and may include only up to the 5^{th} octet. If the value of the S field 34-00 is ‘0’, the corresponding MAC CE may include information about multiple separate TCI state sets; the MAC CE may activate one separate TCI state set corresponding to each codepoint of the TCI state field in DCI format 1_1 or 1_2, or may activate one separate TCI state set corresponding to each codepoint of the two TCI state fields in DCI format 1_1 or 1_2; as described above, separate TCI states for up to 8 or 16 codepoints may be activated through higher layer signaling.

In the MAC CE structure of FIG. 34, every four octets from the 2^{nd} octet may correspond to one separate TCI state set. For example, the C₀ field 34-15 may have a total of 8 values from “000” to “111”, which corresponds to the 8 cases that one separate TCI state set may have as described above.
If the C₀ field has a value of “000”, this may indicate that one separate TCI state set includes one UL TCI state, the TCI state ID_{D,0,0} fields 34-20 and 34-21 may be ignored, and the TCI state ID_{V,0,0} field 34-25 may include information about one UL TCI state. Additionally, the 4^{th} and 5^{th} octets may be ignored.
If the C₀ field has a value of “001”, this may indicate that one separate TCI state set includes two UL TCI states, the TCI state ID_{D,0,0} field 34-20 and 34-21 may be ignored, and the TCI state ID_{U,0,0} field 34-25 can include information about the first UL TCI state among the two UL TCI states. Additionally, the 4^{th} octet may be ignored, and the TCI state ID_{U,1,0} field 34-35 may include information about the second UL TCI state among the two UL TCI states.
If the C₀ field has a value of “010”, this may indicate that one separate TCI state set includes one DL TCI state, the TCI state ID_{D,0,0} field 34-20 and 34-21 may include information about one DL TCI state, and the TCI state ID_{U,0,0} field 34-25 and the 4^{th} and 5^{th} octets may be ignored.
If the C₀ field has a value of “011”, this may indicate that one separate TCI state set includes one DL TCI state and one UL TCI state, the TCI state ID_{D,0,0} field 3420 and 3421 may include information about one DL TCI state, and the TCI state ID_{U,0,0} field 34-25 may include information about one UL TCI state. The 4^{th} and 5^{th} octets may be ignored.
If the C₀ field has a value of “100”, this may indicate that one separate TCI state set includes one DL TCI state and two UL TCI states, the TCI state ID_{D,0,0} field 34-20 and 34-21 may include information about one DL TCI state, and the TCI state ID_{U,0,0} field 34-25 may include information about the first UL TCI state among the two UL TCI states. Additionally, the 4^{th} octet may be ignored, and the TCI state ID_{U,1,0} field 34-35 may include information about the second UL TCI state among the two UL TCI states.
If the C₀ field has a value of “101”, this may indicate that one separate TCI state set includes two DL TCI states, the TCI state ID_{D,0,0} field 34-20 and 34-21 may include information about the first DL TCI state among the two DL TCI states, and the TCI state ID_{U,0,0} field 34-25 and the 5^{th} octet may be ignored. The TCI state ID_{D,1,0} field 34-30 may include information about the second DL TCI state among the two DL TCI states.
If the C₀ field has a value of “110”, this may indicate that one separate TCI state set includes two DL TCI states and one UL TCI state, the TCI state ID_{D,0,0} field 34-20 and 34-21 may include information about the first DL TCI state among the two DL TCI states, the TCI state ID_{U,0,0} field 34-25 may include information about one UL TCI state, the CI state ID_{D,1,0} field 34-30 may include information about the second DL TCI state among the two DL TCI states, and the 5^{th} octet may be ignored.

If the C₀ field has a value of “111”, this may indicate that one separate TCI state set includes two DL TCI states and two UL TCI states, the TCI state ID_{D,0,0} field 34-20 and 34-21 may include information about the first DL TCI state among the two DL TCI states, the TCI state ID_{U,0,0} field 34-25 may include information about the first UL TCI state among the two UL TCI states, the TCI state ID_{D,1,0} field 34-30 may include information about the second DL TCI state among the two DL TCI states, and the TCI state ID_{U,1,0} field 34-35 may include information about the second UL TCI state among the two UL TCI states.

FIG. 34 may illustrate an example of MAC CE when the UL TCI state among the separate TCI states uses a higher layer signaling structure different from that of the DL TCI state among the separate TCI states and the joint TCI state as described above; since representing up to 64 UL TCI states requires 6 bits, the TCI state ID_{D,0,0} to TCI state ID_{D,1,N} fields indicating DL TCI states may each have 7 bits whereas the TCI state ID_{U,0,0} to TCI state ID_{U,1,N} fields indicating UL TCI states may each have 6 bits.

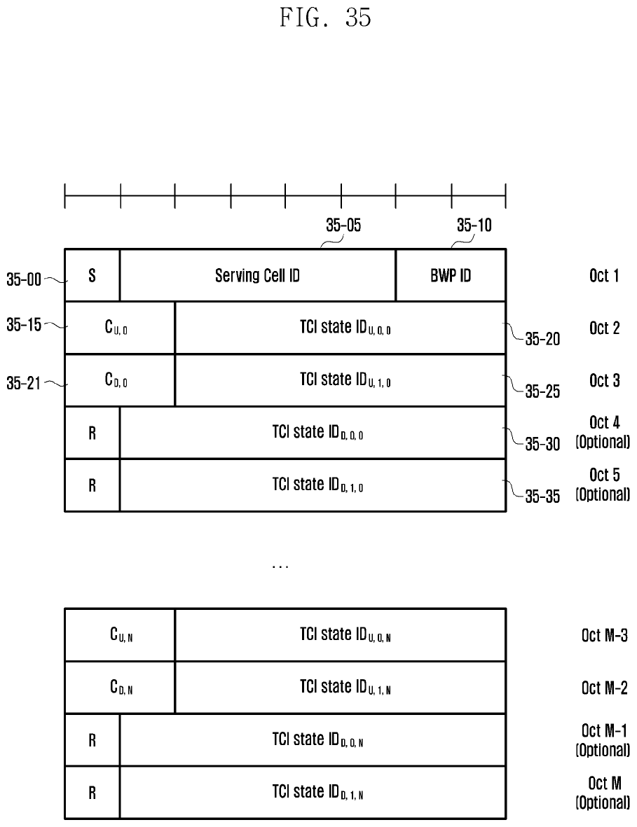

FIG. 35 is a diagram illustrating another MAC CE structure for activating and indicating plural separate TCI states in a wireless communication system according to an embodiment of the disclosure. In FIG. 35, the serving cell ID field 35-05 and the BWP ID field 35-10 may indicate the serving cell ID and bandwidth part ID, respectively. For example, if the value of the S field 35-00 is ‘1’, the corresponding MAC CE may indicate one separate TCI state set and may include up to the 5^{th} octet only.

For example, if the value of the S field 35-00 is ‘0’, the corresponding MAC CE may include information about multiple separate TCI state sets; the MAC CE may activate one separate TCI state set corresponding to each codepoint of the TCI state field in DCI format 1_1 or 1_2, or may activate one separate TCI state set corresponding to each codepoint of the two TCI state fields in DCI format 1_1 or 1_2; as described above, separate TCI state sets for up to 8 or 16 codepoints may be activated through higher layer signaling.

In the MAC CE structure of FIG. 35, every four octets from the 2^{nd} octet may correspond to one separate TCI state set. For example, the C_{U,0} field 35-15 and the C_{D,0} field 35-21 may refer respectively to the number of UL TCI states and the number of DL TCI states included in one separate TCI state set, and may have a meaning for each codepoint as follows.
If the C_{U,0} field has a value of “00”, this may indicate that no UL TCI state is included, and the TCI state ID_{U,0,0} field 35-20 and TCI state ID_{U,1,0} field 35-25 may be ignored.
If the C_{U,0} field has a value of “01”, this may indicate that one UL TCI state is included, the TCI state ID_{U,0,0} field 35-20 may include information about one UL TCI state, and the TCI state ID_{U,1,0} field 35-25 may be ignored.
If the C_{U,0} field has a value of “10”, this may indicate that two UL TCI states are included, the TCI state ID_{U,0,0} field 35-20 may include information about the first UL TCI state among the two UL TCI states, and TCI state ID_{U,1,0} field 35-25 may include information about the second UL TCI state among the two UL TCI states.
If the C_{D,0} field has a value of “00”, this may indicate that no DL TCI state is included, and the 4^{th} and 5^{th} octets may be ignored.
If the C_{D,0} field has a value of “01”, this may indicate that one DL TCI state is included, the TCI state ID_{D,0,0} field 35-30 may include information about one UL TCI state, and the 5^{th} octet may be ignored.
If the C_{D,0} field has a value of “10”, this may indicate that two DL TCI states are included, the TCI state ID_{D,0,0} field 35-30 may include information about the first DL TCI state among the two DL TCI states, and the TCI state ID_{D,1,0} field 35-35 may include information about the second DL TCI state among the two DL TCI states.

FIG. 35 may illustrate an example of MAC CE when the UL TCI state among the separate TCI states uses a higher layer signaling structure different from that of the DL TCI state among the separate TCI states and the joint TCI state as described above; since representing up to 64 UL TCI states requires 6 bits, the TCI state ID_{D,0,0} to TCI state ID_{D,1,N} fields indicating DL TCI states may each have 7 bits whereas the TCI state ID_{U,0,0} to TCI state ID_{U,1,N} fields indicating UL TCI states may each have 6 bits.

In the examples of the MAC CE of FIGS. 33 to 34 described above, at least one of their components may be combined with each other.

### Third Embodiment: Additional Single and Multiple TCI State Indication and Activation Method Based on Unified TCI Framework

As an embodiment of the disclosure, a description is given of a method for indicating and activating additional single and multiple TCI states based on a unified TCI framework. The base station may schedule the UE to receive a PDSCH including a MAC CE that may be composed of a combination of at least one of the various MAC CE structures below, and the UE may interpret each codepoint of the TCI state field in DCI format 1_1 or 1_2 based on the information in the MAC CE received from the base station after 3 slots from transmitting the HARQ-ACK for the corresponding PDSCH to the base station. That is, the UE may activate an entry in the MAC CE received from the base station in a codepoint of the TCI state field in DCI format 1_1 or 1_2.

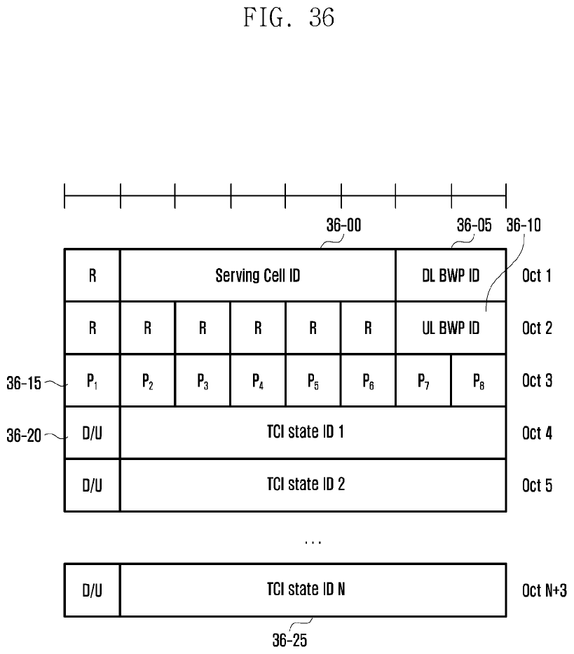

FIG. 36 is a diagram illustrating another MAC CE structure for activating and indicating joint TCI state, separate DL TCI state, or separate UL TCI state in a wireless communication system according to an embodiment of the disclosure. The meaning of each field in the MAC CE structure may be as follows.
Serving Cell ID (36-00): this field may indicate the serving cell to which the corresponding MAC CE is applied. The length of this field may be 5 bits. If the serving cell indicated by this field is included in one or more of higher layer signaling simultaneousU-TCI-UpdateList1, simultaneousU-TCI-UpdateList2, simultaneousU-TCI-UpdateList3, and simultaneousU-TCI-UpdateList4, the corresponding MAC CE may be applied to all serving cells included in one or more lists among simultaneousU-TCI-UpdateList1, simultaneousU-TCI-UpdateList2, simultaneousU-TCI-UpdateList3, and simultaneousU-TCI-UpdateList4 that include the serving cell indicated by this field.
DL BWP ID (36-05): this field may indicate the DL BWP to which the corresponding MAC CE is applied, and the meanings of codepoints of this field may correspond to codepoints of the bandwidth part indicator in DCI. The length of this field may be 2 bits.
UL BWP ID (36-10): this field may indicate the UL BWP to which the corresponding MAC CE is applied, and the meanings of codepoints of this field may correspond to codepoints of the bandwidth part indicator in DCI. The length of this field may be 2 bits.
Pᵢ(36-15): this field may indicate whether a codepoint of the TCI state field in DCI format 1_1 or 1_2 has multiple TCI states or one TCI state. If the value of Pᵢ is ‘1’, this indicates that the corresponding i^{th} codepoint has multiple TCI states, which may mean that the corresponding codepoint may include a separate DL TCI state and a separate UL TCI state. If the value of Pᵢ is ‘0’, this indicates that the corresponding i^{th} codepoint has a single TCI state, which may mean that the corresponding codepoint may include one of a joint TCI state, a separate DL TCI state, and a separate UL TCI state.
D/U (36-20): this field may indicate whether the TCI state ID field in the same octet refers to a joint TCI state, separate DL TCI state, or separate UL TCI state. If this field is ‘1’, the TCI state ID field in the same octet may refer to a joint TCI state or a separate DL TCI state; if this field is ‘0’, the TCI state ID field in the same octet may refer to a separate UL TCI state.
TCI state ID (36-25): this field may indicate the TCI state that may be identified through higher layer signaling TCI-StateId. If the D/U field is set to ‘l’, this field may be used to indicate TCI-StateId, which may be represented in 7 bits. If the D/U field is set to ‘0’, the most significant bit (MSB) of this field may be regarded as a reserved bit, and the remaining 6 bits may be used to indicate UL-TCIState-Id being higher layer signaling. The maximum number of TCI states that can be activated may be 8 for a joint TCI state and 16 for a separate DL TCI state or separate UL TCI state.
R: this means a reserved bit and may be set to ‘0’.

With respect to the MAC CE structure of FIG. 36 described above, the UE may include the 3^{rd} octet including P₁, P₂, . . . , P₈ fields in FIG. 36 in the corresponding MAC CE structure regardless of whether unifiedTCI-StateType-r17 of MIMOparam-r17 in higher layer signaling ServingCellConfig is set to “joint” or “separate”. In this case, the UE may perform TCI state activation by using a fixed MAC CE structure regardless of higher layer signaling from the base station. As another example, with respect to the MAC CE structure of FIG. 36 described above, if unifiedTCI-StateType-r17 of MIMOparam-r17 in higher layer signaling ServingCellConfig is set to “joint”, the UE may omit the 3^{rd} octet including P₁, P₂, . . . , P₈ fields in FIG. 36. In this case, the UE may save up to 8 bits of the payload of the corresponding MAC CE according to higher layer signaling from the base station. In addition, all D/U fields located at the first bit of an octet from the 4^{th} octet in FIG. 36 may be regarded as R fields, and these R fields may be set to a bit of ‘0’.

If the UE is configured with two different CORESETPoolIndex values via higher layer signaling and configured with higher layer signaling DLorJointTCIState or UL-TCIState, the base station and the UE may expect that in FIG. 36 being one of the MAC CE structures indicating activation of the unified TCI state, the R field present in the 1^{st} octet is interpreted as a field referring to a CORESET Pool ID. If the corresponding CORESET Pool ID is set to ‘0’, the UE may consider that the corresponding MAC CE may be applied to each codepoint of the TCI state field in the PDCCH transmitted to from the CORESET corresponding CORESETPoolIndex value ‘0’. If the corresponding CORESET Pool ID is set to ‘1’, the UE may consider that the corresponding MAC CE may be applied to each codepoint of the TCI state field in the PDCCH transmitted from the CORESET corresponding to CORESETPoolIndex value ‘1’.

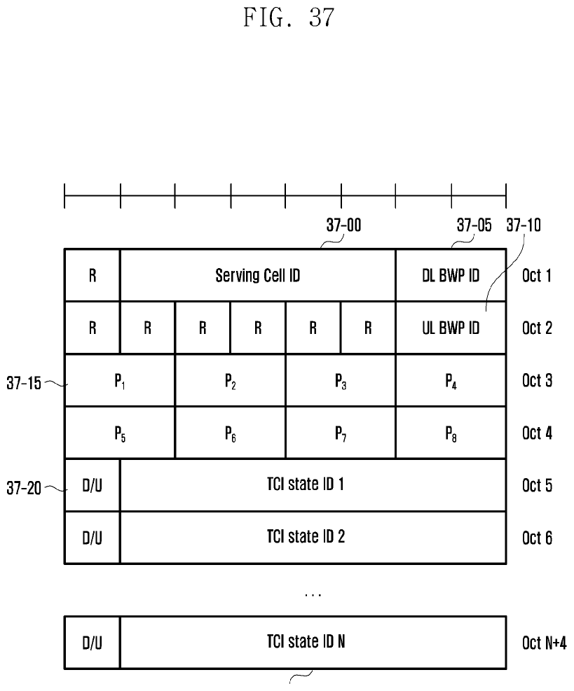

FIG. 37 is a diagram illustrating another MAC CE structure for activating and indicating multiple joint TCI states, separate DL TCI states, or separate UL TCI states in a wireless communication system according to an embodiment of the disclosure. The meaning of each field in the MAC CE structure may be as follows.
Serving Cell ID (37-00): this field may indicate the serving cell to which the corresponding MAC CE is applied. The length of this field may be 5 bits. If the serving cell indicated by this field is included in one or more of higher layer signaling simultaneousU-TCI-UpdateList1, simultaneousU-TCI-UpdateList2, simultaneousU-TCI-UpdateList3, and simultaneousU-TCI-UpdateList4, the corresponding MAC CE may be applied to all serving cells included in one or more lists among simultaneousU-TCI-UpdateList1, simultaneousU-TCI-UpdateList2, simultaneousU-TCI-UpdateList3, and simultaneousU-TCI-UpdateList4 that include the serving cell indicated by this field.
DL BWP ID (37-05): this field may indicate the DL BWP to which the corresponding MAC CE is applied, and the meanings of codepoints of this field may correspond to codepoints of the bandwidth part indicator in DCI. The length of this field may be 2 bits.
UL BWP ID (37-10): this field may indicate the UL BWP to which the corresponding MAC CE is applied, and the meanings of codepoints of this field may correspond to codepoints of the bandwidth part indicator in DCI. The length of this field may be 2 bits.
Pᵢ(37-15): this field may indicate whether a codepoint of the TCI state field in DCI format 1_1 or 1_2 has multiple TCI states or one TCI state.
If the UE is capable of being configured with unifiedTCI-StateType-r17 set to one of “joint” and “separate” in MIMOparam-r17 of higher layer signaling ServingCellConfig, this field may be interpreted as follows, regardless of which of the two settings is set.
If the value of Pᵢ is ‘00’, this indicates that the corresponding i^{th} codepoint has a single TCI state, which may mean that the corresponding codepoint may include one of a joint TCI state, a separate DL TCI state, and a separate UL TCI state.
If the value of Pᵢ is ‘01’, this indicates that the corresponding i^{th} codepoint has two TCI states, which may mean that the corresponding codepoint may include one of two joint TCI states, one separate DL TCI state and one separate UL TCI state, two separate DL TCI states, and two separate UL TCI states.
If the value of Pᵢ is ‘01’, this indicates that the corresponding i^{th} codepoint has three TCI states, which may mean that the corresponding codepoint may include one separate DL TCI state and two separate UL TCI states, or two separate DL TCI states and one separate UL TCI state.
If the value of Pᵢ is ‘11’, this indicates that the corresponding i^{th} codepoint has four TCI states, which may mean that the corresponding codepoint may include two separate DL TCI states and two separate UL TCI states.
If the UE is capable of being configured with unifiedTCI-StateType-r17 set to one of joint, separate, and mixed mode in MIMOparam-r17 of higher layer signaling ServingCellConfig, this field may be interpreted as follows, regardless of which of the possible settings is set. The mixed mode may be expressed as one setting value meaning that a general mixed mode of a joint TCI state and a separate DL TCI state or separate UL TCI state is possible, or may be expressed as plural setting values such as “1joint+1DL” and “joint+1UL” to represent a specific combination of a given number of joint TCI states and a given number of separate DL TCI states or separate UL TCI states.
If the value of Pᵢ is ‘00’, this indicates that the corresponding i^{th} codepoint has a single TCI state, which may mean that the corresponding codepoint may include one of a joint TCI state, a separate DL TCI state, and a separate UL TCI state.
If the value of Pᵢ is ‘01’, this indicates that the corresponding i^{th} codepoint has two TCI states, which may mean that the corresponding codepoint may include one of two joint TCI states, one joint TCI state and one separate DL TCI state, one joint TCI state and one separate UL TCI state, one separate DL TCI state and one separate UL TCI state, two separate DL TCI states, and two separate UL TCI states. If the UE is configured with a value meaning that a general mixed mode of a joint TCI state and a separate DL TCI state or separate UL TCI state is possible, like mixed mode set in unifiedTCI-StateType-r17 of MIMOparam-r17 in higher layer signaling ServingCellConfig, both of one joint TCI state and one separate DL TCI state, and one joint TCI state and one separate UL TCI state described above may be possible. If the UE is configured with unifiedTCI-StateType-r17 set to one of “1joint+1DL” and “1joint+1UL” in MIMOparam-r17 of higher layer signaling ServingCellConfig, among one joint TCI state and one separate DL TCI state, and one joint TCI state and one separate UL TCI state described above, only a case that corresponds to the unifiedTCI-StateType-r17 setting value may be possible.
If the value of Pᵢ is ‘10’, this indicates that the corresponding i^{th} codepoint has three TCI states, which may mean that the corresponding codepoint may include one separate DL TCI state and two separate UL TCI states, or two separate DL TCI states and one separate UL TCI state.
If the value of Pᵢ is ‘11’, this indicates that the corresponding i^{th} codepoint has four TCI states, which may mean that the corresponding codepoint may include two separate DL TCI states and two separate UL TCI states.
The corresponding field may be 2 bits.
D/U (37-20): this field may indicate whether the TCI state ID field in the same octet refers to a joint TCI state, separate DL TCI state, or separate UL TCI state. If this field is ‘1’, the TCI state ID field in the same octet may refer to a joint TCI state or a separate DL TCI state; if this field is ‘0’, the TCI state ID field in the same octet may refer to a separate UL TCI state.
TCI state ID (37-25): this field may indicate the TCI state that may be identified through higher layer signaling TCI-StateId. If the D/U field is set to ‘l’, this field may be used to indicate TCI-StateId, which may be represented in 7 bits. If the D/U field is set to ‘0’, the most significant bit (MSB) of this field may be regarded as a reserved bit, and the remaining 6 bits may be used to indicate UL-TCIState-Id being higher layer signaling. The maximum number of TCI states that can be activated may be 8 for a joint TCI state and 16 for a separate DL TCI state or separate UL TCI state.
R: this means a reserved bit and may be set to ‘0’.

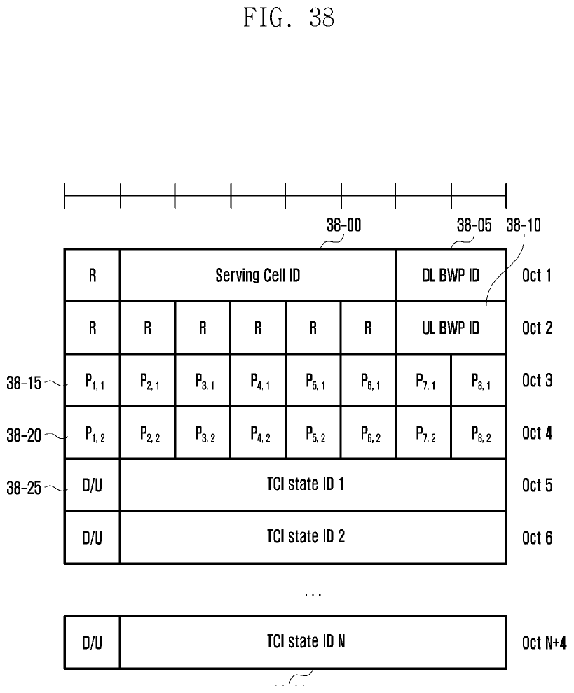

FIG. 38 is a diagram illustrating another MAC CE structure for activating and indicating multiple joint TCI states, separate DL TCI states, or separate UL TCI states in a wireless communication system according to an embodiment of the disclosure. The meaning of each field in the MAC CE structure may be as follows.
Serving Cell ID (38-00): this field may indicate the serving cell to which the corresponding MAC CE is applied. The length of this field may be 5 bits. If the serving cell indicated by this field is included in one or more of higher layer signaling simultaneousU-TCI-UpdateList1, simultaneousU-TCI-UpdateList2, simultaneousU-TCI-UpdateList3, and simultaneousU-TCI-UpdateList4, the corresponding MAC CE may be applied to all serving cells included in one or more lists among simultaneousU-TCI-UpdateList1, simultaneousU-TCI-UpdateList2, simultaneousU-TCI-UpdateList3, and simultaneousU-TCI-UpdateList4 that include the serving cell indicated by this field.
DL BWP ID (38-05): this field may indicate the DL BWP to which the corresponding MAC CE is applied, and the meanings of codepoints of this field may correspond to codepoints of the bandwidth part indicator in DCI. The length of this field may be 2 bits.
UL BWP ID (38-10): this field may indicate the UL BWP to which the corresponding MAC CE is applied, and the meanings of codepoints of this field may correspond to codepoints of the bandwidth part indicator in DCI. The length of this field may be 2 bits.
P_{i,1} (38-15), P_{i,2} (38-20): these fields may indicate whether a codepoint of the TCI state field in DCI format 1_1 or 1_2 has multiple TCI states or one TCI state.
In a case where unifiedTCI-StateType-r17 of MIMOparam-r17 in higher layer signaling ServingCellConfig may be set to one of joint and separate or set to one of joint, separate, and mixed mode, if higher layer signaling unifiedTCI-StateType-r17 is set to joint in the UE, in FIG. 38, the 4^{th} octet including P_{1,2}, P_{2,2}, . . . , P_{8,2} fields may be omitted, and only P_{i,1} may be interpreted as follows. The mixed mode may be expressed as one setting value meaning that a general mixed mode of a joint TCI state and a separate DL TCI state or separate UL TCI state is possible, or may be expressed as plural setting values such as “1joint+1DL” and “1joint+1UL” to represent a specific combination of a given number of joint TCI states and a given number of separate DL TCI states or separate UL TCI states.
If the value of P_{i,1} is ‘0’, this indicates that the corresponding i^{th} codepoint has a single TCI state, which may mean that the corresponding codepoint includes one joint TCI state.
If the value of P_{i,1} is ‘1’, this indicates that the corresponding i^{th} codepoint has two TCI states, which may mean that the corresponding codepoint includes two joint TCI states.
In a case where unifiedTCI-StateType-r17 of MIMOparam-r17 in higher layer signaling ServingCellConfig may be set to one of joint and separate or set to one of joint, separate, and mixed mode, if higher layer signaling unifiedTCI-StateType-r17 is set to separate, the UE may regard P_{i,1} of the 3^{rd} octet and P_{i,2} of the 4^{th} octet as one 2-bit field and interpret it as follows. The mixed mode may be expressed as one setting value meaning that a general mixed mode of a joint TCI state and a separate DL TCI state or separate UL TCI state is possible, or may be expressed as plural setting values such as “1joint+1DL” and “1joint+1UL” to represent a specific combination of a given number of joint TCI states and a given number of separate DL TCI states or separate UL TCI states.
If the value of P_{i,1} is ‘0’ and the value of P_{i,2} is ‘0’, this indicates that the corresponding i^{th} codepoint has a single TCI state, which may mean that the corresponding codepoint may include one of a separate DL TCI state and a separate UL TCI state.
If the value of P_{i,1} is ‘0’ and the value of P_{i,2} is ‘1’, this indicates that the corresponding i^{th} codepoint has two TCI states, which may mean that the corresponding codepoint may include one of one separate DL TCI state and one separate UL TCI state, two separate DL TCI states, and two separate UL TCI states.
If the value of P_{i,1} is ‘1’ and the value of P_{i,2} is ‘0’, this indicates that the corresponding i^{th} codepoint has three TCI states, which may mean that the corresponding codepoint may include one separate DL TCI state and two separate UL TCI states, or two separate DL TCI states and one separate UL TCI state.
If the value of P_{i,1} is ‘1’ and the value of P_{i,2} is ‘1’, this indicates that the corresponding i^{th} codepoint has four TCI states, which may mean that the corresponding codepoint may include two separate DL TCI states and two separate UL TCI states.
In a case where unifiedTCI-StateType-r17 of MIMOparam-r17 in higher layer signaling ServingCellConfig may be set to one of joint, separate, and mixed mode, if higher layer signaling unifiedTCI-StateType-r17 is set to mixed mode, the UE may interpret P_{i,1} of the 3^{rd} octet as follows, and may not transmit the 4^{th} octet. The mixed mode may be expressed as one setting value meaning that a general mixed mode of a joint TCI state and a separate DL TCI state or separate UL TCI state is possible.
If the value of P_{i,1} is ‘0’, this may indicate that the corresponding i^{th} codepoint includes one joint TCI state and one separate DL TCI state.
If the value of P_{i,1} is ‘1’, this may indicate that the corresponding i^{th} codepoint includes one joint TCI state and one separate UL TCI state.
In a case where unifiedTCI-StateType-r17 of MIMOparam-r17 in higher layer signaling ServingCellConfig may be set to one of joint, separate, and mixed mode, if higher layer signaling unifiedTCI-StateType-r17 is set to mixed mode, the UE interpret P_{i,1} of the 3^{rd} octet and P_{i,2} of the 4^{th} octet as follows. The mixed mode may be expressed as one setting value meaning that a general mixed mode of a joint TCI state and a separate DL TCI state or separate UL TCI state is possible.
If the value of P_{i,1} is ‘0’, this may indicate that the corresponding i^{th} codepoint includes one joint TCI state only. That is, since mixed mode is not used, the value of P_{i,2} may be ignored.
If the value of P_{i,1} is ‘1’, this may indicate that the corresponding i^{th} codepoint additionally includes one of one separate UL TCI state and one separate DL TCI state in addition to one joint TCI state. That is, mixed mode may be used for the corresponding codepoint; if the value of P_{i,2} is ‘0’, one separate UL TCI state may be additionally used, and if the value of P_{i,2} is ‘1’, one separate UL TCI state may be additionally used.
D/U (38-25): this field may indicate whether the TCI state ID field in the same octet refers to a joint TCI state, separate DL TCI state, or separate UL TCI state. If this field is ‘1’, the TCI state ID field in the same octet may refer to a joint TCI state or a separate DL TCI state; if this field is ‘0’, the TCI state ID field in the same octet may refer to a separate UL TCI state.
TCI state ID (38-30): this field may indicate the TCI state that may be identified through higher layer signaling TCI-StateId. If the D/U field is set to ‘1’, this field may be used to indicate TCI-StateId, which may be represented in 7 bits. If the D/U field is set to ‘0’, the most significant bit (MSB) of this field may be regarded as a reserved bit, and the remaining 6 bits may be used to indicate UL-TCIState-Id being higher layer signaling. The maximum number of TCI states that can be activated may be 8 for a joint TCI state and 16 for a separate DL TCI state or separate UL TCI state.
R: this means a reserved bit and may be set to ‘0’.

unifiedTCI-StateType-r17 of MIMOparam-r17 in higher layer signaling ServingCellConfig described above may be defined as a new parameter like unifiedTCI-StateType-r18 of higher layer signaling MIMOparam-r18 in ServingCellConfig, or existing parameters may be reused.

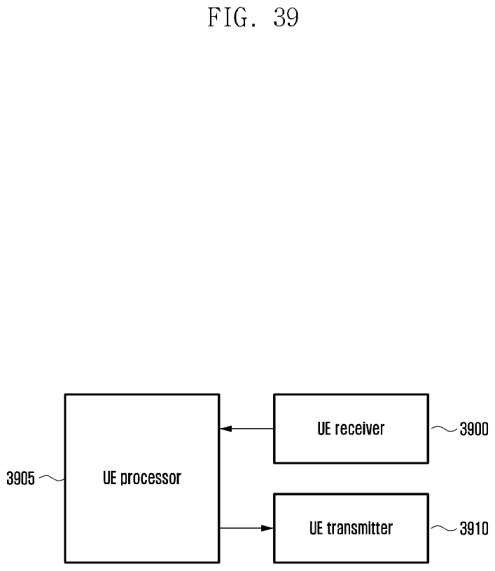

FIG. 39 is a diagram illustrating the structure of a UE in a wireless communication system according to an embodiment of the disclosure.

With reference to FIG. 39, the UE may include a transceiver referring to a UE receiver 3900 and a UE transmitter 3910, a memory (not shown), and a UE processor 3905 (or, UE controller or processor). According to the communication methods of the UE described above, the transceiver (3900, 3910), memory, and UE processor 3905 of the UE may operate. However, the components of the UE are not limited to those described above. For example, the UE may include more or fewer components than the aforementioned components. Further, the transceiver, memory, and processor may be implemented in the form of a single chip. The transceiver may transmit and receive signals to and from a base station. Here, the signal may include control information and data. To this end, the transceiver may be composed of an RF transmitter that up-converts the frequency of a signal to be transmitted and amplifies the signal, and an RF receiver that low-noise amplifies a received signal and down-converts the frequency thereof. However, this is only an embodiment of the transceiver, and the components of the transceiver are not limited to the RF transmitter and RF receiver.

In addition, the transceiver may receive a signal through a radio channel and output it to the processor, and may transmit a signal output from the processor through a radio channel.

The memory may store programs and data necessary for the operation of the UE. Additionally, the memory may store control information or data included in signals transmitted and received by the UE. The memory may be composed of storage media such as ROM, RAM, hard disk, CD-ROM, and DVD, or a combination of storage media. Additionally, the memory may be configured in multiple instances. In addition, the processor may control a series of processes so that the UE can operate according to the above-described embodiment. For example, the processor may control the components of the UE to receive a DCI composed of two layers and receive multiple PDSCHs at the same time. The processor may be configured in multiple instances, and the processor may perform a component control operation of the UE by executing a program stored in the memory.

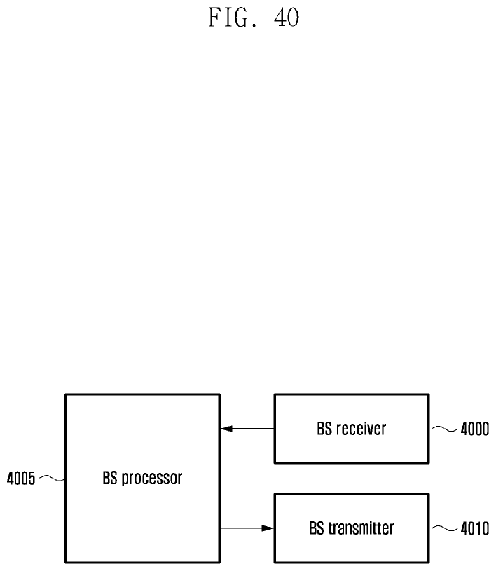

FIG. 40 is a diagram illustrating the structure of a base station in a wireless communication system according to an embodiment of the disclosure.

With reference to FIG. 40, the base station may include a transceiver referring to a BS receiver 4000 and a BS transmitter 4010, a memory (not shown), and a BS processor 4005 (or, BS controller or processor). According to the above-described communication method of the base station, the transceiver (4000, 4010), memory, and BS processor 4005 of the base station may operate. However, the components of the base station are not limited to those described above. For example, the base station may include more or fewer components than those described above. In addition, the transceiver, memory, and processor may be implemented in the form of a single chip.

The transceiver may transmit and receive signals to and from a UE. Here, the signal may include control information and data. To this end, the transceiver may be composed of an RF transmitter that up-converts the frequency of a signal to be transmitted and amplifies the signal, and an RF receiver that low-noise amplifies a received signal and down-converts the frequency thereof. However, this is only an embodiment of the transceiver, and the components of the transceiver are not limited to the RF transmitter and RF receiver.

In addition, the transceiver may receive a signal through a radio channel and output it to the processor, and may transmit a signal output from the processor through a radio channel.

The memory may store programs and data necessary for the operation of the base station. Additionally, the memory may store control information or data included in signals transmitted and received by the base station. The memory may be composed of storage media such as ROM, RAM, hard disk, CD-ROM, and DVD, or a combination of storage media. Additionally, the memory may be configured in multiple instances.

The processor may control a series of processes so that the base station can operate according to the above-described embodiment of the disclosure. For example, the processor may control the components of the base station to compose DCIs of two layers containing allocation information about multiple PDSCHs and transmit the same. The processor may be configured in multiple instances, and the processor may perform a component control operation of the base station by executing a program stored in the memory.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments of the disclosure disclosed in the present specification and drawings are only provided as specific examples to easily explain the technical details of the disclosure and to aid understanding of the disclosure, and are not intended to limit the scope of the disclosure. That is, it will be apparent to those of ordinary skill in the art that other modifications based on the technical idea of the disclosure can be carried out. In addition, some of the embodiments may be combined with each other if necessary for operation. For example, parts of one embodiment and another embodiment of the disclosure may be combined with each other to operate the base station and the UE. For example, parts of the first to third embodiments of the disclosure may be combined with each other to operate the base station and the UE.

Meanwhile, in the drawing depicting a method of the disclosure, the order of description does not necessarily correspond to the order of execution, and steps or operations may be changed in their order or may be executed in parallel.

Alternatively, in the drawing depicting a method of the disclosure, only some elements may be included by omitting some other elements within the scope that does not impair the essence of the present disclosure.

In addition, the method of the disclosure may be implemented by combining some or all of the content included in embodiments within the scope that does not impair the essence of the disclosure.

Various embodiments of the disclosure have been described above. The above description of the disclosure is for illustrative purposes, and embodiments of the disclosure are not limited to those disclosed. A person skilled in the art to which the disclosure pertains will understand that the disclosure can be readily modified into another specific form without changing its technical idea or essential features. The scope of the disclosure is indicated by the claims described below rather than the detailed description above, and all changes or modified forms derived from the meaning and scope of the claims and their equivalent concepts should be construed as being included in the scope of the disclosure.

1. A method of a terminal in a wireless communication system, the method comprising:
receiving, based on a unified transmission configuration indication (TCI), TCI state identification information from a base station;
receiving, from the base station, unified TCI state type information indicating that a type related to the unified TCI is either a joint TCI type or a separate TCI type; and
receiving, from the base station, a medium access control (MAC) control element (CE) that activates a TCI state associated with a codepoint of a TCI state field included in downlink control information (DCI),
wherein the MAC CE includes an information field that indicates a number of TCI states associated with the codepoint of the TCI state field included in the DCI.

2. The method of claim 1, wherein:
the information field is 2 bits for both a case where the type related to the unified TCI is a joint TCI type and a case where the type related to the unified TCI is a separate TCI type;
in case that the information field corresponds to ‘00’, the number of TCI states associated with the codepoint is one;
in case that the information field corresponds to ‘01’, the number of TCI states associated with the codepoint is two;
in case that the information field corresponds to ‘10’, the number of TCI states associated with the codepoint is three; and
in case that the information field corresponds to ‘11’, the number of TCI states associated with the codepoint is four.

3. The method of claim 1, wherein:
in case that the type related to the unified TCI is a joint TCI type, the information field is 1 bit; and
in case that the type related to the unified TCI is a separate TCI type, the information field includes a first field of 1 bit and a second field of 1 bit.

4. The method of claim 3, wherein:
the type related to the unified TCI is a joint TCI type;
in case that the information field corresponds to ‘0’, the number of TCI states associated with the codepoint is one; and
in case that the information field corresponds to ‘l’, the number of TCI states associated with the codepoint is two.

5. The method of claim 3, wherein:
the type related to the unified TCI is a separate TCI type;
in case that the first field corresponds to ‘0’ and the second field corresponds to ‘0’, the number of TCI states associated with the codepoint is one;
in case that the first field corresponds to ‘0’ and the second field corresponds to ‘1’, the number of TCI states associated with the codepoint is two;
in case that the first field corresponds to ‘1’ and the second field corresponds to ‘0’, the number of TCI states associated with the codepoint is three; and
in case that the first field corresponds to ‘1’ and the second field corresponds to ‘1’, the number of TCI states associated with the codepoint is four.

6. A method of a base station in a wireless communication system, the method comprising:
transmitting, based on a unified transmission configuration indication (TCI), TCI state identification information to a terminal;
transmitting, to the terminal, unified TCI state type information indicating that a type related to the unified TCI is either a joint TCI type or a separate TCI type; and
transmitting, to the terminal, a medium access control (MAC) control element (CE) that activates a TCI state associated with a codepoint of a TCI state field included in downlink control information (DCI),
wherein the MAC CE includes an information field that indicates a number of TCI states associated with the codepoint of the TCI state field included in the DCI.

7. The method of claim 6, wherein:
the information field is 2 bits for both a case where the type related to the unified TCI is a joint TCI type and a case where the type related to the unified TCI is a separate TCI type;
in case that the information field corresponds to ‘00’, the number of TCI states associated with the codepoint is one;
in case that the information field corresponds to ‘01’, the number of TCI states associated with the codepoint is two;
in case that the information field corresponds to ‘10’, the number of TCI states associated with the codepoint is three; and
in case that the information field corresponds to ‘11’, the number of TCI states associated with the codepoint is four.

8. The method of claim 6, wherein:
in case that the type related to the unified TCI is a joint TCI type, the information field is 1 bit; and
in case that the type related to the unified TCI is a separate TCI type, the information field includes a first field of 1 bit and a second field of 1 bit.

9. The method of claim 8, wherein:
the type related to the unified TCI is a joint TCI type;
in case that the information field corresponds to ‘0’, the number of TCI states associated with the codepoint is one; and
in case that the information field corresponds to ‘1’, the number of TCI states associated with the codepoint is two.

10. The method of claim 8, wherein:
the type related to the unified TCI is a separate TCI type;
in case that the first field corresponds to ‘0’ and the second field corresponds to ‘0’, the number of TCI states associated with the codepoint is one;
in case that the first field corresponds to ‘0’ and the second field corresponds to ‘1’, the number of TCI states associated with the codepoint is two;
in case that the first field corresponds to ‘1’ and the second field corresponds to ‘0’, the number of TCI states associated with the codepoint is three; and
in case that the first field corresponds to ‘1’ and the second field corresponds to ‘1’, the number of TCI states associated with the codepoint is four.

11. A terminal in a wireless communication system, comprising:
a transceiver; and
a controller that is configured to receive, based on a unified transmission configuration indication (TCI), TCI state identification information from a base station, receive unified TCI state type information indicating that a type related to the unified TCI is either a joint TCI type or a separate TCI type from the base station, and receive a medium access control (MAC) control element (CE) that activates a TCI state associated with a codepoint of a TCI state field included in downlink control information (DCI) from the base station,
wherein the MAC CE includes an information field that indicates a number of TCI states associated with the codepoint of the TCI state field included in the DCI.

12. The terminal of claim 11, wherein:
the information field is 2 bits for both a case where the type related to the unified TCI is a joint TCI type and a case where the type related to the unified TCI is a separate TCI type;
in case that the information field corresponds to ‘00’, the number of TCI states associated with the codepoint is one;
in case that the information field corresponds to ‘01’, the number of TCI states associated with the codepoint is two;
in case that the information field corresponds to ‘10’, the number of TCI states associated with the codepoint is three; and
in case that the information field corresponds to ‘11’, the number of TCI states associated with the codepoint is four.

13. The terminal of claim 11, wherein:
in case that the type related to the unified TCI is a joint TCI type, the information field is 1 bit; and
in case that the type related to the unified TCI is a separate TCI type, the information field includes a first field of 1 bit and a second field of 1 bit.

14. The terminal of claim 13, wherein:
the type related to the unified TCI is a joint TCI type;
in case that the information field corresponds to ‘0’, the number of TCI states associated with the codepoint is one; and
in case that the information field corresponds to ‘1’, the number of TCI states associated with the codepoint is two.

15. A base station in a wireless communication system, comprising:
a transceiver; and
a controller that is configured to transmit, based on a unified transmission configuration indication (TCI), TCI state identification information to a terminal, transmit unified TCI state type information indicating that a type related to the unified TCI is either a joint TCI type or a separate TCI type to the terminal, and transmit a medium access control (MAC) control element (CE) that activates a TCI state associated with a codepoint of a TCI state field included in downlink control information (DCI) to the terminal,
wherein the MAC CE includes an information field that indicates a number of TCI states associated with the codepoint of the TCI state field included in the DCI.
